(19) United States
(12) Patent Application Publication
(10) Pub. No.: US 2024/0227024 A9
(43) Pub. Date: Jul. 11, 2024

(54) POWDER SUPPLY ASSEMBLY FOR ADDITIVE MANUFACTURING

(71) Applicant: Nikon Corporation, Minato-ku (JP)

(72) Inventors: Alton Hugh Phillips, Oro Valley, AZ (US); Joseph P. Rossi, San Jose, CA (US); Johnathan Agustin Marquez, San Francisco, CA (US); Yoon Jung Jeong, San Mateo, CA (US); Lexian Guo, Fremont, CA (US); Patrick Shih Chang, San Francisco, CA (US); Eric Peter Goodwin, Oro Valley, AZ (US); Michael Birk Binnard, Belmont, CA (US); Brett William Herr, Menlo Park, CA (US); Matthew Parker-McCormick Bjork, Davis, CA (US); Paul Derek Coon, Redwood City, CA (US); Motofusa Ishikawa, Ageo-shi (JP)

(21) Appl. No.: 17/624,191

(22) PCT Filed: Jul. 1, 2020
(86) PCT No.: PCT/US20/40498

§ 371 Date: Oct. 13, 2022

Related U.S. Application Data
(60) Provisional application No. 62/869,853, filed on Jul. 2, 2019.

(51) Int. Cl. B22F 12/57; B22F 10/30; B28B 17/00; B29C 64/321; B29C 64/393; B33Y 30/00; B33Y 50/02

(52) U.S. Cl. CPC B22F 12/57; B22F 10/30; B28B 17/0081; B29C 64/321; B29C 64/393; B33Y 30/00; B33Y 50/02; B22F 10/28

(57) ABSTRACT

A processing machine (10) for building an object (11) from powder (12) includes a build platform (26A); a powder supply assembly (18) that deposits the powder (12) onto the build platform (26A) to form a powder layer (13); and an energy system (22) that directs an energy beam (22D) at a portion of the powder (12) on the build platform (26A) to form a portion of the object (11). The powder supply assembly (18) can include (i) a powder container (640A) that retains the powder (12); (ii) a supply outlet (639) positioned over the build platform (26A); and (ii) a flow control assembly (642) that selectively controls the flow of the powder (12) from the supply outlet (639).

### RELATED APPLICATIONS

This application claims priority on U.S. Provisional Application No. 62/869,853 filed on Jul. 2, 2019 and entitled “POWDER SPREADING FOR ADDITIVE MANUFACTURING”. As far as permitted the contents of U.S. Provisional Application No. 62/869,853 are incorporated herein by reference.

As far as permitted the contents of PCT Application No: PCT/US18/67407 entitled “ADDITIVE MANUFACTURING SYSTEM WITH ROTARY POWDER BED” filed on Dec. 22, 2018, and the contents of PCT Application No: PCT/US18/67406 entitled “ROTATING ENERGY BEAM FOR THREE-DIMENSIONAL PRINTER” filed on Dec. 22, 2018 are incorporated herein by reference.

### BACKGROUND

Three-dimensional printing systems are used to print three-dimensional objects. Existing three-dimensional printing systems are relatively slow, have a low throughput, are expensive to operate, and/or generate excessive waste. There is a never ending search to increase the speed, the throughput and reduce the cost of operation for three-dimensional printing systems.

### SUMMARY

The present embodiment is directed to a processing machine for building a three-dimensional object from powder. The processing machine can include a build platform; a powder supply assembly that deposits the powder onto the build platform to form a powder layer; and an energy system that directs an energy beam at a portion of the powder on the build platform to form a portion of the object.

A number of different powder supply assemblies are disclosed herein. As an overview, these powder supply assemblies are uniquely designed to accurately, efficiently, evenly, and quickly distribute the powder onto the build platform. This will improve the accuracy of the built object, and reduce the time required to form the built object.

The powder supply assembly can include (i) a powder container that retains the powder; (ii) a supply outlet positioned over the build platform; and (ii) a flow control assembly that selectively controls the flow of the powder from the supply outlet.

In one implementation, the flow control assembly includes a flow controller and a vibration generator that selectively vibrates at least a portion of the powder supply assembly. In this design, the flow controller allows powder to flow therethrough upon sufficient vibration of the powder supply assembly by the vibration generator; and the flow controller inhibits flow therethrough when there is insufficient vibration of the powder supply assembly by the vibration generator. The control modes of this powder flow controller can include (1) the vibration generator selectively vibrates certain regions of the powder container, or (2) the vibration generator evenly vibrates the entire powder container.

The flow controller can include at least one mesh screen. The flow controller can include a flow structure having a plurality of flow apertures that extend through the flow structure. At least one of the flow apertures has an aperture size that is larger than a nominal powder particle size of the powder particles. Typically, a plurality of the flow apertures each have an aperture size that is larger than the nominal particle size of the powder.

The build platform can be moved relative to the powder supply assembly while the powder supply assembly deposits the powder onto the build platform. Additionally, or alternatively, the powder supply assembly can be moved relative to the build platform while the powder supply assembly deposits the powder onto the build platform.

In certain implementations, gravity urges the powder in the powder container against the flow controller; and/or the powder container can be funnel shaped.

Additionally, the flow control assembly can include a shutter assembly that selectively controls the flow of the powder from the supply outlet. The shutter assembly can include a first shutter, and a first shutter mover that selectively moves the first shutter to selectively control the flow of the powder from the supply outlet. Further, the shutter assembly can include a second shutter, and a second shutter mover that selectively moves the second shutter to selectively control the flow of the powder from the supply outlet.

In certain implementations, the powder supply assembly includes a plurality of supply modules that individually deposit powder on the build platform. These supply modules can be substantially aligned along an axis.

In one example, at least one of the supply modules includes (i) a powder container that retains the powder; (ii) a supply outlet positioned over the build platform; and (ii) a flow control assembly that selectively controls the flow of the powder from the supply outlet. Further, for the at least one supply module, the flow control assembly includes a flow controller and a vibration generator that selectively vibrates at least a portion of the supply module. In this design, the flow controller allows powder flow therethrough upon sufficient vibration of the supply module by the vibration generator; and the flow controller inhibits flow therethrough when there is insufficient vibration of the supply module by the vibration generator.

The flow control assembly can include a flow structure having flow apertures, the flow structure being moved relative to the powder container to release the powder through the flow structure.

Alternatively, the flow control assembly can include a first flow structure having first flow apertures and a second flow structure having second flow apertures. In this design, the first flow structure is moved relative to the second flow structure to release the powder through the flow structures.

Still alternatively, the flow control assembly includes a shaft shaped flow structure having surface features. In this design, the flow structure is rotated relative to the powder container to release the powder from the supply outlet.

In another implementation, the flow control assembly includes a first flow structure having a plurality of first flow apertures that extend through the first flow structure, and a structure mover that moves the first flow structure relative to the powder container to selectively control the flow of the powder from the supply outlet. For example, at least one, a plurality, or substantially all of the first flow apertures can have an aperture size that is larger than a nominal powder particle size of the powder particles. Further, the structure mover can move the first flow structure linearly in a reciprocating manner.

Additionally, the flow control assembly can include a second flow structure having a plurality of second flow apertures that extend through the second flow structure. In this design, structure mover can move the first flow structure and the second flow structure relative to each other to selectively control the flow of the powder from the supply outlet. Further, the first flow structure can be stacked on top of the second flow structure. Moreover, one or both flow structures can include at least one of a grating and a mesh.

In another implementation, the structure mover rotates the first flow structure in a reciprocating manner. Further, the flow control assembly can include a second flow structure having a plurality of second flow apertures that extend through the second flow structure. In this design, the structure mover rotates at least one of the first flow structure and the second flow structure relative to the other to selectively control the flow of the powder from the supply outlet.

The first flow structure can be stacked on top of the second flow structure. The first flow structure can include at least one of a grating and a mesh.

In another implementation, the powder supply assembly includes a plurality of supply modules that individually deposit powder on the build platform. In this design, at least one of the supply modules includes a flow structure having flow apertures that control the flow of powder, and a structure mover that rotates the flow structure relative to the supply module to release the powder through the flow structure.

In still another implementation, the flow control assembly can include a shaft shaped flow structure having surface features. In this design, the flow structure is rotated relative to the powder container to release the powder to the supply outlet. The surface features can have a feature cross-sectional area that is larger than a powder cross-sectional area of one of the powder particles.

In another implementation, the powder supply assembly includes a first supply module that deposit powder on the build platform, and a second supply module that deposits powder into the first supply module. At least one of the supply modules can include (i) a powder container that retains the powder; (ii) a supply outlet positioned over the build platform; and (ii) a flow control assembly that selectively controls the flow of the powder from the supply outlet. The supply modules can be arranged in series. Additionally, the powder supply assembly can include a third supply module that deposits powder into the second supply module.

Further, for at least one supply module, the flow control assembly includes a flow controller and a vibration generator that selectively vibrates at least a portion of the supply module. In this design, the flow controller allows powder flow therethrough upon sufficient vibration of the supply module by the vibration generator; and the flow controller inhibits flow therethrough when there is insufficient vibration of the supply module by the vibration generator.

Alternatively, for at least one supply module, the flow control assembly includes a flow structure having flow apertures, and the flow structure is moved relative to the powder container to release the powder through the flow structure. In another example, for the at least one supply module, the flow control assembly includes a first flow structure having first flow apertures, and a second flow structure having second flow apertures; and the first flow structure is moved relative to the second flow structure to release the powder through the flow structures.

Still alternatively, for the at least one supply module, the flow control assembly includes a shaft shaped flow structure having surface features; and the flow structure is rotated relative to the powder container to release the powder to the supply outlet.

In yet another implementation, the build platform is being moved at a platform velocity while the powder is being distributed onto the build platform, and the powder supply assembly directs the powder at an exit velocity towards the build platform. The exit velocity can be approximately equal to the platform velocity. For example, the exit velocity is within ten percent of the platform velocity.

Additionally, or alternatively, the build platform is being moved in a platform movement direction while the powder is being distributed onto the build platform; and the powder supply assembly directs the powder in an exit movement direction towards the build platform. The powder movement direction can be approximately parallel to the exit movement direction.

In an implementation, the powder supply assembly can include a ramp that directs the powder exiting the powder supply assembly to be moving substantially parallel to the build platform. The ramp can have a ramp curve of approximately ninety degrees. However, the ramp curve can be greater than or less than ninety degrees. Moreover, a ramp height of the ramp is designed to achieve the exit velocity of the powder directed at the build platform.

As provided herein, the build platform can be moved in a platform movement direction while the powder is being distributed onto the build platform; the powder supply assembly can direct the powder in an exit movement direction towards the build platform; and the exit movement direction can be approximately parallel to the platform movement direction.

In one implementation, the powder supply assembly includes (i) a delivery frame that retains the powder, the delivery frame having a plurality of delivery apertures that allow the powder to flow therethrough; and (ii) a frame mover that moves the delivery frame along a frame movement direction that is approximately parallel to the platform movement direction. With this design, the build platform is being moved at a platform velocity while the powder is being distributed onto the build platform; and the frame mover moves the delivery frame at a frame velocity that is approximately equal to the platform velocity.

Additionally, the powder supply assembly can include a rake that smooths the powder on the build platform.

In another implementation, the processing machine includes a support bed that supports the build platform and the powder supply assembly. In this design, a mover assembly can rotate the support bed with the build platform and powder supply assembly relative to the energy system. Further, a supply mover assembly can move the powder supply assembly linearly relative to the support bed and the energy system.

The powder supply assembly can include (i) a powder container that retains the powder; and (ii) a flow control assembly that selectively controls the flow of the powder from the powder container to the build platform. Additionally, or alternatively, the powder supply assembly can include a powder distributor that spreads and levels the powder on the build platform.

In a method implementation, the invention is directed to a method for building a three-dimensional object from powder including: (i) providing a build platform; (ii) distributing the powder onto the build platform to form a powder layer with a powder supply assembly; and (iii) directing an energy beam at a portion of the powder on the build platform to form a portion of the object with an energy system.

Additionally, one or more of the following implementations can be utilized with the method implementation: (i) retaining the powder with a powder container; (ii) positioning a supply outlet over the build platform; (iii) selectively controlling the flow of the powder from the supply outlet with a flow control assembly; (iv) selectively vibrating at least a portion of the powder supply assembly with a vibration generator; (v) the flow control assembly includes at least one mesh screen; (vi) the flow control assembly includes a flow structure having a plurality of flow apertures that extend through the flow structure, wherein at least one of the flow apertures has an aperture size that is larger than a nominal powder particle size of the powder particles; (vii) a plurality of the flow apertures have an aperture size that is larger than the nominal powder particle size of the powder; (viii) selectively controlling the flow of the powder from the supply outlet with a shutter assembly; (ix) the powder supply assembly having a plurality of supply modules that individually deposit powder on the build platform; and/or (x) substantially aligning the supply modules along an axis.

In another implementation, the processing machine includes (i) a mover that moves the build platform so a specific position on the build platform is moved along a moving direction; (ii) a powder supply assembly which supplies the powder to the moving build platform; (iii) an energy system irradiates at least a portion of the powder layer with an energy beam to form at least a portion of the object from the powder layer during a first period of time; and (iv) a measurement device which measures at least portion of the object during a second period of time; wherein at least part of the first period in which the energy system irradiates the powder with the energy beam and at least part of the second period in which the measurement device measures are overlapped.

In still another implementation, the processing machine includes: (i) a mover which moves the build platform so as to move a specific position on the build platform along a moving direction; (ii) a powder supply assembly which supplies a powder to the build platform which moves, and forms a powder layer; and (iii) an irradiation device that changes an irradiation position where the beam is irradiated to the powder layer along a direction crossing the moving direction.

In yet another implementation, the processing machine includes: (i) a mover which moves the build platform so as to move a specific position on the build platform along a moving direction; (ii) a powder supply assembly which supplies a powder to the build platform which moves, and forms a powder layer; and (iii) an irradiation device (also referred to as an energy system) including a plurality of irradiation systems which irradiate the layer with an energy beam to form a built part from the powder layer, wherein the irradiation systems arranged along a direction crossing the moving direction.

In still another implementation, the processing machine includes: (i) a build platform; (ii) a powder supply assembly that deposits the powder onto the build platform; and (iii) a mover that rotates at least one of the build platform and the powder supply device about a rotation axis while the powder supply device deposits the powder onto the build platform.

In another implementation, the processing machine includes: (i) a build platform including a support surface; (ii) a mover which moves the build platform so a specific position on the support surface is moved along a moving direction; (iii) a powder supply assembly which supplies a powder to the moving build platform to form a powder layer during a powder supply time; and (iv) an energy system device which irradiates at least a portion of the powder layer with an energy beam to form at least a portion of the object from the powder layer during an irradiation time; and wherein at least part of the powder supply time and the irradiation time are overlapped.

In still another implementation, the processing machine includes: (i) a build platform including a non-flat support surface; (ii) a powder supply device which supplies a powder to the build platform and which forms a curved powder layer; and (iii) an energy system which irradiates the layer with an energy beam to form a built part from the powder layer.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified side view of an implementation of a processing machine having features of the present embodiment;

FIG. 1B is a simplified top view of a portion of the processing machine of FIG. 1A;

FIG. 2 is a simplified side view of another implementation of a processing machine having features of the present embodiment;

FIG. 3 is a simplified side view of still another implementation of a processing machine having features of the present embodiment;

FIG. 4 is a simplified top view of a powder bed assembly;

FIG. 5 is a simplified top view of another implementation of a powder bed assembly;

FIG. 6A is a perspective view of a portion of a powder bed assembly and a powder supply assembly;

FIG. 6B is a cut-away view taken on line 6B-6B in FIG. 6A.

FIG. 6C is a cut-away view of the powder supply assembly of FIG. 6B at a different time;

FIG. 6D is a cut-away view taken from line 6D-6D in FIG. 6A;

FIG. 6E is a simplified top view of the powder supply assembly without powder;

FIG. 6F is a top view of a flow controller;

FIG. 6G is a side view another flow controller;

FIG. 7 is a cut-away view of another powder supply assembly;

FIG. 8 is a simplified top view of still another powder supply assembly;

FIG. 9A is a perspective view of another powder supply assembly and powder bed assembly;

FIG. 9B is a cut-away perspective of the powder supply assembly and powder bed assembly of FIG. 9A;

FIG. 9C is an enlarged view of a portion of the powder supply assembly of FIG. 9B;

FIG. 9D is a top view of a portion of the powder supply assembly of FIG. 9A;

FIG. 9E is an enlarged view of a portion of the powder supply assembly of FIG. 9D;

FIG. 9F is a cut-away view taken on line 9F-9F of FIG. 9D;

FIG. 10A is a perspective view of yet another powder supply assembly and powder bed assembly;

FIG. 10B is a top view of a portion of the powder supply assembly of FIG. 10A;

FIG. 100 is a cut-away view taken on line 100-100 of FIG. 10B;

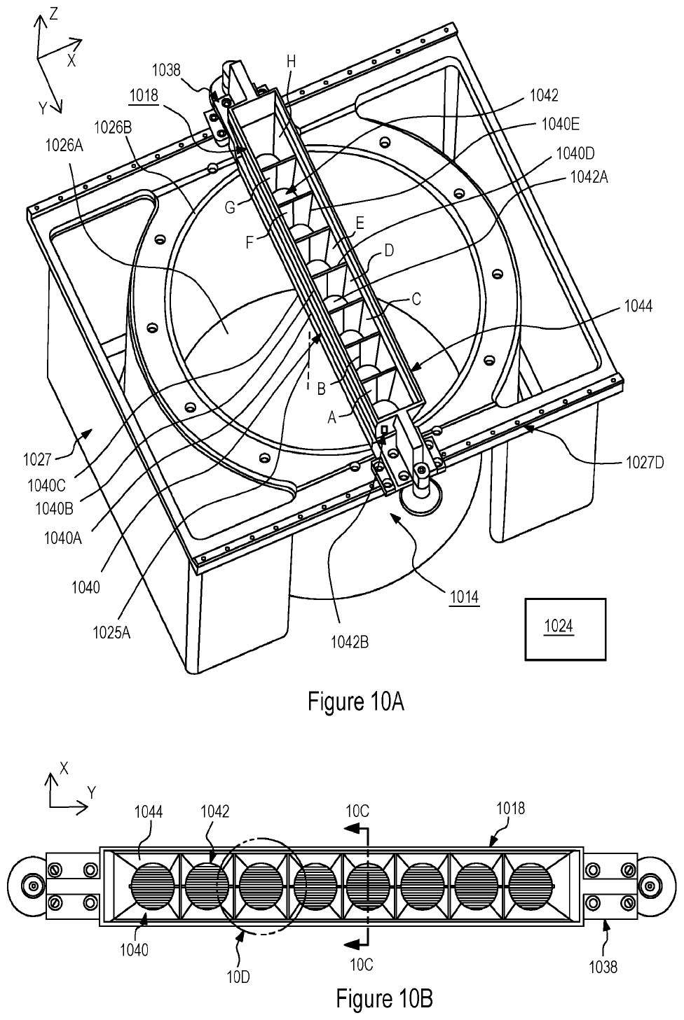

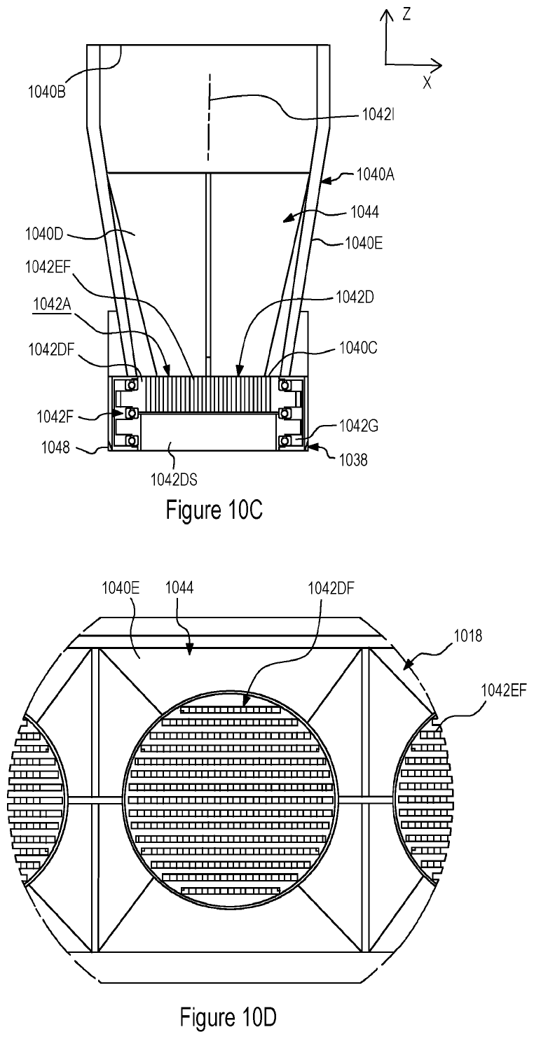

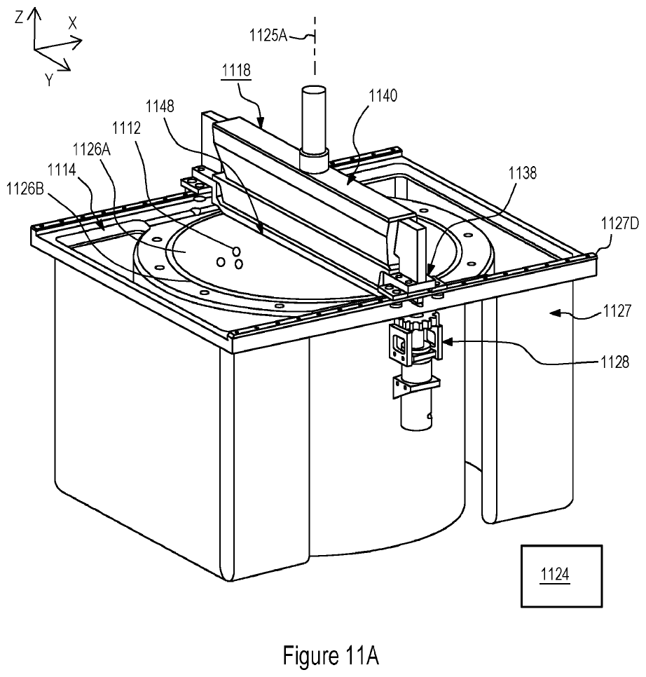

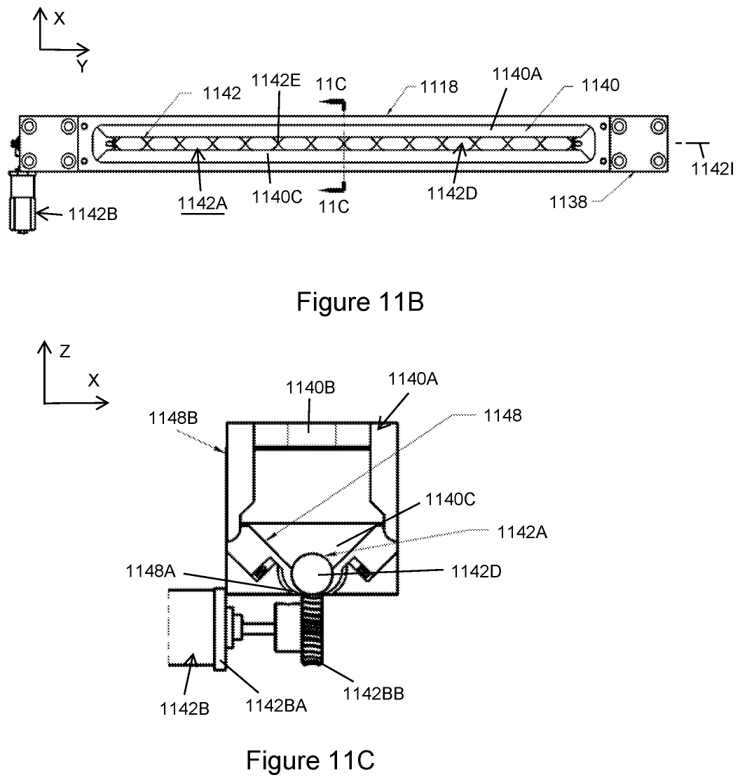

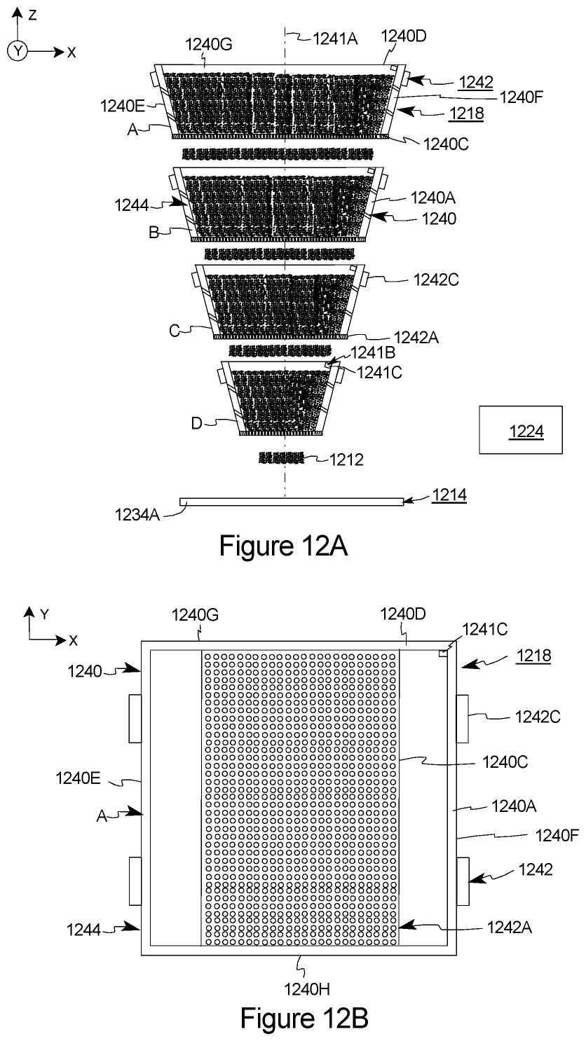

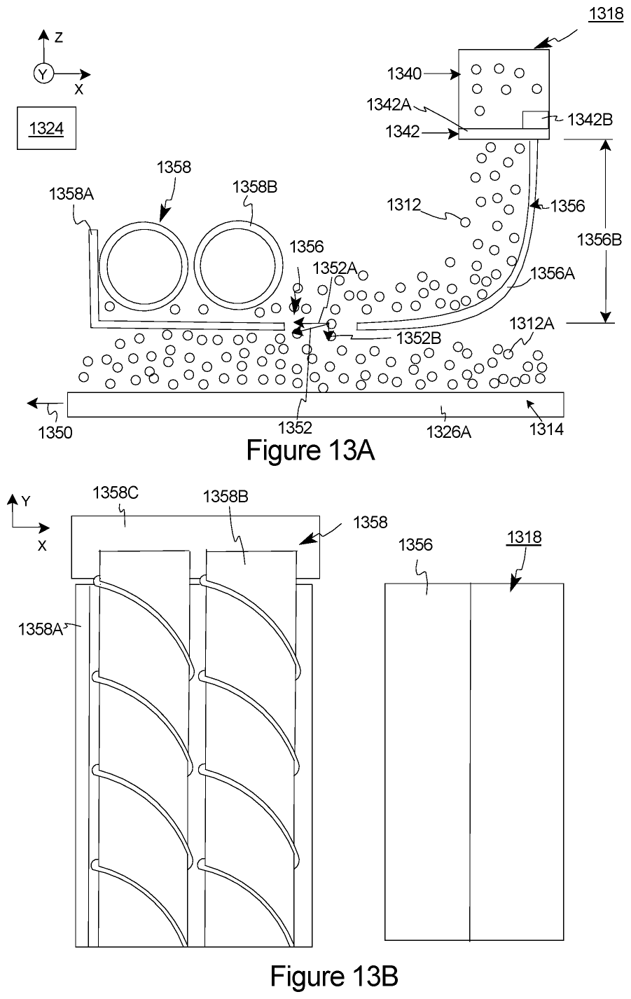

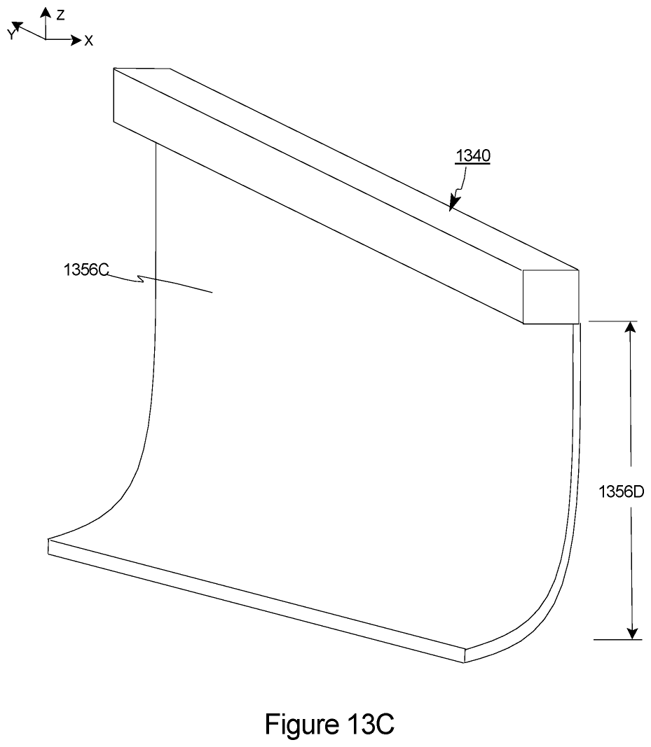

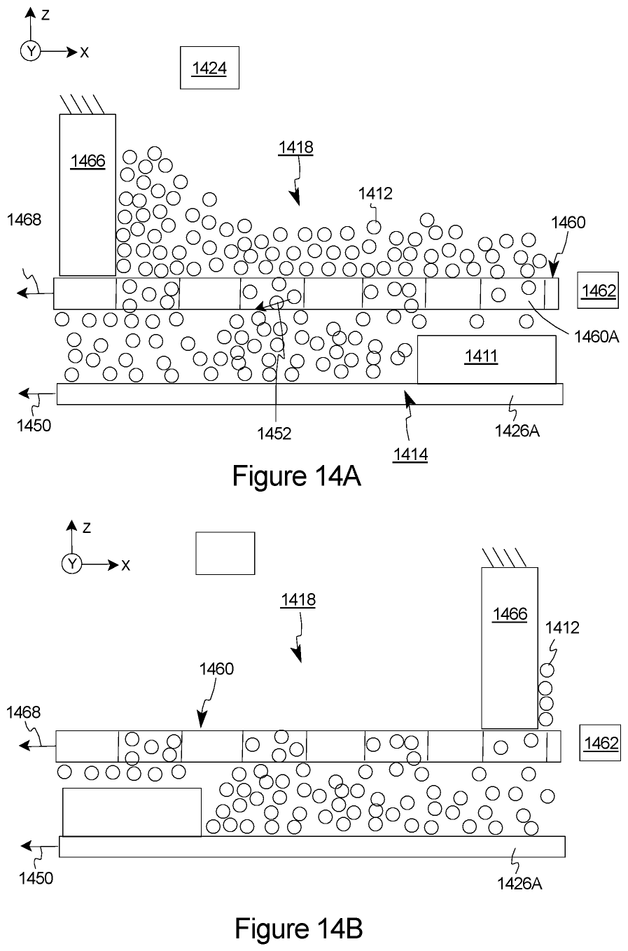

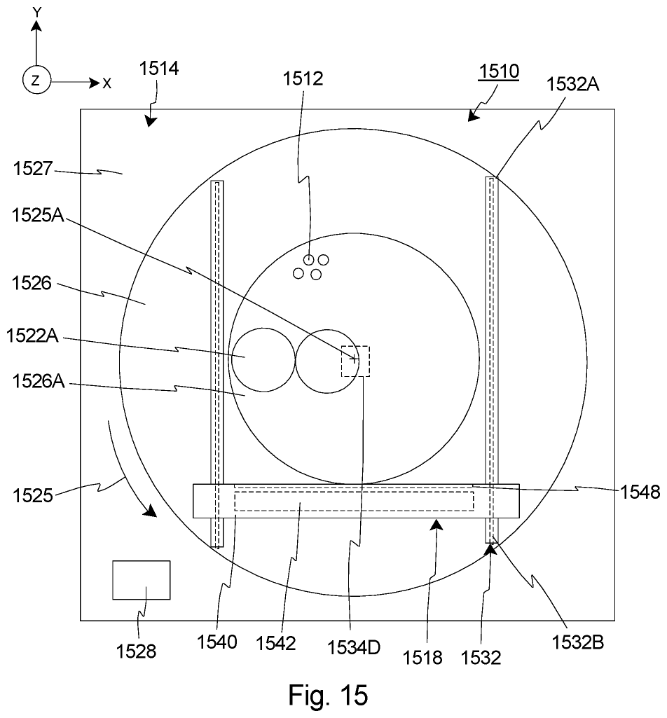

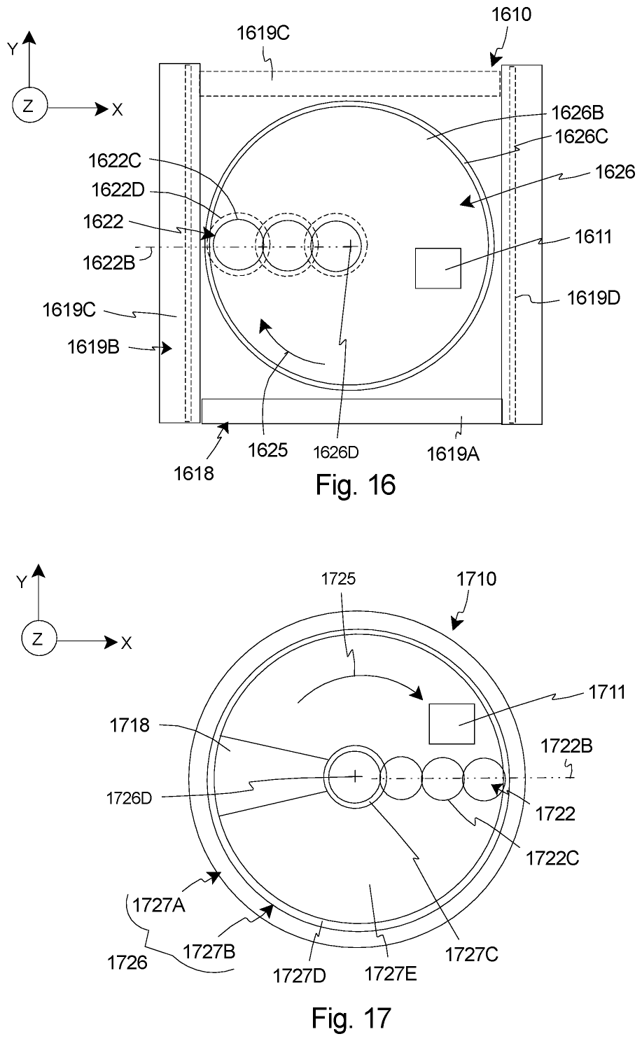

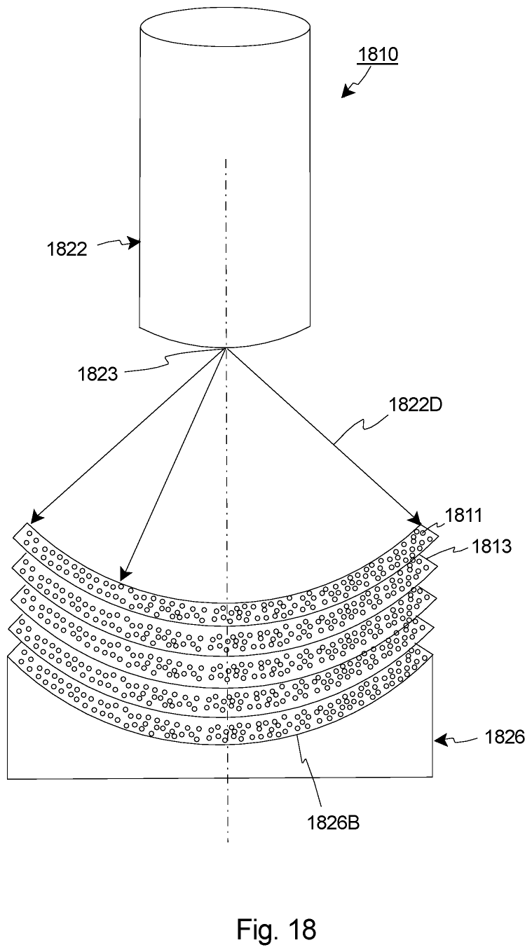

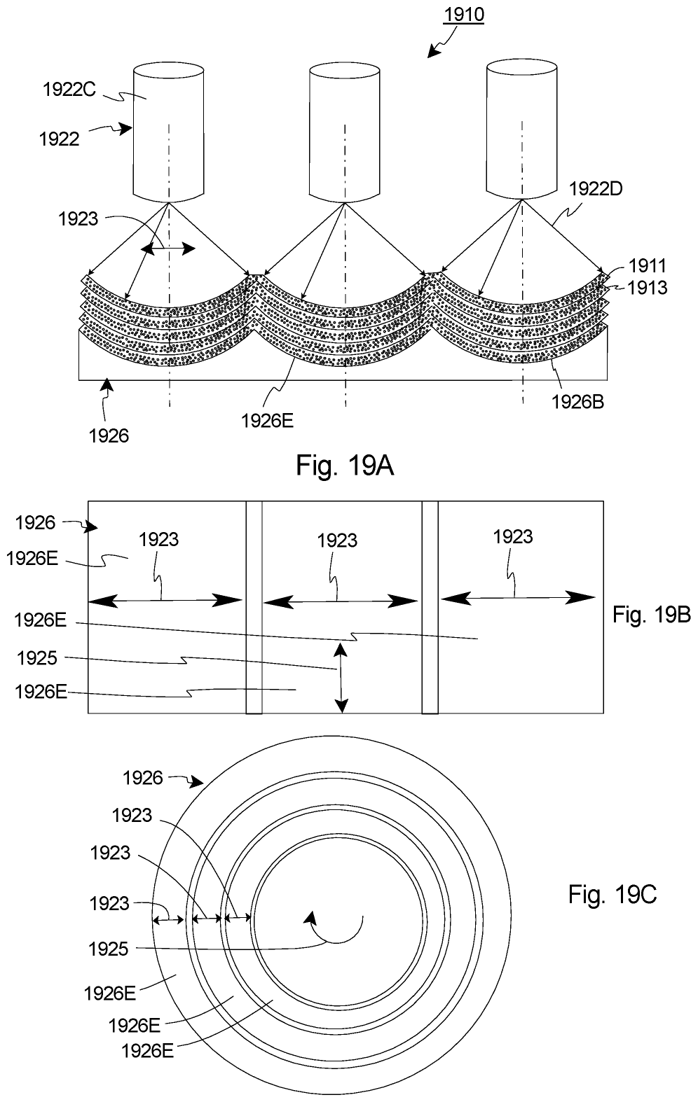

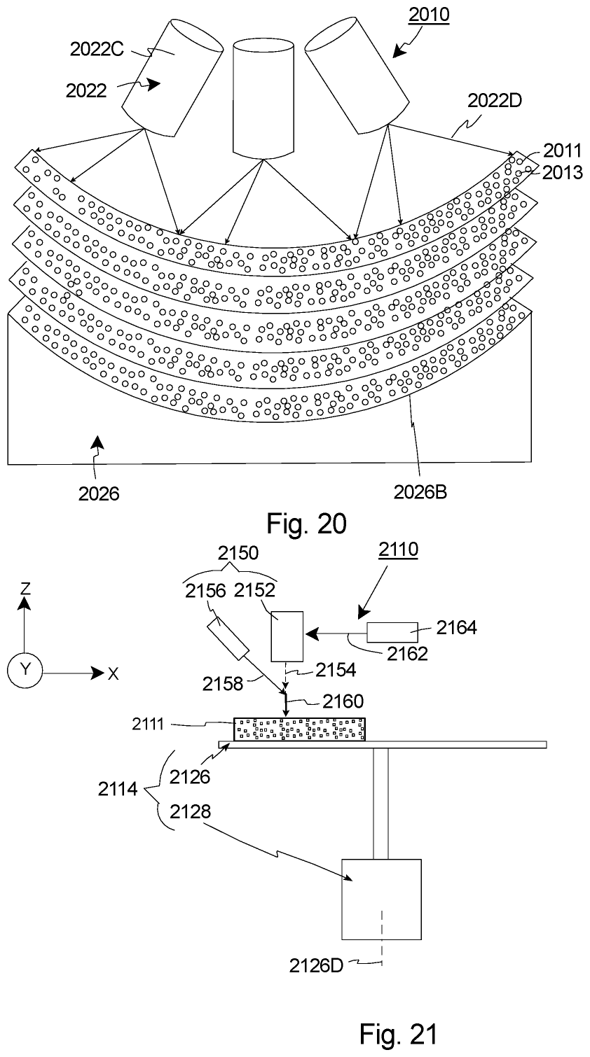

FIG. 10D is an enlarged view of a portion of the powder supply assembly of FIG. 10B;

FIG. 11A is a perspective view of still another powder supply assembly and powder bed assembly;

FIG. 11B is a top view of a portion of the powder supply assembly of FIG. 11A;

FIG. 110 is a cut-away view taken on line 11C-110 of FIG. 11B;

FIG. 12A is a partial cut-away view of another implementation of the powder supply assembly with a portion of a powder bed assembly;

FIG. 12B is a simplified top view of a portion of the powder supply assembly FIG. 12A;

FIG. 13A is a side view of another implementation of the powder supply assembly with a portion of a powder bed assembly;

FIG. 13B is a simplified top view of a portion of the powder supply assembly FIG. 13A;

FIG. 13C is a simplified perspective view of a ramp;

FIG. 14A is a simplified side view of another implementation of the powder supply assembly and the powder bed assembly;

FIG. 14B is a simplified side view of FIG. 14A subsequently in time;

FIG. 15 is a top view of another implementation of a processing machine;

FIG. 16 is a simplified top view of a portion of still another embodiment of a processing machine;

FIG. 17 is a simplified top view of a portion of still another embodiment of a processing machine for building an object from powder;

FIG. 18 is a simplified side illustration of a portion of yet another embodiment of the processing machine;

FIG. 19A is a simplified side illustration of a portion of yet another embodiment of the processing machine;

FIG. 19B is a top view of a support bed in which curved support regions are shaped into linear rows;

FIG. 19C is a top view of a support bed in which curved support regions are shaped into annular rows;

FIG. 20 is a simplified side illustration of a portion of still another embodiment of the processing machine; and

FIG. 21 is a simplified side perspective illustration of a portion of yet another embodiment of the processing machine for building an object from powder.

### DESCRIPTION

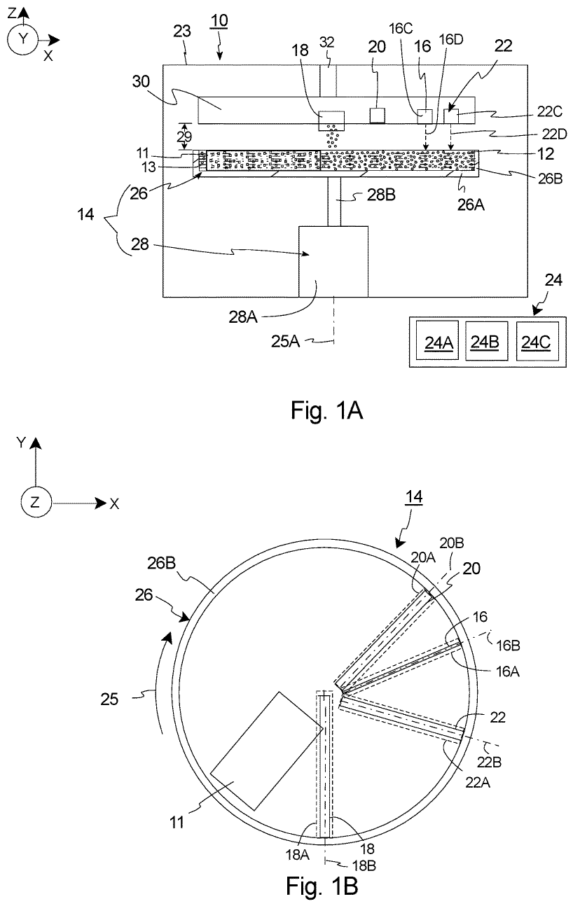

FIG. 1A is a simplified schematic side illustration of a processing machine 10 that may be used to manufacture one or more three-dimensional objects 11. As provided herein, the processing machine 10 can be an additive manufacturing system, e.g. a three-dimensional printer, in which a portion of the powder 12 (powder particles illustrated as small circles) in a series of powder layers 13 (illustrated as dashed horizontal lines) is joined, melted, solidified, and/or fused together to manufacture one or more three-dimensional object(s) 11. In FIG. 1A, the object 11 includes a plurality of small squares that represent the joining of the powder 12 to form the object 11.

The type of three-dimensional object(s) 11 manufactured with the processing machine 10 may be almost any shape or geometry. As a non-exclusive example, the three-dimensional object 11 may be a metal part, or another type of part, for example, a resin (plastic) part or a ceramic part, etc. The three-dimensional object 11 may also be referred to as a “built part”.

The type of powder 12 joined and/or fused together may be varied to suit the desired properties of the object(s) 11. As a non-exclusive example, the powder 12 may include metal powder grains (e.g., including one or more of titanium, aluminum, vanadium, chromium, copper, stainless steel, or other suitable metals) or alloys for metal three-dimensional printing. Alternatively, the powder 12 may be non-metal powder, a plastic, polymer, glass, ceramic powder, organic powder, an inorganic powder, or any other material known to people skilled in the art. The powder 12 may also be referred to as “material” or “powder particles”.

A number of different designs of the processing machine 10 are provided herein. In certain implementations, the processing machine 10 includes (i) a powder bed assembly 14; (ii) a pre-heat device 16; (iii) a powder supply assembly 18 (illustrated as a box); (iii) a measurement device 20 (illustrated as a box); (iv) an energy system 22 (illustrated as a box); and (v) a control system 24 (illustrated as a box) that cooperate to make each three-dimensional object 11. The design of each of these components may be varied pursuant to the teachings provided herein. Further, the positions of the components of the processing machine 10 may be different than that illustrated in FIG. 1. Moreover, the processing machine 10 can include more components or fewer components than illustrated in FIG. 1A. For example, the processing machine 10 can include a cooling device (not shown in FIG. 1A) that uses radiation, conduction, and/or convection to cool the powder 12. Alternatively, for example, the processing machine 10 can be designed without the pre-heat device 16 and/or the measurement device 20.

A number of different powder supply assemblies 18 are disclosed herein. As an overview, these powder supply assemblies 18 are uniquely designed to accurately, efficiently, evenly, and quickly distribute the powder layers 13 onto the powder bed assembly 14. Further, in certain implementations, the powder supply assembly 18 is centerless, and uniformly distributes a fine layer of the powder 12 over a large and broad powder bed assembly 14. This will improve the accuracy of the built object 11, and reduce the time required to form the built object 11.

The thickness of each powder layer 13 can be varied to suit the manufacturing requirements. In alternative, non-exclusive examples, one or more (e.g. all) of the powder layers 13 can have a uniform layer thickness (along the Z axis) of approximately twenty, thirty, forty, fifty, sixty, seventy, eighty, or ninety, or one hundred microns. However other layer thicknesses are possible. Particle sizes of the powder 12 can be varied. In one implementation, a common particle size is approximately fifty microns. Alternatively, in other non-exclusive examples, the particle size can be approximately twenty, thirty, forty, sixty, seventy, eighty, or ninety, or one hundred microns.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes. Further, as used herein, movement with six degrees of freedom shall mean along and about the X, Y, and Z axes.

In FIG. 1A, a portion of the powder bed assembly 14 is illustrated in cut-away so that the powder 12, the powder layers 13 and the object 11 are visible. With the present design, one or more objects 11 can be simultaneously made with the processing machine 10. In FIG. 1A, only one object 11 is visible.

It should be noted that any of the processing machines 10 described herein may be operated in a controlled environment, e.g. such as a vacuum, using an environmental chamber 23 (illustrated in FIG. 1A as a box). For example, one or more of the components of the processing machine 10 can be positioned entirely or partly within the environmental chamber 23. Alternatively, at least a portion of one or more of the components of the processing machine 10 may be positioned outside the environmental chamber 23. Still alternatively, the processing machine 10 may be operated in non-vacuum environment such as inert gas (e.g., nitrogen gas or argon gas) environment.

FIG. 1B is a simplified top view of a portion of the powder bed assembly 14 of FIG. 1A and the three-dimensional object 11. FIG. 1B also illustrates (i) the pre-heat device 16 (illustrated as box) and a pre-heat zone 16A (illustrated with dashed lines) which represents the approximate area in which the powder 12 can be pre-heated with the pre-heat device 16; (ii) the powder supply assembly 18 (illustrated as a box) and a deposit zone 18A (illustrated in phantom) which represents the approximate area in which the powder 12 can be added and/or spread to the powder bed assembly 14 by the powder supply assembly 18; (iii) the measurement device 20 (illustrated as a box) and a measurement zone 20A (illustrated in phantom) which represents the approximate area in which the powder 12 and/or the object 11 can be measured by the measurement device 20; and (iv) the energy system 22 (illustrated as a box) and an energy zone 22A which represents the approximate area in which the powder 12 can be melted and fused together by the energy system 22.

It should be noted that these zones may be spaced apart different, oriented differently, or positioned differently from the non-exclusive example illustrated in FIG. 1B. Additionally, the relative sizes of the zones 16A, 18A, 20A, 22A may be different than what is illustrated in FIG. 1B.

In FIGS. 1A and 1B, in certain implementations, the processing machine 10 can be operated so that there is substantially constant relative motion along a moving direction 25 (illustrated by an arrow) between the object 11 being formed and one or more of the pre-heat device 16, the powder supply assembly 18, the measurement device 20, and the energy system 22. The moving direction 25 may include a rotation direction about a rotation axis 25A. With this design, the powder 12 may be deposited and fused relatively quickly. This allows for the faster forming of the objects 11, increased throughput of the processing machine 10, and reduced cost for the objects 11.

In the implementation illustrated in FIGS. 1A and 1B, the powder bed assembly 14 includes (i) a powder bed 26 that supports the powder 12 and the object 11 while being formed, and (ii) a device mover 28 (e.g. one or more actuators) that selectively moves the powder bed 26. In this implementation, the device mover 28 rotates the powder bed 26 about the rotation axis 25A relative to the pre-heat device 16 (and the pre-heat zone 16A), the powder supply assembly 18 (and the deposit zone 18A), the measurement device 20 (and the measurement zone 20A), and the energy system 22 (and the irradiation zone 22A). This allows nearly all of the rest of the components of the processing machine 10 to be fixed while the powder bed 26 is moved.

In the simplified schematic illustrated in FIGS. 1A and 1B, the powder bed 26 includes a build platform 26A and a support side wall 26B. In this embodiment, the build platform 26A is flat disk shaped and has a support surface, and the support side wall 26B is tubular shaped and extends upward from a perimeter of the support surface 26A. Alternatively, other shapes of the build platform 26A and the support side wall 26B may be utilized. In some implementations, the build platform 26A is moved somewhat similar to a piston relative to the support side wall 26B which act like as the piston's cylinder wall. For example, a platform mover (not shown) can selectively move the build platform 26A downward as each subsequent powder layer 13 is added.

In another implementation, the build platform 26A is flat, rectangular shaped, and the support side wall assembly 26B are rectangular tube shaped and extends upward around the build platform 26A. Alternatively, other shapes of the build platform 26A and/or support side wall assembly 26B may be utilized. As non-exclusive examples, the build platform 26A can be polygonal-shaped, with the support side wall assembly 26B having the corresponding tubular-shape. In another implementation, the support side wall can be built concurrently as a custom shape around the object 11, while the object 11 is being built.

The device mover 28 can move the powder bed 26 at a substantially constant or variable angular velocity about the rotation axis 25A. As alternative, non-exclusive examples, the device mover 28 may move the powder bed 26 at a substantially constant angular velocity of at least approximately 1, 2, 5, 10, 20, 30, 60, 100 or more revolutions per minute (RPM). Stated in a different fashion, the device mover 28 may move the powder bed 26 at a substantially constant angular velocity of between one and one hundred revolutions per minute. As used herein, the term “substantially constant angular velocity” shall mean a velocity that varies less than 10% over time. In one embodiment, the term “substantially constant angular velocity” shall mean a velocity that varies less 0.2% from the target velocity. The device mover 28 may also be referred to as a “drive device”.

Additionally or alternatively, the device mover 28 may move the powder bed 26 at a variable velocity or in a stepped or other fashion. For example, it may be desired to speed up or slow down the rotation of the powder bed 26 for some sections, either as part of a normal cycle like increase time under pre-heater, or as a smart corrective action during the build (e.g. to repair a defect). The rotation axis 25A may be aligned along with gravity direction, and may be along with an inclination direction about the gravity direction.

In FIG. 1A, the device mover 28 includes a motor 28A (i.e. a rotary motor) and a device connector 28B (i.e. a rigid shaft) that fixedly connects the motor 28A to the powder bed 26. In other embodiments, the device connector 28B may include a transmission device such as at least one gear, belt, chain, or friction drive.

The powder 12 used to make the object 11 is deposited onto the powder bed 26 in a series of powder layers 13. Depending upon the design of the processing machine 10, the powder bed 26 with the powder 12 may be very heavy. With the present design, this large mass may be rotated at a constant or substantially constant speed to avoid accelerations and decelerations, and the required motion is a continuous rotation of a large mass, with no non-centripetal acceleration other than at the beginning and end of the entire exposure process. The melting process may be performed during the period when the motion is constant velocity motion.

The pre-heat device 16 selectively preheats the powder 12 in the pre-heat zone 16A that has been deposited on the powder bed 26 during a pre-heat time. In certain embodiments, the pre-heat device 16 heats the powder 12 to a desired preheated temperature in the pre-heat zone 16A when the powder 12 is moved through the pre-heat zone 16A. The number of the pre-heat devices 16 may be one or plural.

In one embodiment, the pre-heat device 16 is positioned along a pre-heat axis (direction) 16B and is arranged between the measurement device 20 and the energy system 22. However, the pre-heat device 16 can be positioned at another location.

The design of the pre-heat device 16 and the desired preheated temperature may be varied. In one embodiment, the pre-heat device 16 may include one or more pre-heat energy source(s) 16C that direct one or more pre-heat beam(s) 16C at the powder 12. Each pre-heat beam 16D may be steered as necessary. As alternative, non-exclusives examples, each pre-heat energy source 16C may be an electron beam system, a mercury lamp, an infrared laser, a supply of heated air, thermal radiation system, a visual wavelength optical system or a microwave optical system. The desired preheated temperature may be 50% 75% 90% or 95% of the melting temperature of the powder material used in the printing. It is understood that different powders have different melting points and therefore different desired pre-heating points. As non-exclusive examples, the desired preheated temperature may be at least 300, 500, 700, 900, or 1000 degrees Celsius. Energy input may also vary dependent on melt duty of previous layers, specific regions on a layer, or progress though the build.

The powder supply assembly 18 deposits the powder 12 onto the powder bed 26. In certain embodiments, the powder supply assembly 18 supplies the powder 12 to the powder bed 26 in the deposit zone 18A while the powder bed 26 is being moved to form each powder layer 13 on the powder bed 26.

In one implementation, the powder supply assembly 18 extends along a powder supply axis (direction) 18B and is arranged between the measurement device 20 and the energy system 22. The powder supply assembly 18 can include one or more powder containers (not shown in FIGS. 1A and 1B). The number of the powder supply assemblies 18 may be one or plural.

With the present design, the powder supply assembly 18 deposits the powder 12 onto the powder bed assembly 14 to sequentially form each powder layer 13. Once a portion of the powder layer 13 has been melted with the energy system 22, the powder supply assembly 18 evenly and uniformly deposits another (subsequent) powder layer 13.

It should be noted that the three-dimensional object 11 is formed through consecutive fusions of consecutively formed cross sections of powder 12 in one or more powder layers 13. For simplicity, the example of FIG. 1A illustrates only a few, separate, stacked powder layers 13. However, it should be noted that depending upon the design of the object 11, the building process will require numerous powder layers 13

A number of alternative powder supply assemblies 18 are described in more detail below. In these embodiments, the powder supply assembly 18 is an overhead powder supply that supplies the powder 12 onto the top of the powder bed assembly 14.

The measurement device 20 inspects and monitors the melted (fused) layers of the object 11 as that are being built, and/or the deposition of the powder layers 13. The number of the measurement devices 20 may be one or plural. For example, the measurement device 20 can measure both before and after the powder 12 is distributed.

As non-exclusive examples, the measurement device 20 may include one or more optical elements such as a uniform illumination device, fringe illumination device (structured illumination device), cameras that function at one or more wavelengths, lens, interferometer, or photodetector, or a non-optical measurement device such as an ultrasonic, eddy current, or capacitive sensor.

In one implementation, the measurement device 20 is arranged between the powder supply assembly 18 and the pre-heat device 16, however, the measurement device 20 may be alternatively located.

The energy system 22 selectively heats and melts the powder 12 in the energy zone 22A to sequentially form each of the layers of the object 11 while the powder bed 26 and the object 11 are being moved. The energy system 22 can selectively melt the powder 12 at least based on a data regarding to the object 11 to be built. The data may be corresponding to a computer-aided design (CAD) model data. The number of the energy systems 22 may be one or plural.

In one embodiment, the energy system 22 is positioned along an energy axis (direction) 22B and is arranged between the pre-heat device 16 and the powder supply assembly 18. The design of the energy system 22 can be varied. In one embodiment, the energy system 22 may include one or more energy source(s) 22C (“irradiation systems”) that direct one or more irradiation (energy) beam(s) 22D at the powder 12. The one or more energy sources 22C can be controlled to steer the energy beam(s) 22D to melt the powder 12.

As alternative, non-exclusives examples, each of the energy sources 22C can be designed to include one or more of the following: (i) an electron beam generator that generates a charged particle electron beam; (ii) an irradiation system that generates an irradiation beam; (iii) an infrared laser that generates an infrared beam; (iv) a mercury lamp; (v) a thermal radiation system; (vi) a visual wavelength system; (vii) a microwave wavelength system; or (viii) an ion beam system.

Different powders 12 have different melting points. As non-exclusive examples, the desired melting temperature may be at least 1000, 1400, 1700, 2000, or more degrees Celsius.

The control system 24 controls the components of the processing machine 10 to build the three-dimensional object 11 from the computer-aided design (CAD) model by successively melting portions of one or more of the powder layers 13. For example, the control system 24 can control (i) the powder bed assembly 14; (ii) the pre-heat device 16; (iii) the powder supply assembly 18; (iii) the measurement device 20; and (iv) the energy system 22. The control system 24 can be a distributed system.

The control system 24 may include, for example, a CPU (Central Processing Unit) 24A, a GPU (Graphics Processing Unit) 24B, and electronic memory 24C. The control system 24 functions as a device that controls the operation of the processing machine 10 by the CPU executing the computer program. This computer program is a computer program for causing the control system 24 (for example, a CPU) to perform an operation to be described later to be performed by the control system 24 (that is, to execute it). That is, this computer program is a computer program for making the control system 24 function so that the processing machine 10 will perform the operation to be described later. A computer program executed by the CPU may be recorded in a memory (that is, a recording medium) included in the control system 24, or an arbitrary storage medium built in the control system 24 or externally attachable to the control system 24, for example, a hard disk or a semiconductor memory. Alternatively, the CPU may download a computer program to be executed from a device external to the control system 24 via the network interface. Further, the control system 24 may not be disposed inside the processing machine 10, and may be arranged as a server or the like outside the processing machine 10, for example. In this case, the control system 24 and the processing machine 10 may be connected via a communication line such as a wired communications line (cable communications), a wireless communications line, or a network. In case of physically connecting with wired, it is possible to use serial connection or parallel connection of IEEE1394, RS-232x, RS-422, RS-423, RS-485, USB, etc. or 10BASE-T, 100BASE-TX, 1000BASE-T or the like via a network. Further, when connecting using radio, radio waves such as IEEE 802.1x, OFDM, or the like, radio waves such as Bluetooth (registered trademark), infrared rays, optical communication, and the like may be used. In this case, the control system 24 and the processing machine 10 may be configured to be able to transmit and receive various types of information via a communication line or a network. Further, the control system 24 may be capable of transmitting information such as commands and control parameters to the processing machine 10 via the communication line and the network. The processing machine 10 may include a receiving device (receiver) that receives information such as commands and control parameters from the control system 24 via the communication line or the network. As a recording medium for recording the computer program executed by the CPU, a CD-ROM, a CD-R, a CD-RW, a flexible disk, an MO, a DVD-ROM, a DVD-RAM, a DVD-R, a DVD+R, a DVD-RW, a magnetic medium such as a magnetic disk and a magnetic tape such as DVD+RW and Blu-ray (registered trademark), a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program can be executed in the form of software, firmware or the like. Furthermore, each processing and function included in the program may be executed by program software that can be executed by a computer, or processing of each part may be executed by hardware such as a predetermined gate array (FPGA, ASIC) or program software, and a partial hardware module that realizes a part of hardware elements may be implemented in a mixed form.

It should also be noted that with the unique designs provided herein, multiple operations may be performed at the same time (simultaneously) to improve the throughput of the processing machine 10. Stated in another fashion, one or more of (i) pre-heating with the pre-heat device 16, (ii) measuring with the measurement device 20, (iii) depositing powder 12 with the powder supply assembly 18, and (iv) melting the powder with the energy system 22 may be partly or fully overlapping in time on different parts of the powder bed 26 to improve the throughput of the processing machine 10. For example, two, three, four, or all five of these functions may be partly or fully overlapping.

In certain implementations, the powder bed 26 may be moved down with the device mover 28 along the rotation axis 25A in a continuous rate via a fine pitch screw or some equivalent method. With this design, a height 29 between the most recent (top) powder layer 13 and the powder supply assembly 18 (and other components) may be maintained substantially constant for the entire process. Alternatively, the powder bed 26 may be moved down in a step down fashion at each rotation, which could lead to the possibility of a discontinuity at one radial position in the powder bed 26. As used herein, “substantially constant” shall mean the height 29 varies by less than a factor of three, since the typical thickness of each powder layer is less than one millimeter. In another embodiment, “substantially constant” shall mean the height 29 varies less than ten percent of the height 29 during the manufacturing process.

In this implementation, only the powder bed 26 is primarily moved, while everything else (pre-heat device 16, powder supply assembly 18, measurement device 20, energy system 22) are all fixed, making the overall system simpler. Also, the throughput of a rotary based powder bed 26 system is much higher since one or more steps can be performed in parallel rather than serially.

In the simplified example of FIG. 1A, the processing machine 10 additionally includes a component housing 30 that retains the pre-heat device 16, the powder depositor 18, the measurement device 20, and the energy system 22. Collectively these components may be referred to as the top assembly. Further, the processing machine 10 can include a housing mover 32 that can be controlled to selectively move the top assembly. The housing mover 32 and the device mover 28 may each include one or more actuators (e.g. linear or rotary). The housing mover 32 and/or the device mover 28 may be referred to as a first mover or a second mover.

It should be noted that processing machine 10 can be designed to have one or more of the following features: (i) one or more of the pre-heat device 16, the powder supply assembly 18, the measurement device 20, and the energy system 22 can be selectively moved relative to the component housing 30 and/or the powder bed 26 with one or more of the six degrees of freedom; (ii) the component housing 30 with one or more of the pre-heat device 16, the powder supply assembly 18, the measurement device 20, and the energy system 22 can be selectively moved relative to the powder bed 26 with one or more of the six degrees of freedom; and/or (iii) the powder bed 26 can be selectively moved relative to the component housing 30 with one or more of the six degrees of freedom.

In a specific, alternative implementation, the housing mover 32 can move the top assembly (or a portion thereof) upward (e.g. along and/or transverse to the rotation axis 25A) relative to the powder bed 26 at a continuous (or stepped) rate while the powder 12 is being deposited to maintain the desired height 29.

Additionally, or alternatively, the housing mover 32 can rotate the top assembly (or a portion thereof) relative to the powder bed 26 about the rotation axis 25A relative to the powder bed 26 during the printing of the object 11. In this implementation, the powder bed 26 can be stationary, rotated about the rotation axis in the clockwise direction, rotated about the rotation axis in the counterclockwise direction, and/or or moved linearly along and/or transverse to the rotation axis 25A.

Stated in another fashion, the processing machine 10 illustrated in FIGS. 1A and 1B may be designed so that (i) the powder bed 26 is rotated about the Z axis and moved along the rotation axis 25A; or (ii) the powder bed 26 is rotated about the rotation axis 25A, and the component housing 30 and the top assembly are moved along the rotation axis 25A only to maintain the desired height 29. In certain embodiments, it may make sense to assign movement along the rotation axis 25A to one component and rotation about the rotation axis 25A to the other.

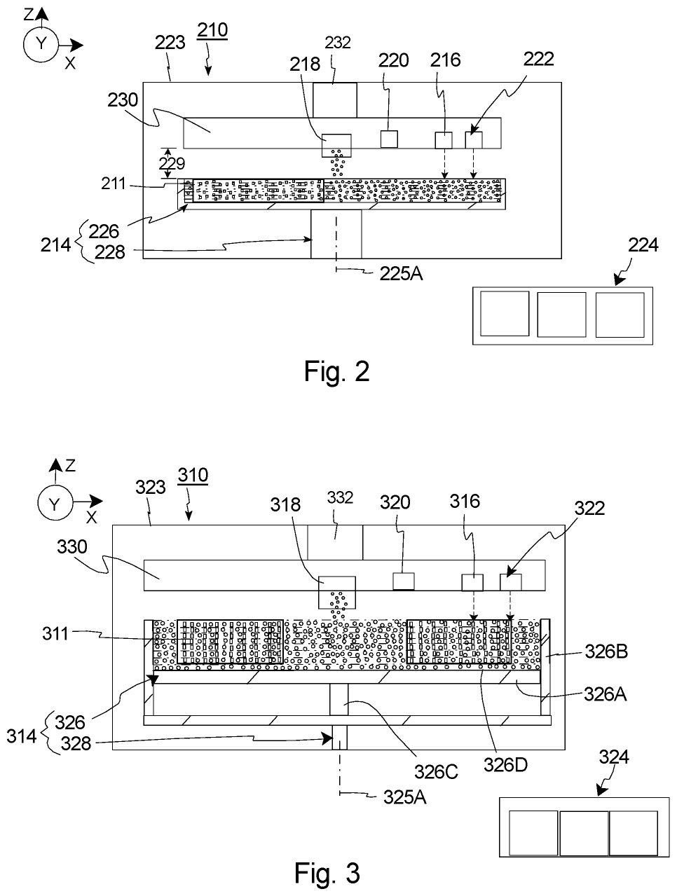

FIG. 2 is a simplified side view of another embodiment of a processing machine 210 for making the object 211 with a portion of the powder bed assembly 214 illustrated in cut-away. In this embodiment, the three-dimensional printer 210 includes (i) a powder bed assembly 214; (ii) a pre-heat device 216 (illustrated as a box); (iii) a powder supply assembly 218 (illustrated as a box); (iv) a measurement device 220 (illustrated as a box); (v) an energy system 222 (illustrated as a box); (vi) an environmental chamber 223; and (vii) a control system 224 that are somewhat similar to the corresponding components described above. However, in this embodiment, the powder bed 226 of the powder bed assembly 214 can be stationary, and the housing mover 232 moves the component housing 230 with one or more of the pre-heat device 216, the powder supply assembly 218, the measurement device 220, and the energy system 222 relative to the powder bed 226.

As a non-exclusive example, the housing mover 232 may rotate the component housing 230 with the pre-heat device 216, the powder supply assembly 218, the measurement device 220, and the energy system 222 (collectively “top assembly”) at a constant or variable velocity about the rotation axis 225A. Additionally or alternatively, the housing mover 232 may move the top assembly along the rotation axis 225A.

It should be noted that the processing machine 210 of FIG. 2 may be designed so that (i) the top assembly is rotated about the Z axis and moved along the Z axis to maintain the desired height 233 with the housing mover 232; or (ii) the top assembly is rotated about the Z axis, and the powder bed 226 is moved along the Z axis only with a device mover 228 to maintain the desired height 229. In certain embodiments, it may make sense to assign Z movement to one component and rotation to the other.

In this embodiment, the powder bed assembly 214 can be generally circular disk shaped or rectangular shaped.

FIG. 3 is a simplified side view of another embodiment of a processing machine 310 for making one or more object(s) 11 (two are illustrated) with a portion of the powder bed assembly 314 illustrated in cut-away. In this implementation, the three-dimensional printer 310 includes (i) a powder bed assembly 314; (ii) a pre-heat device 316 (illustrated as a box); (iii) a powder supply assembly 318 (illustrated as a box); (iv) a measurement device 320 (illustrated as a box); (v) an energy system 322 (illustrated as a box); (vi) an environmental chamber 323; and (vii) a control system 324 that are somewhat similar to the corresponding components described above. However, in this embodiment, the powder bed 326 includes a platform mover 326C in addition to the build platform 326A and the support side wall 326B. In this implementation, the build platform 326A can be moved linearly downward as each subsequent powder layer is added relative to the support side wall 326B with the platform mover 326C.

In alternative, non-exclusive implementations, the build platform 326A can have a build area 326D that is (i) flat, circular disk shaped for use with a corresponding support side wall 326B that is circular tube shaped; (ii) flat rectangular shaped for use with a corresponding support side wall 326B that is rectangular tube shaped, or (iii) polygonal-shaped for use with a corresponding support side wall 326B that is polygonal tube shaped.

It should be noted that the processing machine 310 of FIG. 3 may be designed so that (i) one or more of the pre-heat device 316, the powder supply assembly 318, the measurement device 320, and the energy system 322 can be selectively moved relative to the component housing 330 and/or the powder bed 326 with one or more of the six degrees of freedom; (ii) the component housing 330 with one or more of the pre-heat device 316, the powder supply assembly 318, the measurement device 320, and the energy system 322 can be selectively moved relative to the powder bed 326 with one or more of the six degrees of freedom; and/or (iii) the powder bed 326 can be selectively moved relative to the component housing 330 with one or more of the six degrees of freedom.

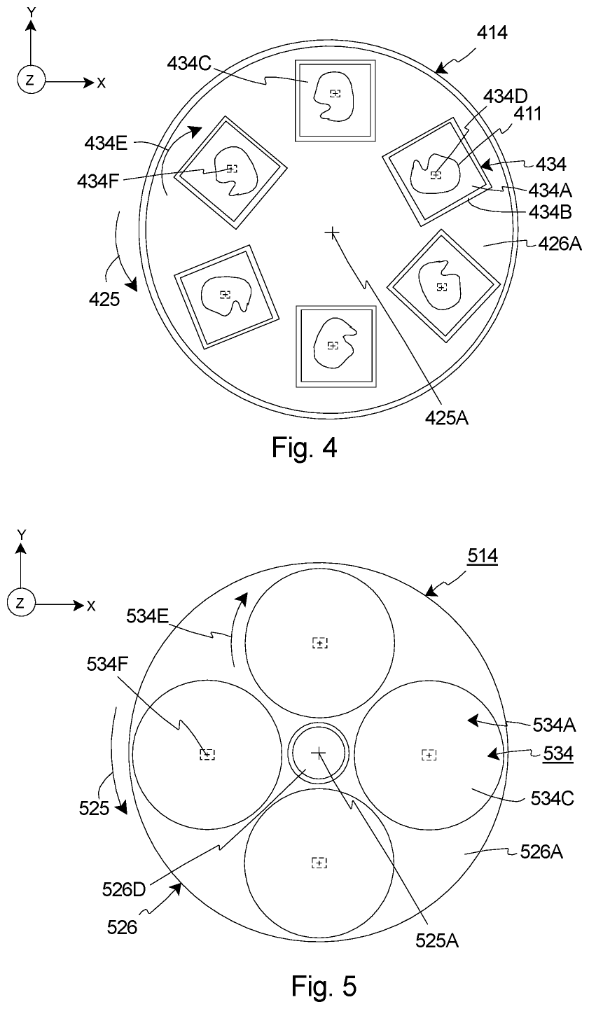

FIG. 4 is a simplified top illustration of a powder bed assembly 414 that can be used in any of the processing machines 10, 210, 310 disclosed herein. In this embodiment, the powder bed assembly 414 can be used to make multiple objects 411 substantially simultaneously. The number of objects 411 that may be made concurrently can vary according the type of object 411 and the design of the processing machine 10, 210, 310. In FIG. 4, six objects 411 are made simultaneously. Alternatively, more than six or fewer than six objects 411 may be made simultaneously.

In FIG. 4, each of the objects 411 is the same design. Alternatively, for example, the processing machine 10, 210, 310 may be controlled so that one or more different types of objects 411 are made simultaneously.

In FIG. 4, the powder bed assembly 414 includes a relatively large support platform 426A, and a plurality of separate, spaced apart, build assemblies 434 that are positioned on and supported by the support platform 426A. The number of separate build assemblies 434 can be varied. In FIG. 4, the powder bed assembly 414 includes six separate build assemblies 414, one for each object 411. With this design, a single object 411 is made in each build assembly 434. Alternatively, more than one object 411 may be built in each build assembly 434. Still alternatively, the powder bed assembly 414 can include more than six or fewer than six separate build assemblies 434.

In one, non-exclusive embodiment, the support platform 426A with the build assemblies 434 can be rotated like a turntable during printing of the objects 411 in a moving direction 425 about a support rotation axis 425A (illustrated with a “+”, e.g. the Z axis). With this design, each build assembly 434 is rotated about at least one axis 425A during the build process. Further, in this embodiment, the separate build assemblies 434 are spaced apart on the large common support platform 426A. The build assemblies 434 can be positioned on or embedded into the support platform 426A. As non-exclusive examples, the support platform 426A can be disk shaped or rectangular shaped.

As provided herein, each of the build assemblies 434 defines a separate, discrete build region. For example, each build assembly 434 can include a build platform 434A, and a sidewall assembly 434B. In one embodiment, each build assembly 434 is an open container in which the object 411 can be built. In this design, after the object 411 is printed, the build assembly 434 with the printed object 411 can be removed from the support platform 426A via a robotic arm (not shown in FIG. 4) and replaced with an empty build assembly 434 for subsequent fabrication of the next object 411.

As non-exclusive examples, each build platform 434A can define a build area 434C that is rectangular, circular, or polygonal shaped.

In an alternative embodiment, one or more of the build platforms 434A can be moved somewhat like an elevator vertically (along the Z axis) relative to its side wall assembly 434B with a platform mover assembly 434D (illustrated in phantom with a box) during fabrication of the objects 411. Each platform mover assembly 434D can include one or more actuators. Fabrication can begin with the build platform 434A placed near the top of the side wall assembly 434B. The powder supply assembly (not shown in FIG. 4) deposits a thin layer of powder into each build assembly 434 as it is moved (e.g. rotated) below the powder supply assembly. At an appropriate time, the build platform 434A in each build assembly 434 is stepped down by one layer thickness so the next layer of powder may be distributed properly.

In some embodiments, one or more platform mover assemblies 434D can also or alternatively be used to move (e.g. rotate) one or more of the build assemblies 434 relative to the support platform 426A and each other in a platform direction 434E about a platform rotation axis 434F (illustrated with a “+”, e.g. the Z axis). With this design, each build platform 434A can be rotated about two, separate, spaced apart and parallel axes 425A, 434F during the build process.

In one, non-exclusive example, the support platform 426A can be rotated (e.g., at a substantially constant rate) in the moving direction 425 (e.g. counterclockwise), and one or more of the build assemblies 434 can be moved (e.g. rotated) relative to the support platform 426A in the opposite direction 434E (e.g. clockwise) during the printing process. In this example, the rotational speed of the support platform 426A about the support rotational axis 425A can be approximately the same or different from the rotational speed of each build assembly 434 relative to the support platform 426A about the platform rotational axis 434F.

Alternatively, the support platform 426A can be rotated (e.g., at a substantially constant rate) in the moving direction 425 (e.g. counterclockwise), and one or more of the build assemblies 434 can be moved (e.g. rotated) relative to the support platform 426A in the same direction 434E (e.g. counterclockwise) during the printing process.

FIG. 5 is a simplified top illustration of another implementation of a powder bed assembly 514 that can be used in any of the processing machines 10, 210, 310 disclosed herein. In this implementation, the powder bed assembly 514 can be used to make multiple objects (not shown in FIG. 5) substantially simultaneously.

In FIG. 5, the powder bed assembly 514 includes a relatively large support platform 526A, and a plurality of separate, spaced apart, build assemblies 534 that are integrated into the support platform 526A. The number of separate build assemblies 534 can be varied. In FIG. 5, the powder bed assembly 514 includes four separate build assemblies 534. With this design, one or more objects can be made on each build assembly 534. Alternatively, the powder bed assembly 514 can include more than four or fewer than four separate build assemblies 534.

In FIG. 5, each build assembly 534 defines a separate build platform 534A that is selectively lowered like an elevator with a platform mover assembly 534D (illustrated in phantom with a box) into the support platform 526A during the manufacturing process. With this design, the support platform 526A can define the support side wall for each build platform 534A. Fabrication can begin with the build platform 534A placed near the top of the support platform 526A. The powder supply assembly (not shown in FIG. 5) deposits a thin layer of powder onto each build platform 534A as it is moved (e.g. rotated) below the powder supply assembly. At an appropriate time, each build platform 534A is stepped down by one layer thickness so the next layer of powder may be distributed properly. Alternatively, each build platform 534A can be moved in steps that are smaller than the powder layer or moved in a continuous fashion, rather than in discrete steps.

In this Figure, each build platform 534A defines a circular shaped build area 534C that receives the powder (not shown in FIG. 5). Alternatively, for example, each build area 534C can have a different configuration, e.g. rectangular or polygonal shaped.

Additionally, the support platform 526A can be annular shaped and powder bed 526 can include a central, support hub 526D. In this implementation, there can be relative movement (e.g. rotation) between the support platform 526A and the support hub 526D. As a result thereof, one or more of the other components (e.g. the powder supply assembly) of the processing machine (not shown in FIG. 5) can be coupled to the support hub 526D.

In one, non-exclusive embodiment, the support platform 526A with the build assemblies 534 can be rotated like a turntable during printing of the objects in a moving direction 525 about the support rotation axis 525A (illustrated with a “+”) relative to the support hub 526D. With this design, each build platform 534A is rotated about at least one axis 525A during the build process.

In some embodiments, one or more platform mover assemblies 534D can be used to move (e.g. rotate) one or more of the build assemblies 534 relative to the support platform 526A and each other in a platform direction 534E about a platform rotational axis 534F (illustrated with a “+”, e.g. along the Z axis). With this design, each build platform 534A can be rotated about two, separate, spaced apart and parallel axes 525A, 534F during the build process.

In one, non-exclusive example, the support platform 526A can be rotated (e.g., at a substantially constant rate) in the moving direction 525 (e.g. counterclockwise), and one or more of the build assemblies 534 can be moved (e.g. rotated) relative to the support platform 526A in the opposite, platform direction 534E (e.g. clockwise) during the printing process. In this example, the rotational speed of the support platform 526A about the support rotational axis 525A can be approximately the same or different from the rotational speed of each build assembly 534 relative to the support platform 526A about the platform rotational axis 434F.

Alternatively, the support platform 526A and one or more of the build assemblies 534 can be rotated in the same rotational direction during the three dimensional printing operation.

It should be noted that in FIGS. 4 and 5, a separate platform mover assembly 434D, 534D is used for each build assembly 434, 534. Alternatively, one or more of the platform mover assemblies 434D, 534D can be designed to concurrently move more than one build assembly 434,534.

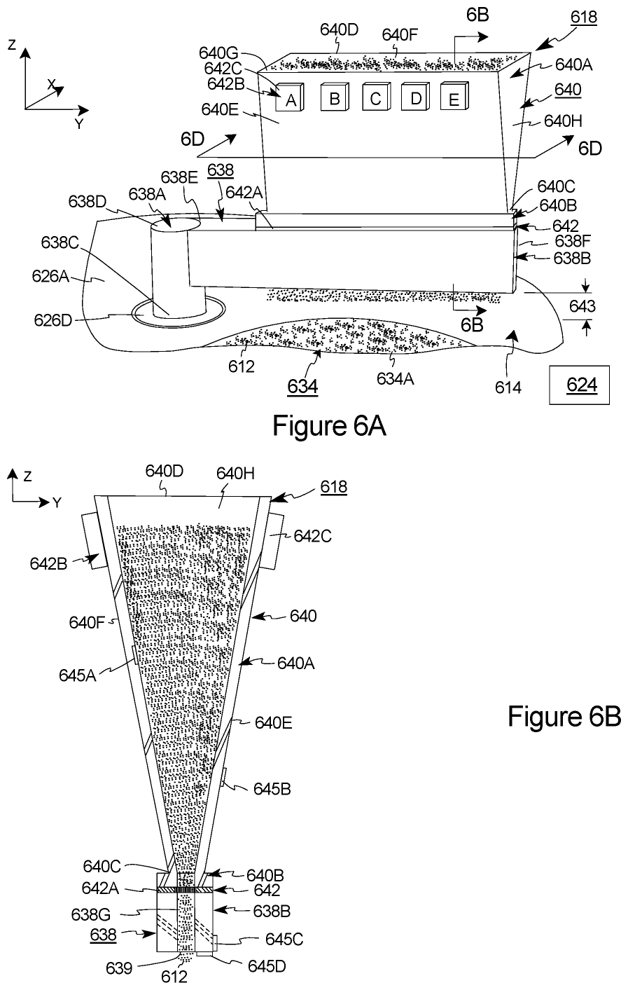

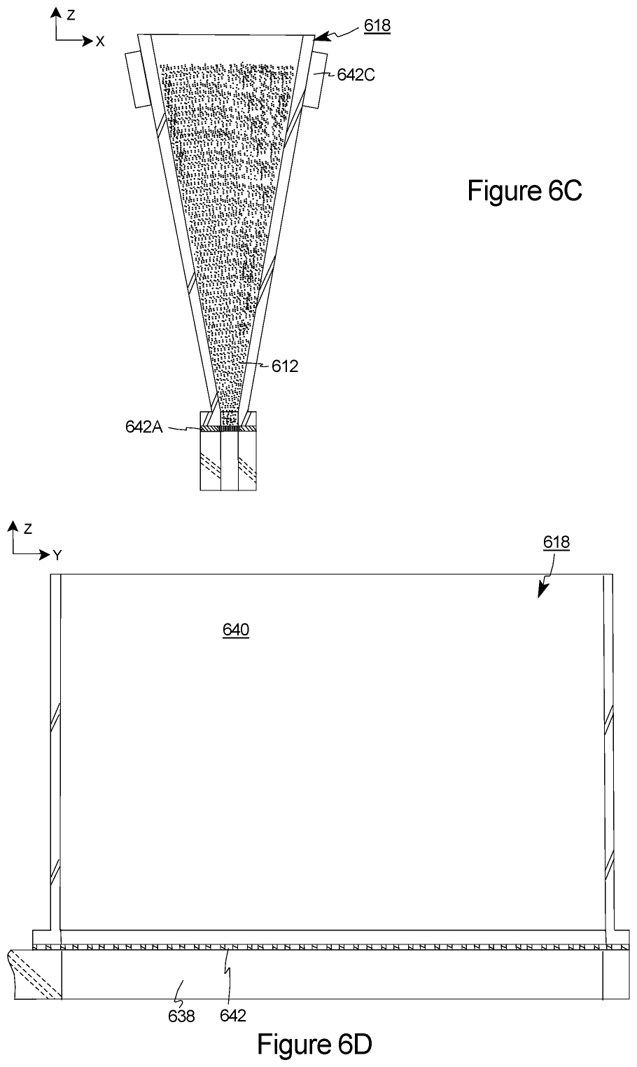

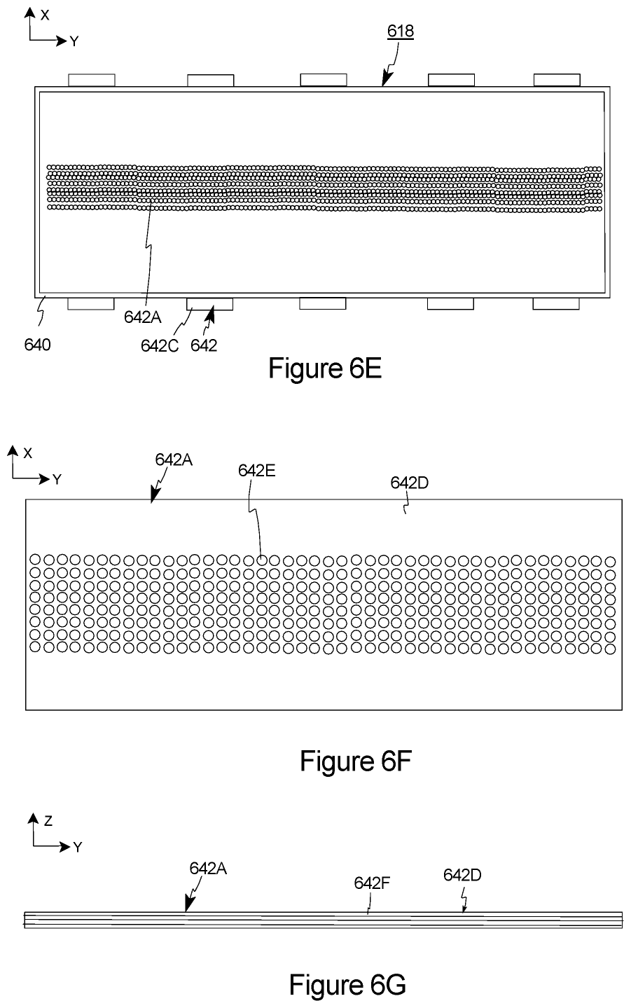

FIG. 6A is a perspective view of a portion of a powder bed assembly 614 including at least one build platform 634A, and a powder supply assembly 618 that can be integrated into in any of the processing machines 10, 210, 310 described above. For example, the powder bed assembly 614 and the powder supply assembly 618 can be designed to have one or more the following movement characteristics while powder 612 is being deposited on the build platform 634A: (i) the build platform 634A is stationary; (ii) the build platform 634A is moved relative to the powder supply assembly 618; (iii) the build platform 634A is moved linearly (along one or more axes) relative to the powder supply assembly 618; (iv) the build platform 634A is rotated (about one or more axes) relative to the powder supply assembly 618; (v) the powder supply assembly 618 is stationary; (vi) the powder supply assembly 618 is moved relative to the build platform 634A; (vii) the powder supply assembly 618 is moved linearly (along one or more axes) relative to the build platform 634A; and/or (viii) the powder supply assembly 618 is rotated (about one or more axes) relative to the build platform 634A. These can be collectively referred to as “Movement Characteristics (i)-(viii)”.

It should be noted that the powder bed assembly 614 and the powder supply assembly 618 can be designed to have any combination of the Movement Characteristics (i)-(viii). For example, the powder bed assembly 614 and the powder supply assembly 618 can be designed to have one, two, three, four, five, six, seven, or all eight of the Movement Characteristics (i)-(viii). Further, the build platform 634A can be circular, rectangular or other suitable shape.

In the implementation illustrated in FIG. 6A, the powder bed assembly 614 is somewhat similar to the implementation illustrated in FIG. 5, and includes a relatively large support platform 626A, a central support hub 626D, and a plurality of separate, spaced apart, build assemblies 634 (only one is illustrated) that are integrated into the support platform 626A. With this design, the support platform 626A with the build assemblies 634 can rotate relative to the support hub 626D, and/or the build assemblies 634 can rotate relative to the support platform 626A.

Further, in FIG. 6A, the powder supply assembly 618 is secured to the support hub 626D, and cantilevers and extends radially over the support platform 626A to selectively deposit the powder 612 (illustrated with small circles) onto the moving build assemblies 634. Alternatively, or additionally, the powder supply assembly 618 could be designed to be moved (e.g. linearly or rotationally) relative to the build assemblies 634. Still alternatively, the powder supply assembly 618 can be retained in another fashion than via the support hub 626D. For example, the powder supply assembly 618 can be coupled to the upper component housing 30 illustrated in FIG. 1A.

FIG. 6B is a cut-away view of the powder supply assembly 618 taken on line 6B-6B in FIG. 6A.

With reference to FIGS. 6A and 6B, the powder supply assembly 618 is a top-down, gravity driven system that is shown with a circular shaped build platform 634A. In one implementation, the powder supply assembly 618 includes a supply frame assembly 638, a powder container assembly 640, and a flow control assembly 642 that is controlled by the control system 624 to selectively and accurately deposit the powder 612 onto the build platform(s) 634A. The design of each of these components can be varied to suit the design requirements of processing machine 10, 210, 310. In FIGS. 6A and 6B, the flow control assembly 642 is illustrated as being recently activated and the powder supply assembly 618 is releasing the powder 612 towards the build platform 634A.

The supply frame assembly 638 supports and couples the powder container assembly 640 and the flow control assembly 642 to the rest of the processing machine 10, 210, 310. The supply frame assembly 638 can fixedly couple these components to the support hub 626D. In one, non-exclusive implementation, the supply frame assembly 638 includes (i) a riser frame 638A that is fixedly coupled to and extends upwardly along the Z axis from the support hub 624D; and (ii) a transverse frame 638B that is fixedly coupled to and cantilevers radially away from the riser frame 638A. It should be noted that either the riser frame 638A, and the transverse frame 638B can be referred to as a first frame or a second frame.

The riser frame 638A is rigid and includes (i) a riser proximal end 638C that is secured to the support hub 624D, and (ii) a riser distal end 638D that is positioned above the support hub 624D. Further, the transverse frame 638B is rigid and includes (i) a transverse proximal end 638E that is secured to the riser distal end 638D, and (ii) a transverse distal end 638F that extends over an outer perimeter of the build platform 634A. In one, non-exclusive implementation, the riser frame 638A is right cylindrical shaped (e.g. hollow or solid), and the transverse frame 638A is rectangular beam shaped. However, other shapes and configurations can be utilized.

Additionally, the transverse frame 638B can include a frame passageway 638G that allows the powder 612 from the flow control assembly 642 to flow therethrough. For example, the frame passageway 638G can be rectangular shaped. Further, the frame passageway 638G can define the supply outlet 639 of the powder 612 from the powder supply assembly 618. The supply outlet 639 is in fluid communication with the powder container assembly 640 and the flow control assembly 642.

In one embodiment, the supply outlet 639 is positioned above and spaced apart a separation distance 643 from the build platform(s) 634A or uppermost powder layer on the build platform 634A. The size of the separation distance 643 can vary depending on the environment around the powder supply assembly 618. For example, the separation distance 643 can be larger if operated in a vacuum environment. As a non-exclusive embodiment, the separation distance 643 can be as small as the largest powder particle size. As a non-exclusive example, the separation distance 643 can be between approximately zero to fifty millimeters.

Alternatively, the powder supply assembly 618 can be designed so that the supply outlet 639 is directly adjacent to and/or against the build platform(s) 634A or uppermost powder layer on the build platform 634A.

The powder container assembly 640 retains the powder 612 prior to being deposited onto the build platform(s) 634A. The powder container assembly 640 can be positioned above and coupled to the transverse frame 638B of the supply frame assembly 638. In one nonexclusive implementation, the powder container assembly 640 is open at the top and the bottom, and can include a powder container 640A that retains the powder 612, and a container base 640B that couples the powder container 640A to the transverse frame 638B with the flow control assembly 642 positioned therebetween. For example, the powder container 640A and the container base 640B can be integrally formed or secured together during assembly. In this implementation, the opening at the top of the powder container assembly 640 is larger than the opening at its bottom.

The size and shape of the powder container 640A can be varied to suit the powder 612 supply requirements for the system. In one non-exclusive implementation, the powder container 640A is tapered, rectangular tube shaped (V shaped cross-section) and includes (i) a bottom, container proximal end 640C that is coupled to the container base 640B, and that is an open, rectangular shape; (ii) a top, container distal end 640D that is an open, rectangular tube shaped and positioned above the proximal end 640C; (iii) a front side 640E; (iv) a back side 640F; (v) a left side 640G; and (vi) a right side 640H. Any of these sides can be referred to as a first, second, third, etc side. The powder container 640A can function as a funnel that uses gravity to urge the powder 612 against the flow control assembly 642.

In one design, the left side 640G and the right side 640H extend substantially parallel to each other; while the front side 640E and a back side 640F taper towards each other moving from the container distal end 640D to the container proximal end 640C. The sides 640E, 640F can be steep (near vertical). As non-exclusive examples, the angle of taper relative to normal (vertical) can be at approximately 0, 0.5, 1, 2, 4, 6, 8, 10, 20, 30 degrees or other angles. The angle of taper can be determined based upon the characteristics (e.g. size) of the powder particles, the material of the powder particles, the amount of powder to be retained in the powder container 640A and other factors. In certain implementations, the powder container 640A comprises two slopes (walls 640E, 640F) getting closer to each other from one end (top 640D) to the other end (bottom 640C) on which the flow controller 642A is provided, and the at least one vibration generator 642C is provided on the at least one wall 640E, 640F. Stated in another fashion, the powder container 640A comprises two walls 640E, 640F that slope towards each other from a first end 640D to the second end 640C in which the flow controller 642C is located. An angle between two slopes of the walls 640E, 640F can be determined based upon a type of powder 612. As provided herein, the plurality of vibration generators 642C are provided at the both of two walls 640E, 640F. Further, in certain implementations, the flow controller 642A is elongated a first direction (e.g. along the Y axis) that crosses the build platform 634A, and the plurality of vibration generators 642C are provided at the both of two walls 640E, 640F along the first direction.

The container base 640B can be rectangular tube shaped to allow the powder 612 to flow therethrough.

It should be noted that other shapes and configurations of the powder container 640A can be utilized. For example, the powder container 640A can have a tapering, oval tube shape, or another suitable shape.

The control system 424 controls the flow control assembly 642 to selectively and accurately control the flow of the powder 612 from the supply outlet 639 onto the build platform(s) 634A. In one implementation, the flow control assembly 642 includes a flow controller 642A and an activation system 642B. In this implementation, (i) the flow controller 642A can be a flow restrictor such as one or more mesh screen(s) or other porous structure; and (ii) the activation system 642B can include one or more vibration generators 642C that are controlled by the control system 624 to selectively vibrate the powder container 640A. Each vibration generator 642C can be a vibration motor.

With this design, sufficient vibration of the powder container 640A by the vibration generator(s) 642C causes the powder 612 to flow through the flow controller 642A to the build platform(s) 634A. In contrast, if there is insufficient vibration of the powder container 640A by the vibration generator(s) 642C, there is no flow through the flow controller 642A. Stated in another fashion, the rate (amplitude and frequency) of vibration by the vibration generator(s) 642C can control the flow rate of the powder 612 through the flow controller 642A to the build platform(s) 634A. Generally speaking, no vibration results in no flow of the powder 612, while the flow rate of the powder 612 increases as vibration rate increases. Thus, the vibration generator(s) 642C can be controlled to precisely control the flow rate of powder 612 to the build platform(s) 634A. The location of the flow controller 642A can be varied. In FIGS. 6A and 6B, the flow controller 642A is located between the powder container 640A and the transverse frame 638B. Alternatively, for example, the flow controller 642A can be located below the transverse frame 638B near the supply outlet 639.

The number and location of the vibration generator(s) 642C can be varied. In the non-exclusive implementation in FIGS. 6A and 6B, the activation system 642B includes (i) five spaced apart vibration generators 642C that are secured to the front side 640E near the top, container distal end 640D; and (ii) five spaced apart vibration generators 642C (only one is visible in FIG. 6B) that are secured to the back side 640F near the container distal end 640D. These vibration generators 642C are located above the flow controller 642A to vibrate the powder 612 in the powder container 640A. Alternatively, the activation system 642B can include more than ten or fewer than ten vibration generators 642C, and/or one or more of the vibration generators 634A located at different positions than illustrated in FIGS. 6A and 6B.

The five vibration generators 642C on each side 640E, 640F can be spaced apart linearly moving left to right. In FIG. 6A, the individual vibration generators 642C on the front side 640E are labeled A-E moving left to right linearly for ease of discussion. With this design, the vibration generators 642C can be independently controlled to control the distribution rate of the powder 612 moving linearly along the power supply assembly 618. This allows for control of the powder distribution radially from near the center to near the edge of the powder bed assembly 614. For example, if more powder 612 is needed near the edge than the center, the vibration generators 642C labelled “D” and “E” can be activated more than the vibration generators 642C labelled “A” and “B”.

With the present design, when it is desired to deposit the powder 612 onto the build platform 634A, the vibration generator(s) is(are) 642C turned ON to start the vibration motion. At this time, the powder 612 will pass from the powder container 640A through the flow controller 642A to deposit the powder 612. In contrast, when it is desired to stop the deposit of the powder 612, the vibration generators 642C are OFF, and the powder 612 will remain inside the powder container 640A.

With the present design, a thin, accurate, even layer of powder 612 can be supplied to the build platform(s) 634A without having to spread the powder 612 (e.g. with a rake) using the top-down vibration activated, powder supply assembly 618 disclosed herein. This powder supply assembly 618 is cost-effective, simple, and reliable method for delivering powder 612. Further, it requires a minimal amount of hardware to achieve even powder layers 612 on the build platform(s) 634A.

In certain embodiments, the flow controller 642A can be grounded to reduce static charges of the metal powder 612.

Additionally, or alternatively, the powder supply assembly 618 can include one or more preheaters 645A-645D on the inner or outer surface of powder container 640, on the transverse frame 638B, and/or near the separation distance 643. The non-exclusive implementation illustrated in FIG. 6B includes (i) one or more preheaters 645A that are positioned near the inner surface of the powder container 640; (ii) one or more preheaters 645B that are positioned near the outer surface of the powder container 640; (iii) one or more preheaters 645C that are positioned on the transverse frame 638B; and (iv) one or more preheaters 645D that are positioned on the transverse frame 638B near the supply outlet 639. With this design, the preheater(s) 645A-645D can be controlled to preheat the powder 612 before, during, and/or after passing through the flow controller 642A. Stated in another fashion, the powder container pre-heaters 645A-645D (different from the build pre-heater) can be located around the body of the powder container 640, or possibly, within the container 640. Another option might be an “on-demand” variant that either separately, or in addition to a bulk container 640 heater, locally pre-heats the powder further somewhere near the dispensing process.

Additionally, or alternatively, the powder supply assembly 618 can be used with a powder recoater (not shown) such as a rake, roller, wiper, squeegee, and/or a brush to further improve the flat powder surface.

FIG. 6C is a cut-away view of the powder supply assembly 618 similar to FIG. 6B, except in FIG. 6C, the vibration generators 642C are turned off. At this time, no powder 612 is flowing through the flow controller 642A.

FIG. 6D is a cut-away view taken from line 6D-6D in FIG. 6A, without the powder. Basically, FIG. 6D illustrates the powder supply assembly 618, including a portion of the supply frame assembly 638, the powder container assembly 640, and the flow control assembly 642.

FIG. 6E is a simplified top view of the powder supply assembly 618, without the powder. FIG. 6D illustrates the powder supply assembly 618, including the powder container assembly 640, and the flow controller 642A and the vibration generators 642C of the flow control assembly 642.

FIG. 6F is a top view of one implementation of the flow controller 642A. In this implementation, the flow controller 642A includes a flow structure 642D, and a plurality of flow apertures 642E that extend through the flow structure 642D. In this embodiment, the flow structure 642D is rectangular plate shaped to correspond to the bottom container end 640C (illustrated in FIG. 6B). However, other shapes are possible. For example, the flow structure 642D can be shaped the same as the build platform 634A (illustrated in FIG. 6A) to allow fast and efficient supply of powder to the build platform 634A.

The flow apertures 642E can have a circular, oval, square, polygonal, or other suitable shape. Further, flow apertures 642E can follow a straight or curved path through the flow structure 642D. Moreover, in this implementation, one or more (typically all) of the flow apertures 642E have an aperture size that is larger than a nominal powder particle size of each of the powder particles 612. In alternative, non-exclusive examples, the aperture size is at least approximately 1, 1.25, 1.5, 1.7, 2, 2.5, 3 or 4 times the nominal powder particle size. Further, in alternative, non-exclusive examples, the aperture size is less than approximately 5, 6, 7, 8 or 10 times the nominal powder particle size. Stated in a different fashion, one or more (typically all) of the flow apertures 642E have an aperture cross-sectional area that is larger than a nominal powder particle cross sectional area of the individual particles of powder 612 (illustrated in FIG. 6A). In alternative, non-exclusive examples, one or more (typically all) of the flow apertures 642E have an aperture cross-sectional area is equal to or larger than the nominal powder cross sectional area of the individual particles of powder 612 by at least, but not limited to, 1, 2, 3, 5, 10, 20, 40, 50, 60, 70, 80, 90, 100, 150, or 200 percent. Stated differently, as non-exclusive examples, the aperture cross-sectional area can be at least approximately ten, twenty, fifty, one hundred, or one thousand times the nominal powder cross-sectional area. Stated in yet another fashion, one or more (typically all) of the flow apertures 642E have an aperture diameter that is larger than a nominal powder particle diameter of the powder particles 612. In alternative, non-exclusive examples, the aperture diameter is at least approximately 1, 1.25, 1.5, 1.75, 2, 3 or 4 times the nominal powder particle diameter. Further, in alternative, non-exclusive examples, the aperture diameter is less than approximately 5, 6, 7, 8 or 10 times the nominal powder particle diameter. However, depending upon the design, other aperture sizes, diameters or cross-sectional areas are possible.

FIG. 6G is a side view the flow structure 642D of the flow controller 642A. In this implementation, the flow structure 642D includes one or more mesh screens 642F. In FIG. 6G, the flow structure 642D includes four mesh screens 642F. Alternatively, it can include more than four or fewer than four mesh screens 642F. In this design, the mesh screens 642F combine to define the plurality of spaced apart flow apertures 642E (illustrated in FIG. 6F).

With reference to FIGS. 6A-6G, in certain implementations, the sizes of flow apertures 642E, the vibration amplitude and/or the vibration directionality of the vibration generator(s) 642C may be adjusted to control the amount of the powder 612 supplied over the build platform 634A. The control system 624 may control the vibration generators 642C based on feedback results from the measurement device 20 (illustrated in FIG. 1A). For example, the measurement device 20 measures (monitors) the condition of the build platform(s) 634A (e.g., the topography of the powder layer, the irregularity of the surface of the powder layer, the geometry of the as-built object 11, the powder quality, the powder temperature, etc.) and the control system 624 controller controls the vibration generator(s) 642C so as to individually adjust the amount and location of powder 612 deposited on the build platform(s) 634A. The powder supply assembly 618 is designed to supply arbitrary amounts of the powder 612 in every area including individual sub-areas (along the radial direction perpendicular to the z-axis) of each build platform 634A.

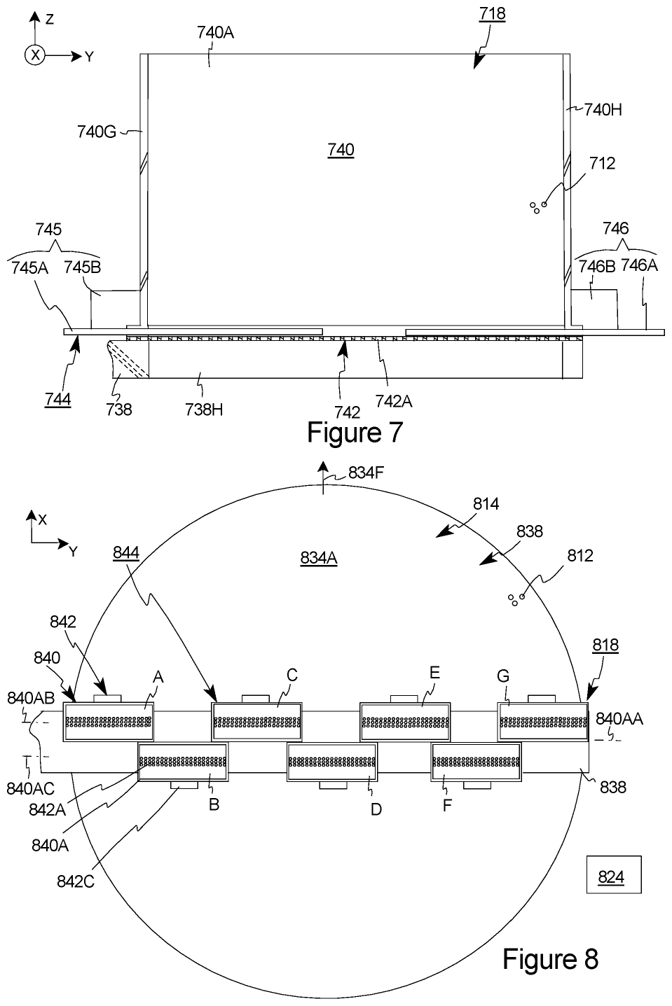

FIG. 7 is a cut-away view of another implementation of the powder supply assembly 718 of powder 712 (illustrated with a few circles) that can be integrated into in any of the processing machines 10, 210, 310 described above. It should be noted that the powder bed assembly (not shown in FIG. 7) and the powder supply assembly 718 can be designed to have any combination of the Movement Characteristics (i)-(viii) defined above. Further, the powder supply assembly 718 can be used with a build platform (not shown in FIG. 7) that is circular, rectangular or other suitable shape.

FIG. 7 is a somewhat similar view to FIG. 6D described above. In FIG. 7, the powder supply assembly 718 again includes a supply frame assembly 738, a powder container assembly 740, and a flow control assembly 742. In this embodiment, the frame assembly 738 and the powder container assembly 740 are similar to the corresponding components described above. However, in this embodiment, the flow control assembly 742 is slightly different.

More specifically, in FIG. 7, the flow control assembly 742 includes the flow controller 742A and the vibration generator(s) (illustrated in FIG. 6A) that similar to the embodiment in FIG. 6A. With this design, the vibration generator(s) is (are) controlled to selectively vibrate the powder container 740A to deposit the powder 712.

However, in FIG. 7, the flow control assembly 742 also includes a shutter assembly 744 that is independently controlled to additionally control the flow of the powder 612 from the supply outlet 738H. For example, the shutter assembly 744 can be controlled by the control system 624 (illustrated in FIG. 6A) to selectively block a portion or all of the supply outlet 739 and/or the flow controller 742. Thus, the shutter assembly 744 can additionally be controlled to selectively control the depositing (distribution) area of the powder 740 and selectively control how the powder 712 is being deposited across the build platform(s) 634A (illustrated in FIG. 6A).

In one implementation, the shutter assembly 744 can include (i) a left, first shutter subassembly 745 positioned by the left side 740G of the powder container 740A, and (ii) a right, second shutter subassembly 746 positioned by the right side 740H of the powder container 740A. For example, (i) the first shutter subassembly 745 can include a first shutter 745A, and a first shutter mover 745B; and (ii) the second shutter subassembly 746 can include a second shutter 746A, and a second shutter mover 746B.

In this embodiment, each shutter 745A, 746A can be a plate secured to a guide (e.g. a linear guide), and each mover 745B, 746B can be an actuator (e.g. a linear motor) that is controlled by the control system 624. With this design, for example, (i) the first mover 745B can selectively move (e.g. slide) the first shutter 745A relative to the powder container 740A and the flow controller 742A along the Y axis; and/or (ii) the second mover 746B can selectively move (e.g. slide) the second shutter 746A relative to the powder container 740A and the flow controller 742A along the Y axis to selective control the flow through the flow controller 742A. In FIG. 7, (i) the first shutter 745A is moved from left to right to reduce the flow, and from right to left to increase the flow; and (ii) the second shutter 746A is moved from right to left to reduce the flow, and from left to right to increase the flow.

Further, with this design, (i) the position of the first shutter 745A can be controlled to selectively control flow of the powder 712 to the inner region of the powder bed assembly 614 (illustrated in FIG. 6A); and (ii) the position of the second shutter 746A can be controlled to selectively control flow of the powder 712 to the outer region of the powder bed assembly 614. With this design, the shutters 745A, 746A can be controlled to manipulate (and restrict) the area of the flow controller 742A in which powder 712 can flow through, and ultimately how and what area the powder 712 is distributed onto the powder bed assembly 614 during the movement of the build platform(s).

In FIG. 7, the shutter assembly 744 adjusts the radial distribution of the powder 712 along the Y axis. Alternatively, or additionally, the shutter assembly 744 can be designed to move along the X axis to adjust the axial distribution of the powder 612. Still alternatively, one or each shutter 745A, 746A can be flexible plate that is deflected (or rotated) with the respective mover 745B, 746B to adjust the slit size instead of or in addition to linear actuation.

With this design, the control system 624 may control the vibration generators 642C and the shutter assembly 744 based on feedback results from the measurement device 20 (illustrated in FIG. 1A). For example, with feedback from the measurement device 20, the vibration generators 642C and the shutter assembly 744 are controlled to adjust the amount and location of powder 612 deposited on the build platform(s) 634A.

FIG. 8 is a simplified top view of another implementation of the powder supply assembly 818 that supplies powder 812 (illustrated with a few circles), and a build platform 834A of a powder bed assembly 814. This powder supply assembly 818 can be integrated into in any of the processing machines 10, 210, 310 described above. It should be noted that the powder bed assembly 814 and the powder supply assembly 818 can be designed to have any combination of the Movement Characteristics (i)-(viii) defined above. Further, the powder supply assembly 818 can be used with a build platform 834A that is circular, rectangular or other suitable shape.

In FIG. 8, the powder supply assembly 818 is illustrated without the powder. In this implementation, the powder supply assembly 818 again includes a supply frame assembly 838, a powder container assembly 840, and a flow control assembly 842 that are somewhat similar to the corresponding components described above and illustrated in FIG. 6A.

However, instead of one big powder container 640A as illustrated in FIG. 6A, the powder supply assembly 818 in FIG. 8 includes multiple smaller powder containers 840A distributed along an axis 840AA (e.g. the Y axis) and the supply frame assembly 838. In FIG. 8, the powder containers 840A are partly overlapping. However, they could be designed to be directly stacked along the axis 840AA.

The number of different powder containers 840A can be varied. In FIG. 8, the powder supply assembly 818 includes seven separate powder containers 840A. Alternatively, it can be designed to include more than seven or fewer than seven powder containers 840A. The number of different powder containers 840A can be determined based upon the size and shape of the build platform 834A, required depositing amount of powder, type of powder, and/or other factors.

Further, in this embodiment, each of the powder containers 840A includes a separate flow controller 842A and one or more vibration generators 842C that can individually be controlled with the control system 824. Each flow controller 842A and vibration generator 842C can be similar to the corresponding components described above and illustrated in FIG. 6A. Each powder container 840A with its corresponding flow controller 842A and one or more vibration generators 842C can be collectively be referred to as a supply module 844. In this example, the powder supply assembly 818 includes seven separate supply modules 844. Further, these supply modules 844 are configured to work in parallel to distribute the powder 812 on the build platform 834A

With this design, the vibration generators 842C can be independently controlled to control the distribution of the powder from each supply module 844 across the build platform 834A. Stated in another fashion, the vibration generator(s) 842C is (are) controlled to selectively vibrate the individual powder containers 840A to deposit the powder in the desired pattern on the build platform 834A.

In FIG. 8, the individual powder modules 844 are labeled A-G moving left to right for ease of discussion. With this design, the vibration generators 842C can be independently controlled to control the distribution rate of the powder 812 moving linearly along the power supply assembly 818.

In a specific example, in FIG. 8, the build platform 834A is illustrated as being centered under the powder container assembly 840. At this time, each of the powder modules 844 can be activated (e.g. vibrated) to deposit the powder 812. However, over time, as the build platform 834A is moving away from being centered (e.g. along a movement direction 834F) under the powder container assembly 840, the powder modules 844 “A” and “G” can be turned OFF. Next, the powder modules 844 “F” and “B” can be turned OFF. Subsequently, the powder modules 844 “C” and “E” can be turned OFF. Next, finally, powder module 844 “D” can be turned OFF. This allows for control of the powder 812 distribution radially across the build platform 834A. This also inhibits powder 812 from being distributed off of the build platform 834A.

With this design, the control system 824 may individually control the vibration generators 842C of each supply module 844 based on feedback results from the measurement device 20 (illustrated in FIG. 1A) to create the desired powder 812 coverage. With this design, for example, the control system 824 can simultaneously control (i) powder module “A” to deposit powder 812 at a first deposit rate to a first location on the build platform 834A; (ii) powder module “B” to deposit powder 812 at a second deposit rate to a second location; (iii) powder module “C” to deposit powder 812 at a third deposit rate to a third location; (iv) powder module “D” to deposit powder 812 at a fourth deposit rate to a fourth location; (v) powder module “E” to deposit powder 812 at a fifth deposit rate to a fifth location; (vi) powder module “F” to deposit powder 812 at a sixth deposit rate to a sixth location; and (vii) powder module “G” to deposit powder 812 at a seventh rate to a seventh location. As provided herein, the control system 824 can control the powder modules so that one or more of the deposit rates are the same or different. Further, the locations are at different positions on the build platform 834A. With this design, more or less powder can be simultaneously deposited at the different locations. For example, the first deposit rate can be greater than the second deposit rate, and the second deposit rate can be greater than the second deposit rate. With this design, more powder is delivered to the first location than the second location, and more powder is delivered to the second location than the third location.

In one implementation, (i) one or more supply modules 844 (e.g. four) are positioned on a first axis 840AB; and (ii) one or more supply modules 844 (e.g. three) are positioned on a second axis 840AC. In FIG. 8, the design includes (i) a first plurality of spaced apart supply modules 844 (e.g. four) that are substantially aligned along the first axis 840AB; and (ii) a second, plurality of spaced apart supply modules 844 (e.g. three) that are substantially aligned along the second axis 840AC. In this example, the first axis 840AB, and the second axis 840AC are substantially parallel to each other (e.g. along the Y axis) and the axes 840AB, 840AC are spaced apart (e.g. along the X axis). In this implementation, the build platform 834A is moved in the movement direction 834F that crosses (e.g. is transverse) to the axes 840AB, 840AC, and the build platform 834A is moved under the supply modules 844. Further, the supply module(s) 844 on the first axis 840AB, and the supply module(s) on the second axis 840AC are arranged at different positions (e.g. along the axes 840AB, 840AC) regarding to a direction that crosses to the movement direction 834F.

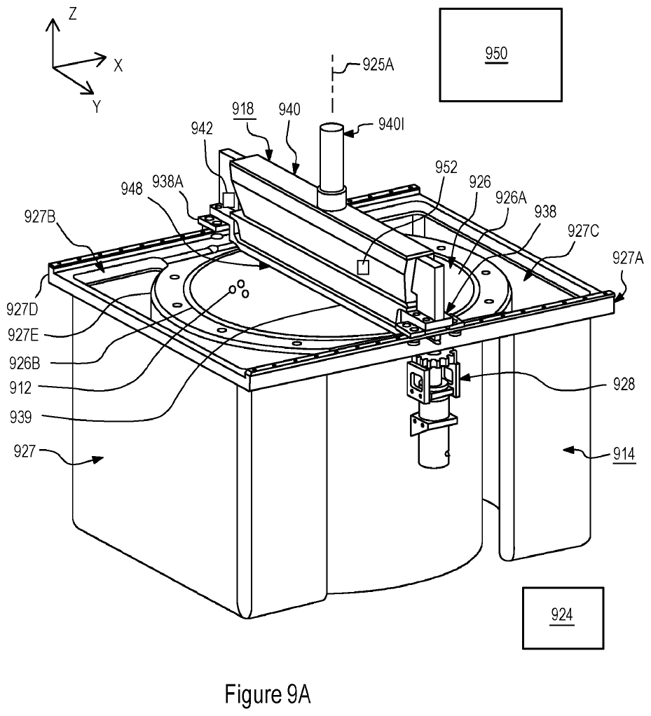

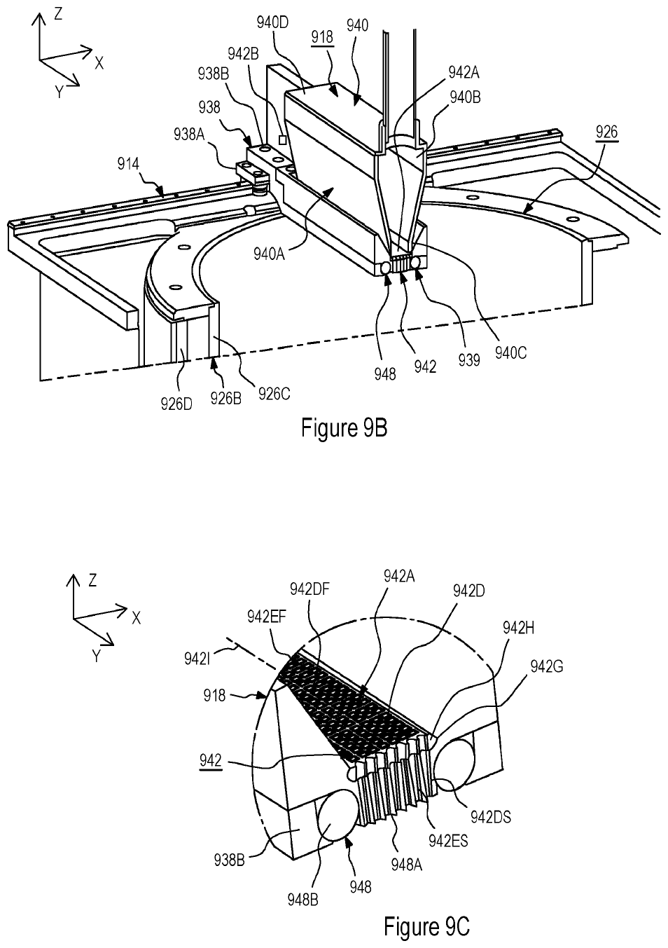

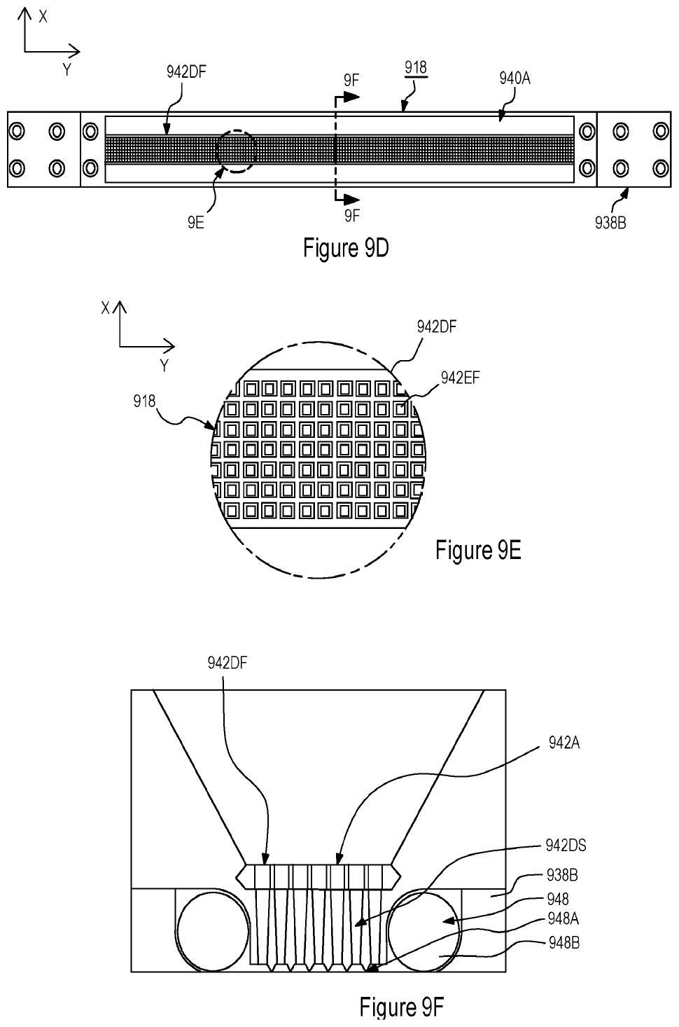

Additionally, or alternatively, the flow control assembly 842 for one or more for the supply modules 844 can be modified to include a shutter assembly 744 as illustrated in FIG. 7. Additionally, or alternatively, one of more of the supply modules 844 can be modified and/or designed to have (i) a flow control assembly 942 similar to that described below and illustrated in FIGS. 9A-9F; (ii) a flow control assembly 1042 similar to that described below and illustrated in FIGS. 10A-10D; and/or (i) a flow control assembly 1142 similar to that described below and illustrated in FIGS. 11A-11C. Additionally, or alternatively, the supply modules 844 might quickly shift along the radial direction while depositing powder as a method of increasing the powder deposit resolution or smoothing the boundary between the tracks each supply module 844 creates.

FIG. 9A is a perspective view of another implementation of the powder bed assembly 914 with the build platform 926A, and the powder supply assembly 918 that deposits the powder 912 (illustrated with a few circles) under the control of the control system 924 (illustrated with a box). This powder supply assembly 918 can be integrated into in any of the processing machines 10, 210, 310 described above. Further, it should be noted that the powder bed assembly 914 and the powder supply assembly 918 can be designed to have any combination of the Movement Characteristics (i)-(viii) defined above. Further, the powder supply assembly 918 can be used with a build platform 926A that is circular, rectangular or other suitable shape.

As an overview, the powder supply assembly 918 illustrated in FIG. 9A is a top-down, gravity driven system. The powder supply assembly 918 is practical, relatively simple, and can provide a uniformly distributed layer of powder 912 quickly and efficiently.

In FIG. 9A, the powder bed assembly 914 includes (i) a circular shaped powder bed 926 that defines the build platform 926A; (ii) a tubular shaped support side wall assembly 926B that encircles the powder bed 926 and supports the powder 912 on the build platform 926A; (iii) a bed frame 927; and (iv) a device mover 928. In one implementation, the powder bed 926 is rotated about the rotation axis 925A (e.g. the Z axis) and moved linearly downward along the rotation axis 925A relative to the support side wall assembly 926B during the adding of the powder 912 and the forming of the object (not shown in FIG. 9A). In another implementation, the powder bed assembly 914 can be located off the rotation axis 925A. In this design, multiple similar build platforms can be circling the rotation axis 925A. Further, each build platform can include its own powder spreader or powder supply assembly, and each powder spreader passing under each processing step.

The bed frame 927 supports the other components of the powder bed assembly 914. Further, in this implementation, the bed frame 927 can support and guide the movement of the powder supply assembly 918 relative to the powder bed assembly 914. In the non-exclusive implementation of FIG. 9A, the bed frame 927 includes an upper frame 927A, a first recovery receptacle 927B, and a spaced apart, second recovery receptacle 927C. The upper frame 927A can be rectangular shaped and define a pair of spaced apart linear frame guides 927D that guide the movement of the powder supply assembly 918 relative to the powder bed assembly 914. Each recovery receptacle 927B, 927C can catch powder 912 that spills over the powder bed 926. As a non-exclusive example, each recovery receptacle 927B, 927C can be an open, generally rectangular shaped structure, with one curved side 927E that conforms to and is positioned adjacent to the side wall assembly 926B.

The device mover 928 can move the powder bed 926 relative to the bed frame 927 and the powder supply assembly 918. In FIG. 9A, the device mover 928 includes a rotary motor that is controlled by the control system 924 to rotate the powder bed 926 about the rotation axis 925A relative to the powder supply assembly 918. It should be noted that the build platform 926A can also be moved downward linearly during forming of the object.

The powder supply assembly 918 is designed to provide a centerless, uniform distribution of a fine layer of powder 912 over the relatively large and broad build platform 926A. In one implementation, the powder supply assembly 918 includes a supply frame assembly 938, a powder container assembly 940, and a flow control assembly 942 (illustrated with a box in FIG. 9A).

Optionally, the powder supply assembly 918 can includes a powder distributor 948 that levels and/or smooths the powder 912 on the build platform 926A. The powder distributor 948 can function as a rake to smooth a top surface of the powder 912 on the build platform 926A. In this embodiment, a supply outlet 939 of the powder 912 from the powder supply assembly 918 is positioned adjacent to and against the layer of powder on the build platform 926A.

Additionally, or alternatively, the powder supply assembly 918 can include a large, bulk powder tank 950 (illustrated with a box) that supplies powder 912 to the powder container assembly 940. The bulk powder tank 950 can retain a large amount of powder 912. For example, the powder container assembly 940 can include one or more powder inlets 9401 that are in fluid communication with the bulk powder tank 950, e.g. via a flexible hose. In FIG. 9A, the powder container assembly 940 includes a single, centrally located powder inlet 9401. With this design, the bulk powder tank 950 can supply powder 912 to the powder container assembly 940 to maintain the powder container assembly 940 at the desired powder level.

In certain implementations, the powder supply assembly 918 is controlled to be moved relative to the build platform 926A while simultaneously and accurately distributing the powder 912 to the build platform 926A. In FIG. 9A, the powder supply assembly 918 is moved linearly (e.g. along the X axis) relative to the build platform 926A on the frame guides 927D with one or more actuators (not shown in FIG. 9A) while the powder 912 is being deposited on the build platform 926A. Alternatively, or additionally, the system can be designed so that the powder supply assembly 918 is rotated relative to the build platform 926A while the powder 912 is being deposited onto the build platform 926A. Still alternatively, the powder supply assembly 918 could be attached to a support hub (not shown) similar to FIG. 6A, or have some other attachment.

Additionally, for example, the powder supply assembly 918 can be parked or positioned on either side of the build platform 926A so as to not interfere with the energy beam 22D (illustrated in FIG. 1A) from the energy system 22 (illustrated in FIG. 1A).

The supply frame assembly 938 (i) is rigid, (ii) extends over the powder bed assembly 914 between the frame guides 927D, and (iii) supports the powder container assembly 940, and the flow control assembly 942 above the build platform 926A. In FIG. 9A, the supply frame assembly 938 is coupled to and moves relative to the powder bed assembly 914. For example, the supply frame assembly 938 can include a pair of spaced apart bearing guides 938A that engage the frame guides 927D to guide the motion of the powder supply assembly 918 relative to the powder bed assembly 914.

Additionally, the powder container assembly 940 can include one or more vibration generator(s) 952 (only one is illustrated in FIG. 9A as a box) that are controlled by the control system 924. With this design, the vibration generator(s) 952 are controlled to inhibit bridging, clumping, or clogging of a powder 912, and/or to evenly distribute the powder in the powder container assembly 940.

Additionally, the powder supply assembly 918 can be designed to include one or more additional rakes and/or rollers.

FIG. 9B is a perspective cut-away view of a portion of FIG. 9A that illustrates (i) the powder bed assembly 914 including a portion of the powder bed 926; and (ii) the powder supply assembly 918 with the supply frame assembly 938, the powder container assembly 940, and the flow control assembly 942, and the powder distributor 948. In FIG. 9B, the support side wall assembly 926B of the powder bed 926 is illustrated, but the build platform 926A (illustrated in FIG. 9A) is not. As illustrated, the support side wall assembly 926B can include an inner wall 926C that can rotate with the build platform 926A, and an outer wall 926D.

The supply frame assembly 938 can support the powder container assembly 940, the flow control assembly 942, and the powder distributor above the build platform 926A. In FIG. 9B, the supply frame assembly 938 includes (i) the bearing guides 938A; and (ii) a rigid, stepped down, support frame 938B that extends across the powder bed assembly 914.

The powder container assembly 940 retains the powder 912 (illustrated in FIG. 9A) prior to being deposited onto the build platform 926A. The powder container assembly 940 can be positioned above and coupled to the supply frame assembly 938. In one nonexclusive implementation, the powder container assembly 940 includes (i) a powder container 940A having a container top 940B that defines a top opening, and a container bottom 940C that defines a bottom opening, and (ii) a container lid 940D that closes the top opening of the container top 940B.

The size and shape of the powder container 940A can varied to suit the powder 912 supply requirements for the system. The powder container 940A can be somewhat similar to the corresponding component described above and illustrated in FIG. 6A. In one non-exclusive implementation, the powder container 940A is tapered, rectangular tube shaped (somewhat V shaped cross-section). Stated in another fashion, the powder container 940A can be rectangular funnel shaped. In this design, the top opening of container top 940B and the bottom opening of the container bottom 940 are each rectangular shaped, with the top opening being larger than the bottom opening. In this design, a length of the top opening and the bottom opening is approximately the same, while a width of the top opening is larger than a width of the bottom opening.

In certain implementations, the powder container 940A is shaped to allow gravitational forces to urge the powder against the flow control assembly 942 positioned adjacent to the container bottom 940C.

The flow control assembly 942 precisely controls the flow of the powder 912 to the build platform 926A. In certain implementations, the flow control assembly 942 simultaneously distributes the powder 912 while the powder supply assembly 918 is being moved either linearly or in a rotating fashion. In this embodiment, the flow control assembly 942 includes a flow controller 942A and an activation system 942B (illustrated with a box). These components are described in more detail below when discussing FIG. 9C.

The powder distributor 948 levels and/or smooths the powder 912 on the build platform 926A. In the non-exclusive implementation of FIGS. 9A and 9B, the powder distribution 948 extends across the build platform 926A. This way, the powder 912 on the build platform 926A can be smoothed and/or leveled by the powder distributor 948 when the powder supply assembly 918 is moved linearly.

FIG. 9C is an enlarged view of a portion of the powder supply assembly 918 of FIG. 9B that illustrates the flow control assembly 942 and the powder distributor 948 in more detail. The design of each of these components can be varied.

In this embodiment, the flow control assembly 942 includes the flow controller 942A and the activation system 942B (illustrated as a box in FIG. 9B). For example, the flow controller 942A can be positioned near the container bottom 940C to control the flow of powder 912 from the powder container 940A.

In this implementation, (i) the flow controller 942A includes one or more flow structures 942D (e.g. one or more mesh screen(s), grating(s) or other porous structure(s)); and (ii) the activation system 942B can include one or more actuators that selectively move the one or more of the flow structures 942D relative to each other and/or the powder container 940A (illustrated in FIG. 9B) to release the powder 912.

In FIG. 9C, the flow controller 942A includes two flow structures 942D, namely a first flow structures 942DF, and a second flow structure 942DS that is below the first flow structure 942DF. In this design, the first flow structure 942DF is stacked on top of the second flow structure 942DS. In this implementation, the first flow structure 942DF is rigid and includes a plurality of spaced apart first flow apertures 942EF that extend therethrough, and the second flow structure 942DS is rigid and includes a plurality of spaced apart second flow apertures 942ES that extend therethrough.

In this non-exclusive implementation, (i) the second flow structure 942DS is somewhat “V” shaped and includes opposed inner slots 942G for guiding the movement of the first flow structure 942DF; and (ii) the first flow structure 942DF is long, rectangular plate shaped and includes angled sides 942H that fit in the slots 942G. With this design, the first flow structures 942DF can be moved relative to the second flow structure 942DS.

In one implementation, the activation system 942B includes a structure mover that individually moves one or multiple of the flow structures 942D in a reciprocating (linear) fashion along a reciprocating axis 9421 (e.g the Y axis) in order to evenly dispense and distribute the metal powder 912 over the powder build platform 926A. With this design, the flow control assembly 942 is a reciprocating grater 942A that evenly dispensing the metal powder.

For example, the second flow structure 942DS can be fixed, and the first flow structure 942DF can be moved relative to the second flow structure 942DS and the powder container 940A. In FIG. 9C, the first flow structure 942DF is configured to reciprocate in a linear or back and forth motion above the second flow structure 942DS. This aids in dispensing the metal powder 912 in a gradual even manner through the lower second flow structure 942DS.

Alternatively, the flow control assembly 942 can be designed so that both flow structures 942D are moved relative to each other and the powder container 940A with the activation system 942B.

Still alternatively, the flow control assembly 942 can be designed to have more than two flow structures 942D, with two or more of these flow structures 942D being movable with the activation system 942B.

With this design, sufficient movement of at least one of the flow structures 942D by the activation system 942B causes the powder 912 to flow through the flow controller 942A to the build platform(s) 916A. In contrast, if there is insufficient movement of the flow structure(s) 942D, there is no flow through the flow controller 942A. As provided herein, the rate (amplitude and frequency) of movement of the flow structure(s) 942D control the flow rate of the powder 912 through the flow controller 942A to the build platform(s) 926A. Thus, the movement of the flow structure(s) 942D can be controlled to precisely control the flow rate of powder 912 to the build platform(s) 926A.

For example, each of the flow structures 942D can be a mesh or grating.

The powder distributor 948 can include one or more spaced apart, scraping teeth 948A, and/or one or more roller elements 948B for spreading or levelling out the powder 912 on the build platform 926A. In one, non-exclusive implementation of FIG. 9C, (i) the scraping teeth 948A are mounted on a bottom surface of the first flow structure 942DF, and (ii) two spaced apart roller elements 948B are mounted between the first flow structure 942DF and the support frame 938B. The scraping teeth 948A can be used alone or in combination with the one or more roller elements 948B to improve the uniformity of the distribution of the metal powder 912.

The scraping teeth 948A serve as a rough spreading mechanism for the powder 912 on the build platform 926A. The one or more roller elements 948B can be positioned on either side of the set of scraping teeth 948A to serve as a finer spreading or compacting mechanism to make the powder build layer more fine and even. The roller elements 948B can be free rolling or driven by a motor (not shown).

FIG. 9D is a top view of a portion of the powder supply assembly 918 of FIG. 9A without the container top 940B. FIG. 9D illustrates the support frame 938B, the powder container 940A, and the first flow structure 942DF.

FIG. 9E is an enlarged view of a portion of the powder supply assembly 918 of FIG. 9D, namely a portion of the first flow structure 942DF. In this embodiment, the first flow structure 942DF includes the plurality of spaced apart first flow apertures 942EF that are organized in a grid like fashion. In this embodiment, each first flow aperture 942EF is generally rectangular shaped. Alternatively, each first flow aperture 942EF can be oval, circular, polygonal, or other suitable configuration.

In this implementation, one, a plurality, or substantially all (typically all) of the first flow apertures 942EF have an aperture cross-sectional area that is larger than a powder cross sectional area of the individual particles of powder 912 (illustrated in FIG. 9A). Moreover, in this implementation, one or more (typically all) of the first flow apertures 942EF have a first aperture size that is larger than a nominal powder particle size of each of the powder particles 912. In alternative, non-exclusive examples, the first aperture size is at least approximately 1, 1.25, 1.5, 1.75, 2, 2.5, 3, 4, 5, 6, or 8 times the nominal powder particle size. Further, in alternative, non-exclusive examples, the first aperture size is less than approximately 10, 12, 15, or 20 times the nominal powder particle size. Stated in a different fashion, one or more (typically all) of the first flow apertures 942EF have an aperture cross-sectional area that is larger than a nominal powder particle cross sectional area of the individual particles of powder 912. In alternative, non-exclusive examples, one or more (typically all) of the first flow apertures 942EF have a first aperture cross-sectional area is equal to or larger than the nominal powder cross sectional area of the individual particles of powder 912 by at least, but not limited to, 1, 2, 3, 5, 10, 20, 40, 50, 60, 70, 80, 90, 100, 150, 200, 300, or 400 percent. Stated differently, as non-exclusive examples, the first aperture cross-sectional area can be at least approximately ten, twenty, fifty, one hundred, one thousand, or two thousand times the nominal powder cross-sectional area. Stated in yet another fashion, one or more (typically all) of the first flow apertures 942EF have an aperture diameter that is larger than a nominal powder particle diameter of the powder particles 912. In alternative, non-exclusive examples, the aperture diameter is at least approximately 1, 1.25, 1.5, 1.75, 2, 3, 4, 5, 6, 7 or 8 times the nominal powder particle diameter. Further, in alternative, non-exclusive examples, the aperture diameter is less than approximately 10, 15, or 20 times the nominal powder particle diameter. However, depending upon the design, other aperture sizes, diameters or cross-sectional areas are possible.

It should be noted that the second flow apertures 942ES of the second flow structure 942DS (illustrated in FIG. 9C) can have similar characteristics to the first flow apertures 942EF. In this design, the size and shape of the flow paths through the flow structures 942DF, 942DS are dynamically changing with the relative movement between the flow structures 942DF, 942DS.

FIG. 9F is a cut-away view taken on line 9F-9F of FIG. 9D that illustrates (i) a portion of the support frame 938B; (ii) the flow controller 942A with the first flow structures 942DF, and the second flow structure 942DS; and (iii) the powder distributor 948 with the scraping teeth 948A, and/or one or more roller elements 948B.

With reference to FIGS. 9A-9F, in this implementation, the powder 912 is released from the powder container 940A into the reciprocating flow structures 942D, while the powder supply assembly 918 is being moves back and forth linearly across the build platform 926A. This reciprocating motion assures the removal of any center high spots to produce a uniform centerless distribution of powder 912. The entire powder supply assembly 918 is moved in a manner to sweep excess powder 912 into the recovery receptacles 927B, 927C. In a non-gravity-fed system, the recovery receptacles 927B, 927C may double as a second supply assembly, and vice versa, such that the rake would not need to return to a specific side before spreading the next layer of powder 912. Gravity fed or not, the excess powder in the recovery receptacles 927B, 927C may feed through a filter to replenish the powder container assembly 940.

One of the advantages of this system is that it combines the reciprocating flow structures 942D with optional scraping teeth 948A and one or more roller elements 948B mounted on the movable powder supply assembly 918 to provide a centerless, thin layer of metal powder 912 distributed uniformly over a large powder build platform 926A.

In FIGS. 9A-9F, the flow structures 942D are moved relative to each other and the powder container 940A to cause powder 912 flow. In contrast, in the embodiment of FIGS. 6A-6G, the powder container 640A and/or the flow structure 642D are vibrated to cause powder 612 flow.

With reference to FIGS. 9A-9F, with this design, the control system 924 controls the reciprocating flow structures 942D based on feedback results from the measurement device 20 (illustrated in FIG. 1A) to create the desired powder 912 coverage.

Additionally, or alternatively, the flow control assembly 942 can be modified to include a shutter assembly 744 as illustrated in FIG. 7.

FIG. 10A is a perspective view of another implementation of the powder bed assembly 1014, and the powder supply assembly 1018 that deposits the powder (not shown in FIG. 10A) under the control of the control system 1024 (illustrated with a box). This powder supply assembly 1018 can be integrated into in any of the processing machines 10, 210, 310 described above. Further, it should be noted that the powder bed assembly 1014 and the powder supply assembly 1018 can be designed to have any combination of the Movement Characteristics (i)-(viii) defined above. Moreover, the powder supply assembly 1018 can be used with a build platform 1026A that is circular, rectangular or other suitable shape.

As an overview, the powder supply assembly 1018 illustrated in FIG. 10A is a top-down, gravity driven system. The powder supply assembly 1018 is practical, relatively simple, and can provide a uniformly distributed layer of powder quickly and efficiently.

In FIG. 10A, the powder bed assembly 1014 is similar to the corresponding component described above and illustrated in FIG. 9A; and the powder supply assembly 1018 that is slightly different from the corresponding component described above and illustrated in FIG. 9A. It should be noted that the build platform 1026A is illustrated at the bottom of the support side wall assembly 1026B in FIG. 10A. The build platform 1026A can be rotated about the rotation axis 1025A (e.g. the Z axis) and moved linearly downward along the rotation axis 1025A relative to the support side wall assembly 1026B during the adding of the powder and the forming of the object (not shown in FIG. 10A).

In this implementation, the powder supply assembly 1018 can again be controlled to be moved relative to the build platform 1026A (e.g. linearly along the X axis on the frame guides 1027D of the bed frame 1027) while simultaneously and accurately distributing the powder to the build platform 1026A. Alternatively, the powder supply assembly 1018 could be attached to a support hub (not shown) similar to FIG. 6A, or have some other attachment. The flow control assembly 1042 can be controlled to simultaneously distribute the powder while the powder supply assembly 1018 is being moved.

The powder supply assembly 1018 uniformly distributes a fine layer of powder over the relatively large and broad build platform 1026A. In one implementation, the powder supply assembly 1018 again includes the supply frame assembly 1038, the powder container assembly 1040, and the flow control assembly 1042.

The supply frame assembly 1038 (i) is rigid, (ii) extends over the powder bed assembly 1014 between the frame guides 1027D, and (iii) supports the powder container assembly 1040, and the flow control assembly 1042 above the build platform 1026A. The supply frame assembly 1038 can be similar to the corresponding component described above and illustrated in FIG. 9A.

The powder container assembly 1040 retains the powder prior to distribution on the build platform 1026A. The powder container assembly 1040 includes the container top 10408 and the container bottom 1040C, and the powder container assembly 1040 can be somewhat similar to the corresponding component described above and illustrated in FIG. 9A. However, in this implementation, the powder container 1040A includes a plurality of container dividers 1040D that divide and separate the powder container 1040A into a plurality of adjacent, individual separate containers 1040E that are arranged in parallel along the supply frame assembly 1038 e.g. along the Y axis). The number of different separate containers 1040E can be varied. In FIG. 10A, the powder supply assembly 1018 includes eight separate containers 1040E. Alternatively, it can be designed to include more than eight or fewer than eight separate containers 1040E.

Each container divider 1040D extends upward from the container bottom 1040C towards container top 1040B. In one implementation of FIG. 10A, each container divider 1040D extends only part way. This allows for the powder to spill over the top of the container dividers 1040D and flow between the separate containers 1040E.

In this embodiment, each of the separate containers 1040E includes a separate flow controller 1042A. Each separate container 1040E with its corresponding flow controller 1042A can be collectively be referred to as a supply module 1044. In this example, the powder supply assembly 1018 includes eight separate supply modules 1044 that are aligned and stacked along the Y axis. Alternatively, it can be designed to include more than eight or fewer than eight separate supply modules 1044. The number of separate supply modules 1044 can be determined based upon the size and shape of the build platform 1026A, required depositing amount of powder, type of powder, and/or other factors. Further, these supply modules 1044 are configured to work in parallel to distribute the powder on the build platform 1026A.

It should be noted that a separate activation system 1042B (only one is illustrated in FIG. 10A as a box) can be used for each supply module 1044 to active each flow controller 1042A. Thus, each supply module 1044 includes the separate activation system 1042B. With this design, the separate activation systems 1042B can be independently controlled with the control system 1024 to control the distribution of the powder from each supply module 1044 across the build platform 1026A. Stated in another fashion, the separate activation systems 1042B can be controlled to deposit the powder in the desired pattern on the build platform 1026A. Thus, each powder module 1044 can be controlled individually to create various powder coverage shapes desired for each layer of the build using feedback from the measurement device 20 (illustrated in FIG. 1).

The eight powder modules 1044 are positioned adjacent to each other along the Y axis. In FIG. 10A, the individual powder modules 1044 are labeled A-H moving bottom to top for ease of discussion. With this design, the powder modules 1044 can be independently controlled to control the distribution rate of the powder moving linearly along the power supply assembly 1018.

In a specific example, in FIG. 10A, the build platform 1026A is illustrated as being centered under the powder container assembly 1040. At this time, each of the powder modules 1044 can be activated to deposit the powder. However, over time, as the powder supply assembly 1018 is moved linearly from being centered over the build platform 1026A, the powder modules 1044 labeled “A” and “H” can be turned OFF. Next, the powder modules 1044 labelled “B” and “G” can be turned OFF. Subsequently, the powder modules 1044 labelled “C” and “F” can be turned OFF. Next, finally, powder module 1044 labelled “D” and “E” can be turned OFF. This allows for control of the powder distribution radially across the build platform 1026A. This also reduces the amount of powder from deposited off of the build platform 1026A.

Alternatively, a common activation system 1042B can be used to concurrently activate multiple flow controllers 1042A. In this design, the supply modules 1044 that share a common activation system 1042B will operate concurrently.

Additionally, and optionally, the powder container assembly 1040 can include one or more vibration generator(s) 952 (illustrated in FIG. 9A) that are controlled by the control system 1024. With this design, the vibration generator(s) 952 are controlled (i) to inhibit bridging, clumping, or clogging of a powder, and/or (ii) to evenly distribute the powder in the powder container assembly 1040.

Additionally, and optionally, the powder supply assembly 1018 can include a powder distributor 1048 (illustrated in FIG. 100) that levels and/or smooths the powder on the build platform 1026A. For example, the powder distributor 1048 can include a knife edge that engages the powder to function as a rake to smooth a top surface of the powder on the build platform 1026A. Additionally or alternatively, the powder distributor 1048 can include a roller.

Additionally, and optionally, the powder supply assembly 1018 can include a large, bulk powder tank 950 (illustrated in FIG. 9A) that supplies powder to the powder container assembly 1040.

FIG. 10B is a top view of a portion of the powder supply assembly 1018 of FIG. 10A without powder. FIG. 10B illustrates the supply frame assembly 1038, the powder container assembly 1040, and the flow control assembly 1042 that cooperate to define the powder modules 1044.

FIG. 10C is a cut-away view taken on line 10C-10C in FIG. 10B. FIG. 10C illustrates (i) a cut-away view of the funnel shaped powder container 1040A with the container top 1040B and the container bottom 1040C; (ii) one container divider 1040D that extends upward from the container bottom 1040C to define one of the supply modules 1044; (iii) the flow controller 1042A for that powder module 1044 that is positioned adjacent to the container bottom 1040C; and (iv) a portion of the supply frame assembly 1038.

In one implementation, (i) each flow controller 1042A includes one or more flow structures 1042D (e.g. one or more sift cogs, mesh screen(s), grating(s) or other porous structure(s)); and (ii) the activation system 1042B (illustrated in FIG. 10A) can include one or more actuators that selective move (e.g. rotate) the one or more of the flow structures 1042D relative to each other and/or the powder container 1040A to release the powder.

In FIG. 100, the flow controller 1042A for each supply module 1044 includes two flow structures 1042D, namely a first flow structures 1042DF, and a second flow structure 1042DS that is below the first flow structure 1042DF. In this design, the first flow structure 1042DF is stacked on top of the second flow structure 1042DS and the flow structures 1042D are aligned along the Z axis for each supply module 1044. In this implementation, the first flow structure 1042DF is rigid and includes a plurality of spaced apart first flow apertures 1042EF that extend transversely therethrough along the Z axis, and the second flow structure 1042DS is rigid and includes a plurality of spaced apart second flow apertures (not shown) that extend transversely therethrough along the Z axis.

In this non-exclusive implementation, (i) each flow structure 1042D is circular disk shaped; (ii) the first flow structure 1042DF can include a first bearing assembly 1042F that rotatable couples the first flow structure 1042DF to the supply frame assembly 1038; and (iii) the second flow structure 1042DS can include a second bearing assembly 1042G that rotatable couples the second flow structure 1042DS to the supply frame assembly 1038.

In one implementation, for each supply module 1044, the activation system 1042B can include one or more structure movers that individually move (e.g. rotate) one or multiple of the flow structures 1042D in a reciprocating (rotational) fashion about a reciprocating axis 10421 (e.g. the Z axis) in order to evenly dispense and distribute the metal powder over the powder build platform 1026A. With this design, the flow controller 1042A for each supply module 1044 is a reciprocating sifter 1042A that evenly dispensing the metal powder.

For example, the flow controller 1042A can be designed so that both flow structures 1042D are moved relative to each other and the powder container 1040A to allow the powder to flow through both flow structures 1042D. Specifically, for each supply module 1044, the first flow structure 1042DF and the second flow structure 1042DS can be rotated in opposite directions, or in the same direction at different rates. This aids in dispensing the metal powder in a gradual even manner through the lower second flow structure 1042DS.

Alternatively, the second flow structure 1042DS can be fixed, and the first flow structure 1042DF can be moved relative to the second flow structure 1042DS and the powder container 1040A.

Still alternatively, the flow controller 1042A for each supply module 1044 can be designed to have more than two flow structures 1042D, with two or more of these flow structures 1042D being movable.

With this design, sufficient movement of at least one of the flow structures 1042D by the activation system 10428 causes the powder to flow through the flow controller 1042A to the build platform(s) 1016A. In contrast, if there is insufficient movement of the flow structure(s) 1042D, there is no flow through the flow controller 1042A. As provided herein, the rate (amplitude and frequency) of movement of the flow structure(s) 1042D control the flow rate of the powder through the flow controller 1042A. Thus, the movement of the flow structure(s) 1042D can be controlled to precisely control the flow rate of powder to the build platform(s) 1026A.

In this example, for each supply module 1044, the flow structures 1042S are each circular sift cog elements that are positioned adjacent to each other. Each sift cog is configured to have a screen or grid-like pattern to allow metal powder to gradually flow through each sift cog.

In certain embodiments, the first flow structures 1042DF of adjacent supply modules 1044 are aligned in a row along a first axis (parallel to the Y axis) and are coupled to each other such that when one of the first flow structures 1042DF is rotated in a direction (e.g., clockwise), its adjacent first flow structure 1042DF rotates in an opposite (e.g., counterclockwise) direction. Similarly, the second flow structures 1042DS of adjacent supply modules 1044 are aligned in a row along a second axis (parallel to the Y axis) and are coupled to each other such that when one of the second flow structures 1042DS is rotated in a direction (e.g., counterclockwise), its adjacent second flow structure 1042DS rotates in an opposite (e.g., clockwise) direction.

Optionally, the supply frame assembly 1038 and/or the second flow structure 1042DS can include the integrated powder distributor 1048, e.g. one or more knife edges. The knife edges can be used to improve the uniformity of the distribution of the metal powder.

FIG. 10D is an enlarged view of a portion of the powder supply assembly 1018 of FIG. 10B. FIG. 10D, illustrates (i) one complete first flow structure 1042DF for one supply module 1044; and (ii) partial, first flow structures 1042DF for two other adjacent supply modules 1044. In this embodiment, each first flow structure 1042DF includes the plurality of spaced apart first flow apertures 1042EF that are organized in a grid like fashion to allow the powder to flow therethrough.

In this implementation, one or more (typically all) of the first flow apertures 1042EF have an aperture cross-sectional area that is larger than a cross-sectional area of the powder. The first flow apertures 1042EF can be rectangular, circular or other suitable shape. Moreover, in this implementation, one or more (typically all) of the first flow apertures 1042EF have a first aperture size that is larger than a nominal powder particle size of each of the powder particles. In alternative, non-exclusive examples, the first aperture size is at least approximately 1, 1.25, 1.5, 1.75, 2, 2.5, 3, 4, 5, 6, or 8 times the nominal powder particle size. Further, in alternative, non-exclusive examples, the first aperture size is less than approximately 10, 12, 15, or 20 times the nominal powder particle size. Stated in a different fashion, one or more (typically all) of the first flow apertures 1042EF have an aperture cross-sectional area that is larger than a nominal powder particle cross sectional area of the individual particles of powder. In alternative, non-exclusive examples, one or more (typically all) of the first flow apertures 1042EF have a first aperture cross-sectional area is equal to or larger than the nominal powder cross sectional area of the individual particles of powder by at least, but not limited to, 1, 2, 3, 5, 10, 20, 40, 50, 60, 70, 80, 90, 100, 150, 200, 300, or 400 percent. Stated differently, as non-exclusive examples, the first aperture cross-sectional area can be at least approximately ten, twenty, fifty, one hundred, one thousand, or two thousand times the nominal powder cross-sectional area. Stated in yet another fashion, one or more (typically all) of the first flow apertures 1042EF have an aperture diameter that is larger than a nominal powder particle diameter of the powder particles. In alternative, non-exclusive examples, the aperture diameter is at least approximately 1, 1.25, 1.5, 1.75, 2, 3, 4, 5, 6, 7 or 8 times the nominal powder particle diameter. Further, in alternative, non-exclusive examples, the aperture diameter is less than approximately 10, 15, or 20 times the nominal powder particle diameter. However, depending upon the design, other aperture sizes, diameters or cross-sectional areas are possible.

It should be noted that the second flow apertures of the second flow structure 1042DS (illustrated in FIG. 100) can have similar characteristics to the first flow apertures 1042EF. In this design, the size and shape of the flow paths through the flow structures 1042DF, 1042DS are dynamically changing with the relative movement between the flow structures 1042DF, 1042DS.

Further, FIG. 10D also illustrates that the separate containers 1040E can have a tapered funnel configuration to urge the powder towards the first flow structure 1042DF.

Alternatively, or alternatively, one of more of the power supply modules 1044 can be modified and/or designed to have (i) a flow control assembly 642 that is similar to that described above and illustrated in FIGS. 6A and 6B; (ii) a flow control assembly 942 similar to that described above and illustrated in FIGS. 9A-9F; and/or (i) a flow control assembly 1142 similar to that described below and illustrated in FIGS. 11A-11C.

Additionally, or alternatively, the flow controller 1042A for one or more for the supply modules 1044 can be modified to include a shutter assembly 744 as illustrated in FIG. 7.

FIG. 11A is a perspective view of another implementation of the powder bed assembly 1114, and the powder supply assembly 1118 that deposits the powder 1112 under the control of the control system 1124 (illustrated with a box). This powder supply assembly 1118 can be integrated into in any of the processing machines 10, 210, 310 described above. Further, it should be noted that the powder bed assembly 1114 and the powder supply assembly 1118 can be designed to have any combination of the Movement Characteristics (i)-(viii) defined above. Moreover, the powder supply assembly 1118 can be used with a build platform 1126A that is circular, rectangular or other suitable shape.

As an overview, the powder supply assembly 1118 illustrated in FIG. 11A is a top-down, gravity driven system. The powder supply assembly 1118 is practical, relatively simple, and can provide a uniformly distributed layer of powder quickly and efficiently.

In FIG. 11A, the powder bed assembly 1114 is similar to the corresponding component described above and illustrated in FIG. 9A; and the powder supply assembly 1118 is slightly different from the corresponding component described above and illustrated in FIG. 9A. It should be noted that the build platform 1126A can be rotated about the rotation axis 1125A (e.g. the Z axis) or off-axis, and moved linearly downward along the rotation axis 1125A relative to the support side wall assembly 1126B during the adding of the powder 1112 and the forming of the object (not shown in FIG. 11A).

In this implementation, the powder supply assembly 1118 can again be controlled to be moved relative to the build platform 1126A (e.g. linearly along the X axis on the frame guides 1127D of the bed frame 1127 with the device mover 1128) while simultaneously and accurately distributing the powder 1112 to the build platform 1126A. For example, the powder supply assembly 1118 can be controlled to simultaneously distribute the powder 1112 while being moved back and forth linearly in a reciprocating fashion. Alternatively, the powder supply assembly 1118 could be attached to a support hub (not shown) similar to FIG. 6A, or have some other attachment.

The powder supply assembly 1118 uniformly distributes a fine layer of powder over the relatively large and broad build platform 1126A. In one implementation, the powder supply assembly 1118 again includes the supply frame assembly 1138, the powder container assembly 1140, and the flow control assembly 1142 (illustrated in FIG. 11B).

The supply frame assembly 1138 (i) is rigid, (ii) extends over the powder bed assembly 1114 between the frame guides 1127D, and (iii) supports the powder container assembly 1140, and the flow control assembly 1142 above the build platform 1126A. The supply frame assembly 1138 can be similar to the corresponding component described above and illustrated in FIG. 9A.

The powder container assembly 1140 retains the powder prior to distribution on the build platform 1126A. The powder container assembly 1140 can be somewhat similar to the corresponding component described above and illustrated in FIG. 9A or alternatively in FIG. 10 with the container dividers 1040D.

Additionally, and optionally, the powder container assembly 1140 can include one or more vibration generators 952 (illustrated in FIG. 9A) that are controlled by the control system 1124. With this design, the vibration generator(s) 952 are controlled (i) to inhibit bridging, clumping, or clogging of a powder, and/or (ii) to evenly distribute the powder in the powder container assembly 1140.

Additionally, and optionally, the powder supply assembly 1118 can include a powder distributor 1148 that levels and/or smooths the powder 112 on the build platform 1126A. For example, the powder distributor 1148 can include an adjustable knife edge that engages the powder 1112 to function as a rake to smooth a top surface of the powder 1112 on the build platform 1126A. Additionally or alternatively, the powder distributor 1148 can include a roller.

Additionally, and optionally, the powder supply assembly 1118 can include a large, bulk powder tank 950 (illustrated in FIG. 9A) that supplies powder to the powder container assembly 1140.

FIG. 11B is a top view of a portion of the powder supply assembly 1118 of FIG. 11A. FIG. 11B illustrates the supply frame assembly 1138, the powder container assembly 1140 and the flow control assembly 1142. In this implementation, the flow control assembly 1142 again includes a flow controller 1142A and an activation system 1142B, e.g. a rotary motor or other type of actuator.

More specifically, in one implementation, (i) the flow controller 1142A can include one or more shaft shaped flow structures 1142D (only one is shown) that extends along the container bottom 1140C along the Y axis; and (ii) the activation system 1142B can include one or more actuators that selective move (e.g. rotate) the one or more of the flow structures 1142D relative to the powder container 1140A to release the powder.

For example, the flow structure 1142D can be a rigid, circular shaped shaft that includes one or a plurality of surface features 1142E (represented with “X's”) such as grooves and/or indentations. The grooves 1142E in the flow structure 1142D can be formed in a helical pattern or a spiral screw pattern. The surface features 1142E have surface cross-sectional areas that are larger than a powder cross-sectional area of one of the powder particles 1112. The surface cross-sectional areas can be similar to the aperture cross-sectional areas described above. As non-exclusive examples, the surface features 1142E can have a feature size that is larger than a nominal powder particle size of each of the powder particles. In alternative, non-exclusive examples, the feature size is at least approximately 1, 1.25, 1.5, 1.75, 2, 2.5, 3, 4, 5, 6, or 8 times the nominal powder particle size. Further, in alternative, non-exclusive examples, the feature size is less than approximately 10, 12, 15, or 20 times the nominal powder particle size. Stated in a different fashion, one or more (typically all) of the surface features 1142E have a feature cross-sectional area that is larger than a nominal powder particle cross sectional area of the individual particles of powder. In alternative, non-exclusive examples, one or more (typically all) of the surface features 1142E have a feature cross-sectional area is equal to or larger than the nominal powder cross sectional area of the individual particles of powder by at least, but not limited to, 1, 2, 3, 5, 10, 20, 40, 50, 60, 70, 80, 90, 100, 150, 200, 300, or 400 percent. Stated differently, as non-exclusive examples, the feature cross-sectional area can be at least approximately ten, twenty, fifty, one hundred, one thousand, or two thousand times the nominal powder cross-sectional area. In certain implementations, the surface features 1142E can have a depth of at least approximately ten, twenty, thirty, forty, fifty, or sixty percent larger than the individual, nominal powder particle size. However, depending upon the design, other feature sizes, feature depths, and/or cross-sectional areas are possible.

Further, the activation system 1142B can rotate the flow structure 1142D continuously or back and forth about a rotation axis 11421. With this design, the powder 1112 in the funnel shaped powder container 1140A moves in the surface features 1142E of the flow structure 1142D, and rotation of the flow structure 1142D will result in the powder 1112 being evenly dispensed.

FIG. 110 is a cut-away view taken on line 11C-110 in FIG. 11B. FIG. 110 illustrates (i) a cut-away view of the funnel shaped powder container 1140A with the container top 1140B and the container bottom 1140C; (ii) the shaft shaped flow structure 1142D of the flow controller 1142A that is positioned adjacent to the container bottom 1140C; and (iii) a portion of the activation system 1142B.

In one implementation, the activation system 1142B include a rotary motor 1142BA, and a worm gear assembly 1142BB that couples the rotary motor 1142BA to the flow structure 1142D.

The design of the powder distributor 1148 can be varied. In FIG. 110, the powder distributor includes one or more adjustable rake(s) 1148A (e.g. knife edges), and a rake tensioner 1148B that spring preloads the rake edge(s). The rake edges 1148A can be positioned symmetrically on opposite sides of the flow structure 1142D. The rake(s) 1148A can be sickle-shaped or curved to follow the shape of the flow structure 1142D to keep the rake(s) 1148A close to the profile of the flow structure 1142D.

The rake(s) 1148A can be used to improve the uniformity of the distribution of the metal powder 1112 and remove of any center high spots.

In this embodiment, the grooved flow controller 1142A is combined with a set of symmetrical rakes 1148A. Further, the powder supply assembly 1118 can moved linearly and/or rotationally relative to the build platform 1126A to provide a centerless, thin layer of metal powder distributed uniformly over the build plane.

Additionally, or alternatively, the flow control assembly 1142 can be modified to include a shutter assembly 744 as illustrated in FIG. 7.

FIG. 12A is a partial cut-away view of another implementation of the powder supply assembly 1218 that distributes powder 1212 onto a build platform 1234A of a powder bed assembly 1214. FIG. 12A also illustrates the control system 1224. The powder supply assembly 1218 can be integrated into in any of the processing machines 10, 210, 310 described above. It should be noted that the powder bed assembly 1214 and the powder supply assembly 1218 can be designed to have any combination of the Movement Characteristics (i)-(viii) defined above. Further, the powder supply assembly 1218 can be used with a build platform 1234A that is circular, rectangular or other suitable shape.

FIG. 12B is a simplified top view of a portion of the powder supply assembly 1218 of FIG. 12A without the powder 1212.

With reference to FIGS. 12A and 12B, the powder supply assembly 1218 again includes a powder container assembly 1240, and a flow control assembly 1242 that are somewhat similar to the corresponding components described above and illustrated in FIG. 6A. The supply frame assembly is not illustrated in this implementation. However, the supply frame assembly can be designed to support and couple the powder container assembly 1240, and the flow control assembly 1242 to the rest of the processing machine 10, 210, 310.

Instead of one big powder container 640A as illustrated in FIG. 6A, the powder supply assembly 1218 in FIGS. 12A and 12B includes multiple, cascading, smaller powder containers 1240A that are spaced apart and aligned (distributed in series) along a container axis 1241 (e.g. the Z axis and aligned with gravity). These smaller powder containers 1240A cooperate to effectively form a much larger powder container. As provided herein, larger volume containment of powder 1212 can result in powder locking. However, the use of the multiple, smaller powder containers 1240A in series can improve the powder 1212 distribution of the powder supply assembly 1218 to the build platform 1234A.

The number of different powder containers 1240A can be varied to suit the design requirements of the system. For example, the powder supply assembly 1218 can include four, separate powder containers 1240A. Alternatively, it can be designed to include more than four or fewer than four powder containers 1240A. The four powder containers 1240A can be labeled A-D moving top to bottom for convenience.

The size and shape of each powder container 1240A can be varied to suit the powder 1212 supply requirements for the system. In one non-exclusive implementation, each powder container 1240A is tapered, rectangular tube shaped (truncated V shaped cross-section), and moving top to bottom (A to D) along the container axis 1241, each subsequent powder container 1240A is smaller than the previous powder container 1240A. Thus, (i) the powder container 1240A labeled “A” is larger than powder container 1240A labeled “B”; (ii) the powder container 1240A labeled “B” is larger than powder container 1240A labeled “C”; and (iii) the powder container 1240A labeled “C” is larger than powder container 1240A labeled “D”. In this implementation, the powder containers 1240A are similar shaped, but graduated in size. Alternatively, the sizes of the powder containers 1240A can be different from that illustrated in FIGS. 12A and 12B. For example, one or more of the powder containers 1240A can be similar in size.

Similar to FIG. 6A, each powder container 1240A can include (i) an open, container proximal end 1240C; (ii) an open, container distal end 1240D; (iii) a front side 1240E; (iv) a back side 1240F; (v) a left side 1240G; and (vi) a right side 1240H. In one design, the left side 1240G and the right side 1240H extend substantially parallel to each other; while the front side 1240E and a back side 1240F taper towards each other moving from the container distal end 1240D to the container proximal end 1240C. It should be noted that the powder container assembly 1240 in FIG. 12A is rotated ninety degrees from the illustration in FIG. 6A, and the designations for front, back, left, right have been maintained from FIG. 6A.

Further, in FIGS. 12A and 12B, each of the powder containers 1240A includes a separate flow controller 1242A and one or more vibration generators 1242C that can be individually controlled with the control system 1224. Each flow controller 1242A and vibration generator 1242C can be similar to the corresponding components described above and illustrated in FIG. 6A. Each powder container 1240A with its corresponding flow controller 1242A and one or more vibration generators 1242C can be collectively be referred to as a supply module 1244. In this example, the powder supply assembly 1218 includes four separate supply modules 1244 that are arranged in series. The designations A-D can also be used to represent the respective supply modules 1244 moving from top to bottom.

With the present design, the vibration generators 1242C can be independently controlled to control the distribution of the powder 1212 from each powder container 1240A in the series. In one implementation, the goal is to keep the lowest supply module 1244 “D” at the proper level for accurately depositing the powder 1212 onto the build platform 1234A. With this design, (i) the vibration generator(s) 1242C are individually controlled for supply modules 1244 “A” “B” and “C” to maintain the proper level of powder 1212 in supply module 1244 “D”; and (ii) the vibration generator(s) 1242C for supply module 1244 “D” are individually controlled to accurately deposit the powder 1212 onto the build platform 1234A. More specifically, in this design, (i) supply module 1244 “A” is controlled to maintain supply module 1244 “B” at the desired level; (ii) supply module 1244 “B” is controlled to maintain supply module 1244 “C” at the desired level; (iii) supply module 1244 “C” is controlled to maintain supply module 1244 “D” at the desired level; and (iv) supply module 1244 “D” is controlled to accurately deposit the powder 1212 onto the build platform 1234A. This is a cascading supply module 1244 arrangement.

As provided herein, depending on the powder 1212, the vibration generator(s) 1242C can be less effective at activating powder flow through the respective flow controller 1242A when there is too much powder in the powder container 1240A. A large volume powder container 1240A is preferred to reduce how often the powder container 1240A needs to be refilled, however the weight of a large volume of powder 1212 in the powder container 1240A increases the likelihood of high powder “locking” forces at the flow controller 1242A reducing the accuracy of the powder flow through the flow controller 1242A when the vibration generator(s) 1242C are activated. Thus, the problem of large volume (exacerbating powder locking) in a single large powder container, is solved by the cascading supply modules 1244 arrangement.

In one implementation, the height of the powder container 1240A of each supply module 1244 is limited to reduce the locking force at the respective flow controller 1242A to what can be overcome by the corresponding vibration generator(s) 1242C.

Additionally, the powder supply assembly 1218 can include a container feedback system 1241B (illustrated with a box) that measures the level, volume, or other characteristic of powder 1212 in one or more of the powder containers 1240A to allow for the closed loop control of the flow control assembly 1242. For example, each of the powder containers 1240A can include a separate container sensor 1241C that provides information regarding the level of powder in the respective powder container 1240A. For example, each container sensor 1241C can be based on detecting powder physical properties (e.g. optical, mass, etc.).

With this design, (i) when supply module 1244 “D” is determined to be too low by the container sensor 1241C, supply module 1244 “C” can be activated and controlled in a closed loop fashion to fill supply module 1244 “D” to the desired level; (ii) when supply module 1244 “C” is determined to be too low by the container sensor 1241C, supply module 1244 “B” can be activated and controlled in a closed loop fashion to fill supply module 1244 “C” to the desired level; and (iii) when supply module 1244 “B” is determined to be too low by the container sensor 1241C, supply module 1244 “A” can be activated and controlled in a closed loop fashion to fill supply module 1244 “B” to the desired level.

Additionally, the flow controller 1242A of one or more of the supply modules 1244 can be designed to include one or more shutter assemblies 744 (illustrated in FIG. 7) similar to FIG. 7.

Additionally, or alternatively, one of more of the power supply modules 1244 can be modified and/or designed to have (i) a flow controller 942A similar to that described above and illustrated in FIGS. 9A-9F; (ii) a flow controller 1042A similar to that described below and illustrated in FIGS. 10A-10D; and/or (i) a flow controller 1142A similar to that described below and illustrated in FIGS. 11A-11C.

FIG. 13A is a simplified side view of another implementation of the powder supply assembly 1318 that distributes powder 1312 (illustrated with circles) onto a build platform 1326A of a powder bed assembly 1314. FIG. 13A also illustrates the control system 1324 (illustrated as a box). The powder supply assembly 1318 can be integrated into in any of the processing machines 10, 210, 310 described above. It should be noted that the powder bed assembly 1314 and the powder supply assembly 1318 can be designed to have one or more of the Movement Characteristics (i)-(viii) defined above. Further, the powder supply assembly 1318 can be used with a build platform 1326A that is circular, rectangular or other suitable shape.

In FIG. 13A, the powder supply assembly 1318 is uniquely designed to direct the powder 1312 toward the build platform 1326A in an improved fashion.

As provided herein, the build platform 1326A and a previously deposited powder 1312A already on the build platform 1326A can be moved in a platform movement direction 1350 at a platform velocity while the new powder 1312 is being distributed onto the build platform 1326A. In one implementation, the powder supply assembly 1318 is designed so that the new powder 1312 exiting the powder supply assembly 1318 has an exit movement direction 1352 and an exit velocity just before the powder 1312 is distributed onto the build platform 1326A.

In certain implementations, the powder supply assembly 1318 is designed so that the exit velocity is approximately equal to the platform velocity. As non-exclusive examples, the powder supply assembly 1318 is designed so that the exit velocity is within (plus or minus) five, ten, fifteen, twenty or thirty percent of the platform velocity. In one specific implementation, the powder supply assembly 1318 directs the powder 1312 out, laterally, close to or at the speed of the spinning build platform 1326A so the power 1312 doesn't skid or tumble. This variability might be attributed to the fact that, in a rotating system, the build platform 1326A velocity varies depending on where along the radius the powder 1312 is being directed, and the powder velocity might be fixed across all radii. This percentage above will partly depend on how far off the powder 1312 is from the rotation axis of the build platform 1326A.

Additionally, or alternatively, the powder supply assembly 1318 is designed so that the exit movement direction 1352 is approximately parallel to the platform movement direction. As non-exclusive examples, the powder supply assembly 1318 can be designed so that the exit movement direction 1352 is within approximately ten, fifteen, twenty, thirty, or forty degrees of being parallel to the platform movement direction 1350. Stated in another fashion, the exit movement direction 1352 is approximately parallel to the build platform 1326A or somewhere between parallel and vertical.

The exit movement direction 1352 can be considered as having (i) a horizontal, first movement component 1352A that is parallel to the platform movement direction 1350 and the X axis; and (ii) a vertical, second movement component 1352B (e.g. along the Z axis and aligned with gravity) that is perpendicular to the platform movement direction 1350. In certain embodiments, the powder supply assembly 1318 is designed so that the powder velocity along the first movement component 1352A is approximately equal to the platform velocity. As non-exclusive examples, the powder supply assembly 1318 is designed so that the powder velocity along the first movement component 1352A is within five, ten, fifteen, twenty or thirty percent of the platform velocity.

With this design, the deposited powder 1312 and build platform 1326A are moving at approximately the same speed in approximately the same direction. The problem of limited powder application rate (hence throughput) is solved, for example, by matching the velocity of the powder 1312 and the velocity of the build platform 1326A before contact.

The powder supply assembly 1318 again includes a powder container assembly 1340, and a flow control assembly 1342. The supply frame assembly is not illustrated in this implementation. However, the supply frame assembly can be designed to support and couple the powder container assembly 1340, and the flow control assembly 1342 to the rest of the processing machine 10, 210, 310.

The powder container assembly 1340 can be a large hopper that retains the powder 1312 that is distributed over time onto the build platform 1326A.

The flow control assembly 1342 is controlled by the control system 1324 to selectively deposit the powder 1312 from the powder container assembly 1340 to the build platform 1326A. In FIG. 13A, the flow control assembly 1342 includes a flow controller 1342A, an actuation system 1342B, and a ramp 1356 that cooperate so that the powder 1312 is moving to have the desired exit movement direction 1352 and exit velocity.

In one implementation, the flow controller 1342 can be a door that is selectively opened and closed as necessary by the actuation system 13428 (e.g. a motor). When the door is open, the gravitational force causes the powder 1312 to fall onto the ramp 1356.

In one embodiment, the ramp 1356 includes a ramp curve 1356A, and the ramp 1356 has a ramp height 1356B. In this embodiment, the ramp curve 1356A directs the powder 1312 to have the desired exit movement direction 1352, and the ramp height 1356B is selected so that the powder 1312 has the desired exit velocity. Thus, the characteristics of the ramp 1356 can be varied to achieve the desired exit movement direction 1352, and the ramp height 13568. Stated in another fashion, the shape of the ramp 1356 (e.g. height and curve) can be adjusted to adjust the exit velocity and exit movement direction 1352.

In one embodiment, the ramp 1356 has a ramp curve 1356A that is approximately ninety degrees. Alternatively, the ramp 1356 can be designed to have a ramp curve 1356A within plus or minus twenty, fifteen, ten, or five degrees of being ninety degrees.

FIG. 13B is a simplified top view of the powder supply assembly 1318 of FIG. 13A including the ramp 1356 without the powder 1312 and without the powder bed assembly 1314.

With reference FIGS. 13A and 13B, additionally, the powder supply assembly 1318 can include a surplus system 1358 that takes up additional powder 1312. In one embodiment, the surplus system 1358 is spaced apart from the ramp 1356, and includes (i) a surplus frame 1358A; (ii) one or more, rotating surplus rollers 1358B (two are illustrated); and (iii) a surplus receptacle 1358C. With this design, the surplus frame 1358A and surplus rollers 1358B can be used to direct excess powder 1312 to the surplus receptacle 1358C. For example, the surplus rollers 1358B can function as take-up brushes to collect the excess powder 1312 in the surplus receptacle 1358C.

In FIGS. 13A and 13B, the powder supply assembly 1318 is a gravity feed powder delivery system, with a ramp 1356 and take-up brushes 1356B. The gravity feed powder delivery system is positioned at the top of a ramp. The ramp is stationary and has at least one supply aperture 1357 (opening) formed on the bottom surface facing the build platform 1326A. The powder 1312 released from the gravity feed powder delivery system slides along the ramp 1356, passes through the supply aperture 1357, and falls down to the build platform 1326A or the previously deposited powder 1312A.

In some embodiments, for a linearly moving build platform 1326A, the platform velocity across the build platform 1326A is substantially the same, and a ramp height 1356B can be uniform and be set such that the exit velocity of the applied powder 1312 leaving the ramp 1356 matches the platform velocity.

FIG. 13C is a simplified perspective view of another embodiment of the ramp 1356C with the powder container assembly 1340. In some embodiments, for a rotating build platform (not shown in FIG. 13C), the outer radius of the build platform is moving faster than the inner radius of the build platform. In this implementation, the position of the powder container assembly 1340 and a ramp height 1356D of the ramp 1356C can be varied across the ramp 1356C so that the powder 1312 (illustrated in FIG. 13A) has a velocity that varies across the ramp 1356C to match the velocity of the build platform (e.g., matching means that the exit velocity of the powder exiting the ramp 1356C moves 5%, 10%, or 20% slower or faster than the platform velocity).

In this example, the ramp height 1356D of the gravity feed powder delivery system can vary along the Y axis. This would be beneficial in the case where the velocity of the build platform varies along the Y-axis (as in a rotating turntable 3D printer).

In a simple example, ignoring friction: If a rotating turntable 3D printer has a diameter of 0.7 meters and it is desired to apply a powder layer within one second, then the maximum tangential powder bed velocity would be V=2.2 m/s, and then the maximum height of a gravity feed powder delivery system would need to be about, H=V²/2 g=0.25 meters.

In an alternative embodiment, a forced powder delivery system (e.g. with pumps, brushes, and/or conduits) can be used instead of a gravity feed system to achieve the desired exit movement direction 1352 and exit velocity. For example, a rotational sweeper can direct the powder 1312 at the desired exit movement direction 1352 and exit velocity instead of relying on gravity and a sloping ramp.

FIG. 14A is a simplified side view of another implementation of the powder supply assembly 1418 that distributes powder 1412 (illustrated with circles) onto a build platform 1426A of a powder bed assembly 1414 for building an object 1411. FIG. 14A also illustrates the control system 1424 (illustrated as a box). The powder supply assembly 1418 can be integrated into in any of the processing machines 10, 210, 310 described above. It should be noted that the powder bed assembly 1414 and the powder supply assembly 1418 can be designed to have one or more of the Movement Characteristics (i)-(viii) defined above. Further, the powder supply assembly 1418 can be used with a build platform 1426A that is circular, rectangular or other suitable shape.

Somewhat similar to the embodiment illustrated in FIG. 13A, 13B, the build platform 1426A and a previously deposited powder 1412A already on the build platform 1426A can be moved in a platform movement direction 1450 (illustrated with an arrow) at a platform velocity while the new powder 1412 is being distributed onto the build platform 1426A. Further, the powder supply assembly 1418 is designed so that the new powder 1412 exiting the powder supply assembly 1418 has an exit movement direction 1452 (illustrated with an arrow) and an exit velocity just before the powder 1412 is distributed onto the build platform 1426A.

Further, similar to embodiment in FIGS. 13A, 13B, the powder supply assembly 1418 is designed so that (i) the exit velocity is approximately equal to the platform velocity, and/or (ii) the exit movement direction 1452 is approximately parallel to the platform movement direction 1450. With this design, the deposited powder 1412 and build platform 1426A are moving at approximately the same speed in approximately the same direction. The problem of limited powder application rate (hence throughput) is solved, for example, by matching the velocity of the powder 1412 and the velocity of the build platform 1426A before contact. Further, the powder supply assembly 1418 quickly delivers the powder 1412 to the build platform 1426A without disturbing the object 1411 that is being built.

In the simplified illustration of FIG. 14A, the powder supply assembly 1418 includes (i) a delivery frame 1460 retains the powder 1412; (ii) a frame mover 1462 (illustrated as a box) that moves the delivery frame 1460; and (iii) a rake 1466 that cooperate to deliver the powder 1412 to the build platform 1426A at the desired exit velocity and exit movement direction 1452.

For example, the delivery frame 1460 can function as a sieve and can include a rigid plate having a plurality of spaced apart delivery apertures 1460A that allow the powder 1412 to flow therethrough. The delivery apertures 1460A can be organized in a grid or other pattern. Moreover, in this implementation, one or more (typically all) of the delivery apertures 1460A have an aperture size that is larger than a nominal powder particle size of each of the powder particles 1412. In alternative, non-exclusive examples, the aperture size is at least approximately ten, twenty, fifty, one hundred, or one thousand times the nominal powder particle size. Stated in a different fashion, one or more (typically all) of the delivery apertures 1460A have an aperture cross-sectional area that is larger than a nominal powder particle cross sectional area of the individual particles of powder 1412. As non-exclusive examples, the delivery apertures 1460A can have a cross-sectional area of approximately ten, twenty, fifty, one hundred, or one thousand times a nominal cross-sectional area of the powder 1412. However, depending upon the design, other aperture sizes, or cross-sectional areas are possible.

In certain implementations, the frame mover 1462 moves the delivery frame 1460 (i) along a frame movement direction 1468 that is approximately parallel to the platform movement direction 1450; and/or (ii) at a frame velocity that is approximately equal to the platform velocity. As non-exclusive examples, the frame mover 1462 can move the delivery frame 1460 so that (i) frame movement direction 1468 is within approximately one, two, three, or five degrees of being parallel to the platform movement direction 1350; and/or (ii) the frame velocity is within (plus or minus) five, ten, fifteen, twenty or thirty percent of the platform velocity.

The rake 1466 maintains the excess powder 1412 on the delivery frame 1460. In the non-exclusive implementation of FIG. 14A, the delivery frame 1460 and the build platform 1426A move relative to the rake 1466. For example, the rake 1466 can be fixed. Further, the delivery frame 1460 can move under the rake 1466. Thus, the delivery frame 1460 is positioned between the rake 1466 and the build platform 1426A.

With this design, the moving delivery frame 1460 accelerates the supplied powder 1412 to approximately the platform velocity of the build platform 1432A. The rake 1466 is used to level the applied powder 1412 while the applied powder 1412 is retained by the moving delivery frame 1460. In one implementation, there is a slight velocity difference between the platform velocity and the frame velocity. For example, the velocity difference can be approximately equal to an aperture pitch of the delivery apertures 1462 divided by the powder spreading time. For example, if the aperture pitch is one millimeter and the application time is one second, then the velocity difference can be controlled to be about one millisecond. With this design, coarse raking is achieved with the delivery frame 1460, and finer raking can be achieved with another rake (not shown) that is downstream.

In certain implementations, for a build platform 1426A that is moved linearly, the frame mover 1462 can move the delivery frame 1460 linearly in a reciprocating. Further, the energy beam 22D (illustrated in FIG. 1A) can be aimed through the delivery aperture(s) 1462.

Alternatively, in certain implementations, for a build platform 1426A that is rotated, the delivery frame 1460 can be disk shaped, and the frame mover 1462 can rotate the delivery frame 1460 over the rotating build platform 1426A. Similarly, in this design, the energy beam 22D (illustrated in FIG. 1A) can be aimed through the delivery aperture(s) 1462.

FIG. 14B is a simplified side view of the powder supply assembly 1418 of FIG. 14A at a subsequent time with the build platform 1426A and the delivery frame 1460 having been moved relative to the rake 1466. At this time, the build platform 1426A is still moving in the platform movement direction at the platform velocity, and the frame mover 1462 is moving the delivery frame 1460 in the frame movement direction 1468 at the frame velocity to continue to distribute the powder 1412 (illustrated with circles) onto the build platform 1426A.

FIG. 15 is a top view of a portion of another implementation of a processing machine 1510. More specifically, FIG. 15 is a simplified top illustration of a powder bed assembly 1514 and a powder supply assembly 1518 that can be used in any of the processing machines 10, 210, 310 disclosed herein. An energy zone 1522A where the energy system 22 (illustrated in FIG. 1A) can direct the energy beam(s) 22D (illustrated in FIG. 1A) to melt the powder 1512 is also illustrated in FIG. 15 with two circles (to represent two energy sources being utilized). The energy zone 1522A represents the exposure field that is accessible with the energy beam(s) 22D.

In FIG. 15, the powder bed assembly 1514 includes (i) a relatively large support bed 1526 that supports at least one build platform 1526A; and (ii) a bed frame 1527. Further, in this embodiment, the powder supply assembly 1518 is secured to, support by, and moves with the support bed 1526 and the build platform 1526A.

In certain implementations, the build platform 1526A is quite large to allow for the forming large objects 11 (illustrated in FIG. 1A). In certain designs, the energy zone 1522A (possible exposure field) is insufficient to cover large build platforms 1526A. Thus, either the build platform 1526A or the energy system 22 will have to be moved to allow for coverage of the entire build platform 1526A.

In one implementation, the powder bed assembly 1514 also includes a mover assembly 1528 (illustrated with a box) that concurrently moves the support bed 1526 with the build platform 1526A, and the powder supply assembly 1518 relative to the bed frame 1527, the energy zone 1522A, and the energy system 22. For example, the mover assembly 1528 can rotate the support bed 1526 with the build platform 1526A, and the powder supply assembly 1518 in a moving direction 1525 about a rotational axis 1525A (illustrated with a “+”, e.g. the Z axis) relative to the bed frame 1527 at a substantially constant or variable rate during the depositing of the powder 1512 and the forming of the object. Stated in another fashion, the support bed 1526, the build platform 1526A, and the powder supply assembly 1518 are rotated like a turntable during printing of the objects 11.

The large build platform 1526A can be very heavy, so the continued rotation of build platform 1526A to provide access to the energy zone 1522A will require less power than stop and start type movements. Stated in another fashion, an alternative design would require either moving the energy system 22 or the large build platform 1526A linearly in a reciprocating motion to provide the possibility of exposure to the whole build platform 1526A. This would require that the energy system 22 or the large build platform 1526A be accelerated and decelerated repeatedly. Further, this may require the stoppage of movement to allow a powder spreader or raking mechanism to sweep across the build platform 1526A before the next exposure. However, accelerating, decelerating, stopping and starting the movement of a large mass (e.g., the large object and build platform 152A) requires a lot of energy and time, is costly, inefficient, and limits the throughput. The present design solves these issues by rotating the build platform 1526 and the power supply assembly 1518 concurrently.

With the present design, the energy system 22 can be fixed source and positioned off to the side of the rotational axis 1525A. This allows the whole build platform 1526A rotate and pass underneath the fixed energy system 22. An advantage of this approach is, for example, that the fixed energy system 22 only needs to cover the radius and not the full diameter of the build platform 1526A, which as mentioned above, drastically reduces the size of the required energy zone 1522A needed to print a large object 11.

Additionally, and optionally, the build platform 1526A can be moved somewhat like an elevator vertically (along the Z axis) downward relative to the support bed 1526 with a platform mover assembly 1534D (illustrated in phantom with a box) during fabrication of the objects 11.

Additionally, or alternatively, the platform mover assembly 1534D can also be used to move (e.g. rotate) the build platform 1526A relative to the support bed 1526 somewhat similar to what is described in FIG. 5 above.

In one embodiment, the powder supply assembly 1518 includes (i) a powder container assembly 1540 (illustrated as a box) that retains the powder 1512; and (ii) a flow control assembly 1542 (illustrated as a dashed box) that selectively controls the flow of the powder 1512 from the powder container assembly 1540 to the build platform 1526A. As non-exclusive examples, the powder container assembly 1540 can be similar to any of the powder container assemblies described herein; and/or the flow control assembly 1542 can be similar to any of the flow control assemblies described herein.

Additionally, or alternatively, the powder supply assembly 1518 can be designed to include a powder distributor 1548 (illustrated with a dashed box) that spreads and/or levels the powder 1512 on the build platform 1526A. The powder distributor 1548 can be similar to any of the powder distributors described herein. For example, the powder distributor 1548 can include one or more rakes and/or rollers.

In it should be noted that the powder supply assembly 1518 can be designed to include (i) the power container assembly 1540 and the flow control assembly 1542; (ii) the power container assembly 1540, the flow control assembly 1542, and the powder distributor 1548; or (iii) just the powder distributor 1548.

Additionally, the powder supply assembly 1518 can include a supply mover assembly 1532 that moves the powder supply assembly 1518 relative to the support bed 1526, the build platform 1526A, and the energy zone 1522A. For example, the supply mover 1532 can include one or more linear guides 1532A (illustrated with boxes) and one or more linear movers 15328 (illustrated with dashed boxes) that move the powder supply assembly 1518 back and forth linearly relative to the support bed 1526 and the build platform 1526A. With this design, the powder supply assembly 1518 can be moved back and forth to rapidly distribute and/or level the powder 1512 on the entire build platform 1526A, and subsequently be parked out of the way (e.g. off of the build platform 1526A) to allow the energy beam 22D to melt the powder 1512.

Moreover, with this design, the powder 1512 is rapidly distributed on the build platform 1526A without the need to stop rotation of the support bed 1526. Additionally, with this design, the powder supply assembly 1518 can extend over and straddle the entire, round build platform 1526A. As a result thereof, the powder supply assembly 1518 can access and provide an even, seamless, smooth layer of powder 1512 with one linear motion, and without any missed areas or powder buildup on the build platform 1526A.

Further, from the perspective of the powder supply assembly 1518, because the powder supply assembly 1518 is rotating with the build platform 1526A, the powder 1512 on the build platform 1526A is still. Thus, the powder supply assembly 1518 can be moved linearly straight across the build platform 1526A. In other words, the linear powder supply assembly 1518 is always in the same coordinate system relative to the build platform 1526A. Moreover, the linear powder supply assembly 1518 can actuate across the build platform 1526A at any time, regardless of the rotational position of the support bed 1526.

With regards to FIG. 15, the problem of three-dimensional printing large objects with a limited energy zone 1522A (exposure field that is insufficient to cover a large build platform) is solved, by a processing machine 1510 that includes a rotating build platform 1526A and a linear powder supply assembly 1518 coupled to the rotating build platform 1526A such that the linear powder supply assembly 1518 rotates with the build platform 1526A. In this design, the rotation of the build platform 1526A allows the use of a smaller exposure field 1522A to cover the entire build platform 1526A. This design, eliminates the need to rapidly accelerate, decelerate, stop and start the motion of the build platform 1526A after each exposure. Thus, the processing machine 1510 provides an ability to three-dimensionally print large metal objects in a cost-effective and efficient manner, potentially increasing throughput at minimal increased cost and complexity as compared with existing methods and systems.

FIG. 16 is a simplified top view of a portion of still another embodiment of a processing machine 1610. In this embodiment, the processing machine 1610 includes (i) the powder bed 1626; (ii) the powder depositor 1618; and (iii) the irradiation device 1622 that are somewhat similar to the corresponding components described above. It should be noted that the processing machine 1610 may include the pre-heat device, the measurement device, the cooler device, and the control system, that have been omitted from FIG. 16 for clarity. The powder depositor 1618, the irradiation device 1622, the pre-heat device, the cooler device, and the measurement device may collectively be referred to as the top assembly.

In this embodiment, the problem of building a practical and low cost three dimensional printer 1610 for three dimensional printing of one or more metal parts 1611 (illustrated as a box) is solved by providing a rotating powder bed 1626, and the powder depositor 1618 is moved linearly across the powder bed 1626 as the powder bed 1626 is rotated in a moving direction 1625 about a rotation axis 1626D that is parallel to the Z axis. The part 1611 is built in the cylindrical shaped powder bed 1626.

In one embodiment, the powder bed 1626 includes the support surface 1626B having an elevator platform that may be moved vertically along the rotation axis 1626D (e.g. parallel to the Z axis), and the cylindrical side wall 1626C that surrounds an “elevator platform”. With this design, fabrication begins with the support surface 1626B (elevator) placed near the top of the side wall 1626C. The powder depositor 1618 translates across the powder bed 1626 spreading a thin powder layer across the support surface 1626B.

In FIG. 16, the irradiation device 1622 directs the irradiation beams 1622D to fuse the powder to form the parts 1611. In this embodiment, the irradiation device 1622 includes multiple (e.g. three), separate irradiation energy sources 1622C (each illustrated as a solid circle) that are positioned along the irradiation axis 1622B. In this embodiment, each of the energy sources 1622C generates a separate irradiation beam 1622D (illustrated with dashed circle). In the embodiment shown, three energy sources 1622C are arranged in a line along the irradiation axis 1622B (transverse to the rotation axis 1626D) so that together they may cover at least the radius of the support surface 1626B. Further, the three energy sources 1622C are substantially tangent to each other in this embodiment, and the irradiation beams 1622D are overlapping. Because the irradiation beams 1622D cover the entire radius of the powder bed 1626, every point in the powder bed 1626 may be reached by at least one of the irradiation beams 1622D. This prevents an exposure “blind spot” at the center of rotation of the powder bed 1626. It should be noted that the powder beds in FIGS. 15-17 don't necessarily need to have a rotation axis in the center. These systems may be designed so that one or more build platform(s) travel in a larger ring around an off-centered axis to improve the way they pass under the energy source.

In an alternative embodiment, where lower throughput is acceptable, a single energy source may be used with the beam being steered in the radial direction. In this embodiment, the beam is scanned parallel to the irradiation axis 1622B that is transverse to the rotation axis 1626D and that crosses the movement direction. In another alternative embodiment, a single energy source with sufficient beam deflection width to cover the desired part radius may expose every point within the build volume.

The powder depositor 1618 distributes the powder across the top of the powder bed 1626. In this embodiment, the powder depositor 1618 includes a powder spreader 1619A and a powder mover assembly 16198 that moves the powder spreader 1619A linearly, transversely to the powder bed 1626.

In this embodiment, the powder spreader 1619A deposits the powder on the powder bed 1626. In some embodiments, the powder spreader 1619A comprises features that control the width of the powder distribution area to minimize or prevent powder from falling outside the cylindrical powder bed 1626. In other embodiments, the side walls 1626C may include flanges that extend into the corners of the powder spreading area, wherein the flanges prevent excess powder from being spread outside the cylindrical powder bed 1626.

The powder mover assembly 1619B moves the powder spreader 1619A linearly with respect to the powder bed 1626, while the powder bed 1626 and powder depositor 1618 are rotating together about the rotation axis 1626D. In one embodiment, the powder mover assembly 1619B includes a pair of spaced apart actuators 1619C (e.g. linear actuators) and a pair of spaced apart linear guides 1619D (illustrated in phantom) that move the powder spreader 1619A along the Y axis, transversely (perpendicular) to the rotation axis 1626D and the powder bed 1626. The powder spreader 1619A may be moved across the powder bed 1626 to the empty “parking space” 1619C shown in dotted lines at the top of the FIG. 16.

After the powder spreader 1619A is parked at the opposite side of the rotating system, the irradiation device 1622 may be energized to selectively melt or fuse the appropriate powder into a solid part 1611.

In yet another embodiment, the powder bed 1626 may be rectangular and hold a larger volume of powder, but the maximum part volume is confined to a cylindrical volume within the rectangular powder bed 1626.

With this design, because the powder bed 1626 rotates relative to the irradiation device 1622, it is possible to reach every point in the part volume without requiring any acceleration or deceleration time. This feature provides a substantial throughput improvement over prior art systems. Because the only scanning part is the powder spreader 1619A with relatively low mass, high acceleration may be used to maintain high throughput.

Moreover, because the powder spreader 1619A is moved in a linear fashion relative to the powder bed 1626, the powder may be easily distributed in a flat and thin layer. This avoids an excess or lack of powder at the rotation center.

In another embodiment, the processing machine 1610 (i) may include more than one irradiation devices 1622 and more than one exposure areas (irradiation zones); and/or (ii) multiple parts 1611 may be made on the powder bed 1626 at one time to increase throughput. For example, the processing machine 1610 may include two irradiation devices 1622 that define two exposure areas, or three irradiation devices 1622 that define three exposure areas.

In certain embodiments, (i) the powder bed 1626 and the entire powder depositor 1618 are rotating at a substantially constant velocity about the rotation axis 1626D relative to irradiation device 1622, the pre-heat device, the cooler device, and/or the measurement device, and (ii) the powder depositor 1618 is moved linearly, with respect to the powder bed 1626 during the powder spreading operation. Alternatively, (i) the powder bed 1626 is rotated at a substantially constant velocity relative to the powder depositor 1618, irradiation device 1622, the pre-heat device, the cooler device, and/or the measurement device about the rotation axis 1626D, and (ii) the powder depositor 1618 is moved linearly relative to the irradiation device 1622, the pre-heat device, the cooler device, and/or the measurement device during the powder spreading operation.

Further, in yet another embodiment, (i) the powder bed 1626 is stationary, (ii) the irradiation device 1622, the pre-heat device, the cooler device, and/or the measurement device are rotated relative the powder bed 1626 about the rotation axis 1626D, and (iii) the powder depositor 1618 is moved linearly, transversely to the rotation axis 1626D, with respect to the stationary powder bed 1626 during the powder spreading operation.

In certain embodiments, the powder bed 1626 or the top assembly is continuously moved along the Z axis while printing to maintain a substantially constant height. Alternatively, the powder bed 1626 or the top assembly may be moved in a stepped like fashion along the Z axis. As another alternative, the powder bed 1626 or the top assembly may be ramped down gradually to the next print level.

The embodiments in which the powder bed 1626 is stationary and the top assembly is rotated may have the following benefits: (i) eliminate centrifugal forces on the melted metal and the dry powder at the surface, and, below the printing surface, on the powder bed's varied mixture of unused powder and parts in progress; (ii) eliminating the Z-stepping of the powder bed leaves the powder/melted metal/parts agglomeration truly undisturbed; (iii) Z-movement control may be easier with the much lighter and constant-mass top assembly than with the massive and growing powder bed; (iv) the top assembly could finish one complete rotation, then do nothing for 20 degrees of rotation, then start a new layer: this would distribute and perhaps average out any discontinuities or metallurgical differences at the stepping point, and each layer would start 20 degrees farther on, for example; (v) easier cooling system connections to the powder bed, if any are required; (vi) reduce controls complexity for the rotating part and Z-movement: a rotating powder bed is constantly gaining mass, but it needs a steady rotational speed and a steady Z-movement (or a uniform Z-step distance), so the control system has to adjust for that; (vii) a rotating top assembly is far lighter and of roughly constant mass (depending on whether powder replenishment is continuous or periodic); (viii) possibly simplify measurement system because everything is measured against the fixed floor of the powder bed 1626. In one embodiment, wireless communications and batteries may be used in the rotating top assembly. Further, printing could pause periodically to replenish power (via capacitors) and powder. Alternatively, if a pause would introduce build discontinuities, then continuous printing could be performed, and electricity might be supplied by continuous inductive charging or another non-contact method, and the powder hopper could be continuously replenished.

As provided above, in one embodiment, the powder bed 1626 is moved along the rotation axis 1626D, and the top assembly is rotated about the rotation axis 1626D at a constant angular velocity. If the powder bed 1626 is moved along the rotation axis 1626D at a constant speed, the relative motion between the powder bed 1626 and the top assembly will be spiral shaped (i.e., helical). In one embodiment, the flat surfaces in the parts 1611 may be inclined to match the trajectory of the powder bed 1626, or the axis of rotation 1626D may be tilted slightly with respect to the Z axis so that the exposure surface of the part 1611 is still planar.

In one embodiment, the powder depositor 1618 is designed to continuously feed powder to the powder bed 1626. In this embodiment, the powder depositor 1618 could include a powder hopper (not shown) with a funnel on the rotating top assembly that covers the rotation axis 1626D (center zone), and a non-rotating feeder (not shown) (e.g. a screw drive, conveyor belt, etc.) that terminates directly over the funnel. If the center zone is not available due to the needs of other components, then a donut shaped funnel would have one at least one point in its annular opening under a stationary off-axis feeder point at all times. In both of these embodiments it is advantageous to make the large and heavy powder supply mechanism stationary and feed the powder into the rotating top assembly.

If the “melting zone” of each column of the irradiation beam 1622D is approximately linear, it may be aligned to the slightly sloped radial surface of a helical surface. It doesn't matter if the helical surface is not planar, as long as it has a sufficiently straight radial line segment. It is also possible that some embodiments may treat a helical powder surface as “approximately flat” since the powder layer thickness is small compared to the part size, the powder bed size, and the energy beam depth of focus.

FIG. 17 is a simplified top view of a portion of still another embodiment of a processing machine 1710 for forming the three dimensional part 1711. In this embodiment, the processing machine 1710 includes (i) the powder bed 1726; (ii) the powder depositor 1718; and (iii) the irradiation device 1722 that are somewhat similar to the corresponding components described above. It should be noted that the processing machine 1710 may include the pre-heat device, the cooler device, the measurement device, and the control system, that have been omitted from FIG. 17 for clarity. The powder depositor 1718, the irradiation device 1722, the pre-heat device, the cooler device, and the measurement device may collectively be referred to as the top assembly.

In the embodiment illustrated in FIG. 17, the powder bed 1726 includes a large support platform 1727A and one or more build chambers 1727B (only one is illustrated) that are positioned on the support platform 1727A. In one embodiment, the support platform 1727A is holds and supports each build chamber 1727B while each part 1711 is being built. For example, the support platform 1727A may be disk shaped, or rectangular shaped.

In FIG. 17, the build chamber 1727B contains the metal powder that is selectively fused or melted according to the desired part geometry. The size, shape and design of the build chamber 17278 may be varied. In FIG. 17, the build chamber 1727B is generally annular shaped and includes (i) a tubular shaped, inner chamber wall 1727C, (ii) a tubular shape, outer chamber wall 1727D, and (iii) an annular disk shaped support surface 1727E that extends between the chamber walls 1727C, 1727D.

In this embodiment, the support surface 1727E may function as an annular “elevator platform” that may be moved vertically relative to the chamber walls 1727C, 1727D. In certain embodiments, fabrication begins with the elevator 1727E placed near the top of the chamber walls 1727C, 1727D. The powder depositor 1718 deposits a preferably thin layer of metal powder into the build chamber 1727B during relative movement between the build chamber 1727B and the powder depositor 1718. During fabrication of the part 1711, the elevator support surface 1727E may be slowly lowered down by one layer thickness per revolution so the next layer of powder may be distributed properly in a continuous fashion. In this way, instead of building parts as a stack of thin parallel planar layers, the part(s) are built in a continuous helical layer that spirals on itself many times.

In the embodiment illustrated in FIG. 17, the support platform 1727A and the build chamber 1727B may be rotated about the rotation axis 1726D in the rotation direction 1725 at a substantially constant velocity with a mover (not shown) during the manufacturing process relative to at least a portion of the top assembly. Alternatively, at least a portion of the top assembly may be rotated relative to the support platform 1727A and the build chamber 1727B. Still alternatively, instead of the support surface 1727E including the elevator platform that moves down, the support platform 1727A may be controlled to move downward along the rotation axis 1726D during fabrication and/or the top assembly may be controlled to move upward along the rotation axis 1726D during fabrication.

With the present design, the problem of building a practical and low cost three dimensional printer 1710 for high volume 3D printing of metal parts 1711 is solved by providing a rotating turntable 1727A that supports a large annular build chamber 1727B suitable for continuous deposition of myriad small parts 1711 or individual large parts that fit in the annular region.

In FIG. 17, the irradiation device 1722 again includes multiple (e.g. three) separate irradiation energy sources 1722C (each illustrated as a circle) that are positioned along the irradiation axis 1722B. In this embodiment, the three energy sources 1722C are arranged in a line along the irradiation axis 1722B so that together they may cover the full radial width of the build chamber 1727B. Because the exposure area covers the entire radial dimension of the desired build volume, every point in the required build volume may be reached by at least one of the irradiation beams. Alternatively, a single irradiation energy source 1722C may be utilized with a scanning irradiation beam.

As provided herein, this processing machine 1710 requires no back and forth motion (no turn motion), so throughput may be maximized. Many parts 1711 may be built in parallel in the build chamber 1727B. Very large parts that fit within the annular shape may be fabricated. There are many applications that require large round parts with a central hole, so this capability may be valuable in some applications (such as jet engines).

FIG. 18 is a simplified side illustration of a portion of yet another embodiment of the processing machine 1810. In this embodiment, the processing machine 1810 includes (i) the powder bed 1826 that supports the powder 1811; and (ii) the irradiation device 1822. It should be noted that the processing machine 1810 may include the powder depositor, pre-heat device, the cooler device, the measurement device, and the control system, that have been omitted from FIG. 18 for clarity. The powder depositor, the irradiation device 1822, the pre-heat device, the cooler device, and the measurement device may collectively be referred to as the top assembly.

In this embodiment, the irradiation device 1822 generates the irradiation energy beam 1822D to selectively heat the powder 1811 in each subsequent powder layer 1813 to form the part. In the embodiment of FIG. 18, the energy beam 1822D may be selectively steered to any direction within a cone shaped workspace. In FIG. 18 three possible directions for the energy beam 1822D are represented by three arrows.

Additionally, in FIG. 18, the support surface 18268 of the powder bed 1826 is uniquely designed to have a concave, curved shape. As a result thereof, each powder layer 1813 will have a curved shape.

As provided herein scanning the energy beam 1822D across a large angle at a planar powder surface would create focus errors because the distance from the deflection center to the powder changes with the cosine of the deflection angle. To avoid focus errors, in one embodiment of the system shown in FIG. 18, the support surface 18268 and each powder layer 1813 have a spherical shape with the center of the sphere at the center of deflection 1823 of the energy beam 1822D. As a result thereof, the energy beam 1822D is properly focused at every point on the spherical surface of the powder 1811, and the energy beam 1822D has a constant beam spot shape at the powder layer 1813. In FIG. 18, the powder 1811 is spread on the concave support surface 1826B centered at a beam deflection center 1823. For a processing machine 1810 having a single irradiation energy source as illustrated in FIG. 18, the powder 1811 may be spread over the single concave support surface 1826B. Alternatively, for a processing machine 1810 having multiple, irradiation energy sources, the powder 1811 may optionally be spread on multiple curved surfaces, each centered on the deflection center 1823 of the respective energy sources.

For an alternative embodiment of the processing machine 1810 that uses linear scanning of the powder bed 1826 (or the column) into and out of the page, the curved support surface 1826B would be cylindrical shape. Alternatively, for an embodiment where the powder bed 1826 is rotated about a rotation axis, the curved surface support surface 18268 would be designed to have a spherical shape.

In these embodiments, the size and shape of the curved support surface 18268 is designed to correspond to (i) the beam deflection of the energy beam 1822D at the top powder layer 1813, and (ii) the type or relative movement between the energy beam 1822D and the powder layer 1813. Stated in another fashion, the size and shape of the curved support surface 18268 is designed so that the energy beam 1822D has a substantially constant focal distance to the top powder layer 1813 during relative movement between the energy beam 1822D and the powder layer 1813. As used herein the term substantially constant focus distance shall mean variations in the focal distance of less than five percent. In alternative embodiments, the term substantially constant focus distance shall mean the focus distance changes no more than ten, five, four, three, two, or one percent.

In FIG. 18, the problem of building a three dimensional printer 1810 with focus variations caused by a large beam deflection angle is solved by providing at least one cylindrical or spherical, bowl-shaped support surface 1826B that maintains a constant focal distance for the irradiation energy beam 1822D. In other words, the embodiment of the FIG. 18 comprises the support device which includes a non-flat (e.g. the curved) support surface, the powder supply device which supplies the powder to the support device and which forms the curved powder layer, and the irradiation device which irradiates the curved powder layer. In this situation, the irradiation device sweeps the energy beam in at least a swept plane (paper plane of FIG. 18) which includes a swept direction. And the curved support surface includes a curvature in the swept plane. The non-flat support surface may be a part of polygonal shape (a shape made of a plurality of straight lines which cross each other).

FIG. 19A is a simplified side illustration of a portion of yet another embodiment of the processing machine 1910. In this embodiment, the processing machine 1910 includes (i) the powder bed 1926 that supports the powder 1911; and (ii) the irradiation device 1922. It should be noted that the processing machine 1910 may include the powder depositor, pre-heat device, the cooler device, the measurement device, and the control system, that have been omitted from FIG. 19A for clarity. The powder depositor, the irradiation device 1922, the pre-heat device, and the measurement device may collectively be referred to as the top assembly.

In this embodiment, the irradiation device 1922 includes multiple (e.g. three) irradiation energy sources 1922C that each generates a separate irradiation energy beam 1922D that may be steered (scanned) to selectively heat the powder 1911 in each subsequent powder layer 1913 to form the part. In FIG. 19A, each energy beam 1922D may be controllably steered throughout a cone shaped workspace that diverges from the respective energy source 1922C. In FIG. 19A, the possible directions of each energy beam 1922D are each represented by three arrows.

In FIG. 19A, the support surface 19268 of the powder bed 1926 is uniquely designed to have three concave, curved shaped regions 1926E. Stated in another fashion, the support surface 1926B includes a separate curved shaped region 1926E for each irradiation energy source 1922C. As a result thereof, each powder layer 1913 will have a dimpled curved shape.

As provided above, scanning each energy beam 1922D across a large angle would create focus errors if the surface of the powder 1911 were a flat plane because the distance from the deflection center to the powder 1911 would change with the cosine of the deflection angle. In the embodiment illustrated in FIG. 19A, however, the powder 1911 is spread on the three lobed, curved support surface 19268 and the distance between the deflection center of each energy beam 1922D and the surface of the powder 1911 is constant so there are no significant focus errors.

In certain embodiments, such as a system where the powder support surface 19268 is rotating in a manner similar to the previously described embodiments, it may be more practical to distribute the powder across a single curved spherical surface. In this case, the columns providing each energy beam 1922D may be offset from each other in the vertical direction to more closely align the focal surface of each energy beam 1922D with the powder surface. In other words, the shape of the surface of the powder 1911 is not precisely matched to the focal distance of each energy beam 1922D, but the deviations from optimal focus are small enough with respect to the depth of focus of each energy beam 1922D that the proper part geometry may be formed in the powder 1911.

The processing machine 1910 illustrated in FIG. 19A, may be used with a linear scanning powder bed 1926, or a rotating powder bed 1926. For a rotating system, it may be preferable to distribute the multiple columns across the powder bed 1926 radius, not its diameter. In this case, the powder bed axis of rotation would be at the right edge of the diagrams.

In these embodiments, the size and shape of the curved support regions 1926E are designed to correspond to (i) the beam deflection of each energy beam 1922D at the top powder layer 1913, and (ii) the type of relative movement between the energy beam 1922D and the powder layer 1913. Stated in another fashion, the size and shape of each curved support region 1926E is designed so that the energy beam 1922D has a substantially constant focus distance at the top powder layer 1913 during relative movement between the energy beam 1922D and the powder layer 1913. Stated in yet another fashion, the shape of the support region 1926E, and the position of the energy beams 1922D are linked to the type of relative movement between the support region 1926E and the energy beams 1922D so that the energy beams 1922D have a substantially constant focus distance at the top powder layer 1913.

For example, FIG. 19B is a top view of a support bed 1926 in which the curved support regions 1926E are shaped into linear rows. In this embodiment, there is linear relative movement along a movement axis 1925 between the powder bed 1926 and the irradiation device 1922 (illustrated in FIG. 19A) while maintaining a substantially constant focus distance. A sweep (scan) direction 1923 of each beam 1922D (illustrated in FIG. 19A) is illustrated with a two headed arrow in FIG. 19B.

Alternatively, for example, FIG. 19C is a top view of a support bed 1926 in which the curved support regions 1926E are shaped into annular rows. In this embodiment, there is rotational relative movement along a movement axis 1925 between the powder bed 1926 and the irradiation device 1922 (illustrated in FIG. 19A) while maintaining a substantially constant focus distance. A sweep (scan) direction 1923 of each beam 1922D (illustrated in FIG. 19A) is illustrated with a two headed arrow in FIG. 19C.

As provided herein, maintaining a constant focal distance will improve the part quality by controlling aberrations and the beam spot size.

Referring back FIG. 19A, in this embodiment, (i) the powder bed 1926 has a non-flat support region (support surface) 1926E, (ii) the powder supply device (not shown in FIG. 19A) supplies the powder 1911 to the powder bed 1916 to form the curved powder layer 1913; and (iii) the irradiation device 1922 irradiates the layer 1913 with an energy beam 1922D to form the built part (not shown in FIG. 19A) from the powder layer 1913. In this embodiment, the non-flat support surface 1926E may have a curvature. Further, the irradiation device 1922 may sweep the energy beam 1922D back and forth along a swept direction 1923, and wherein the curved support surface 1926E includes the curvature in a plane where the energy beam 1922D pass through.

FIG. 20 is a simplified side illustration of a portion of still another embodiment of the processing machine 2010. In this embodiment, the processing machine 2010 includes (i) the powder bed 2026 that supports the powder 2011; and (ii) the irradiation device 2022 that are somewhat similar to the corresponding components described above and illustrated in FIG. 19A. It should be noted that the processing machine 2010 may include the powder depositor, pre-heat device, the cooler device, the measurement device, and the control system, that have been omitted from FIG. 20 for clarity. The powder depositor, the irradiation device 2022, the pre-heat device, and the measurement device may collectively be referred to as the top assembly.

In this embodiment, the irradiation device 2022 includes multiple (e.g. three) irradiation energy sources 2022C that each generates a separate irradiation energy beam 2022D that may be steered (scanned) to selectively heat the powder 2011 in each subsequent powder layer 2013 to form the part. In FIG. 20, each energy beam 2022D may be controllably steered throughout a cone shaped workspace that diverges from the respective energy source 2022C. In FIG. 20, the possible directions of each energy beam 2022D are each represented by three arrows.

In FIG. 20, the support surface 2026B of the powder bed 2026 is uniquely designed to have large concave curved surface. Stated in another fashion, the support surface 2026B is curved shaped.

As provided above, scanning each energy beam 2022D across a large angle would create focus errors if the surface of the powder 2011 were a flat plane because the distance from the deflection center to the powder 2011 would change with the cosine of the deflection angle. In the embodiment illustrated in FIG. 20, however, the powder 2011 is spread on the curved support surface 2026B, and the irradiation energy sources 2022C are tilted relative to each other so that the distance between the deflection center of each energy beam 2022D and the surface of the powder 2011 is substantially constant so there are no significant focus errors.

In the embodiment illustrated in FIG. 20, the powder support surface 2026B is rotating in a manner similar to the previously described embodiments, and the powder 2011 is distributed across a single curved spherical surface 2026B. In this case, the columns providing each energy beam 2022D may be offset from each other in the vertical direction (and angled) to more closely align the focal surface of each energy beam 2022D with the powder surface. In other words, the shape of the surface of the powder 2011 is not precisely matched to the focal distance of each energy beam 2022D, but the deviations from optimal focus are small enough with respect to the depth of focus of each energy beam 2022D that the proper part geometry may be formed in the powder 2011.

The processing machine 2010 illustrated in FIG. 20, may be used with a linear scanning powder bed 2026, or a rotating powder bed 2026. In these embodiments, the size and shape of the curved support surface 2026B is designed and the irradiation energy sources 2022C are oriented and positioned (i) so that each energy beam 2022D has a substantially constant focus distance at the top powder layer 2013, and (ii) to match the type of relative movement between the energy beam 2022D and the powder layer 2013. Stated in yet another fashion, the shape of the support region 2026E, and the position of the energy beams 2022D are linked to the type of relative movement between the support region 2026E and the energy beams 2022D so that the energy beams 2022D have a substantially constant focus distance at the top powder layer 2013.

FIG. 21 is a simplified side perspective illustration of a portion of yet another embodiment of the processing machine 2110 for making a three dimensional part 2111. In this embodiment, the processing machine 2110 is a wire feed, three dimensional printer that includes (i) the material bed assembly 2114 that supports the three dimensional part 2111; and (ii) a material depositor 2150.

In FIG. 21, the material bed assembly 2114 includes the material bed 2126 and a device mover 2128 that rotates the material bed 2126 about the support rotation axis 2126D.

Further, in FIG. 21, the material depositor 2150 includes (i) an irradiation device 2152 that generates an irradiation energy beam 2154; and (ii) a wire source 2156 that provides a continuous feed of wire 2158. In this embodiment, the irradiation energy beam 2154 illuminates and melts the wire 2158 to form molten material 2160 that is deposited onto the material bed 2126 to make the part 2111.

As provided herein, the problem of manufacturing high precision rotationally symmetric parts 2111 by three dimensional printing is solved by using a rotating material bed 2126 (build platform), the wire source 2156 (wire feed mechanism) that supplies the wire 2158, and the irradiation energy beam 2154 for melting the wire 2158.

In one embodiment, as the material bed 2126 is rotated about the rotation axis 2126D, the material depositor 2150 may provide the molten material 2160 to form the part 2111. Further, material depositor 2150 (irradiation device 2152 and wire source 2156) may be moved transversely (e.g. along arrow 2162) with a depositor mover 2164 relative to the rotating material bed 2126 to build the part 2111. Further, the material bed 2126 and/or the material depositor 2150 may be moved vertically (e.g. by one of the movers 2128, 2164) to maintain the desired height between the material depositor 2150 and the part 2111.

Alternatively, the depositor mover 2164 may be designed to rotate the material depositor 2150 about a rotation axis and move the material depositor 2150 transversely to the rotation axis relative to the stationary material bed 2126. Still alternatively, the depositor mover 2164 may be designed to rotate the material depositor 2150 about a rotation axis relative to the material bed 2126, and the material bed 2126 may be moved transversely to the rotation axis with the device mover 2128.

Round, substantially rotationally symmetric parts 2111 may be built by rotating the material bed 2126 and depositing metal by using the energy beam 2154 to melt the wire feed 2158. The basic operation is analogous to a normal metal cutting lathe, except that the “tool” is depositing metal 2160 instead of removing it.

It is understood that although a number of different embodiments of the processing machine 10, 210, 310 and powder supply assembly 18, 218, 318, 618, 718, 818, 918, 1018, 1118, 1218, 1318, 1418 have been illustrated and described herein, one or more features of any one embodiment can be combined with one or more features of one or more of the other embodiments, provided that such combination satisfies the intent of the present disclosure.

While a number of exemplary aspects and embodiments of the processing machine 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A processing machine for building a three-dimensional object from powder, the processing machine comprising:
a build platform;
a powder supply assembly that distributes the powder onto the build platform to form a powder layer; and
an energy system that directs an energy beam at a portion of the powder on the build platform to form a portion of the object.

2. The processing machine of claim 1, wherein the powder supply assembly includes (i) a powder container that retains the powder; (ii) a supply outlet positioned over the build platform; and (iii) a flow control assembly that selectively controls the flow of the powder from the supply outlet.

3. The processing machine of claim 2 wherein the flow control assembly includes a flow controller and a vibration generator that selectively vibrates at least a portion of the powder supply assembly; wherein the flow controller allows powder to flow therethrough upon vibration of the powder supply assembly by the vibration generator.

4. The processing machine of claim 3 wherein the flow controller allows powder to flow therethrough upon sufficient vibration of the powder supply assembly by the vibration generator; and wherein the flow controller inhibits flow therethrough when there is insufficient vibration of the powder supply assembly by the vibration generator.

5. The processing machine of claim 2 wherein the flow controller includes at least one mesh screen.

6. The processing machine of claim 2 wherein the flow controller includes a flow structure having a plurality of flow apertures that extend through the flow structure, wherein at least one of the flow apertures has an aperture size that is larger than a nominal particle size of the powder particles.

7. The processing machine of claim 6 wherein a plurality of the flow apertures have an aperture size that is larger than the nominal particle size of the powder.

8. The processing machine of claim 3 wherein the vibration generator selectively vibrates the powder container.

9. The processing machine of claim 3 wherein the powder container comprises two walls that slope towards each other from a first end to the second end in which the flow controller is located, and the at least one vibration generator is provided on at least one of the walls.

10. The processing machine of claim 9 wherein an angle of the walls is determined based upon a type of powder.

11. The processing machine of claim 9, wherein the plurality of vibration generators are provided at the both of two walls.

12. The processing machine of claim 11, wherein the flow controller is elongated in a first direction crossing the build platform, and the plurality of vibration generators are provided at the both of two walls along with the first direction.

13. The processing machine of claim 2 wherein the flow control assembly includes a shutter assembly that selectively controls the flow of the powder from the supply outlet.

14. The processing machine of claim 13 wherein the shutter assembly includes a first shutter, and a first shutter mover that selectively moves the first shutter to selectively control the flow of the powder from the supply outlet.

15. The processing machine of claim 14 wherein the shutter assembly includes a second shutter, and a second shutter mover that selectively moves the second shutter to selectively control the flow of the powder from the supply outlet.

16-39. (canceled)

41. The processing machine of claim 1 wherein the powder supply assembly includes a first supply module that deposits powder on the build platform, and a second supply module that deposits powder into the first supply module.

42. The processing machine of claim 41 wherein at least one of the supply modules includes (i) a powder container that retains the powder; (ii) a supply outlet positioned over the build platform; and (iii) a flow control assembly that selectively controls the flow of the powder from the supply outlet.

43. The processing machine of claim 42 wherein for the at least one supply module, the flow control assembly includes a flow controller and a vibration generator that selectively vibrates at least a portion of the supply module; wherein, the flow controller allows powder flow therethrough upon sufficient vibration of the supply module by the vibration generator; and wherein, the flow controller inhibits flow therethrough when there is insufficient vibration of the supply module by the vibration generator.

44-46. (canceled)

47. The processing machine of claim 41 wherein the supply modules are arranged in series.

48. The processing machine of claim 41 wherein powder supply assembly includes a third supply module that deposits powder into the second supply module.

49. The processing machine of claim 1 wherein the build platform is being moved relative to the powder supply assembly while the powder supply assembly deposits the powder onto the build platform.

50-69. (canceled)

70. The processing machine of claim 1 further comprising (i) a mover that moves the build platform so a specific position on the build platform is moved along a moving direction; (ii) a powder supply device which supplies the powder to the moving build platform; (iii) wherein the energy system irradiates at least a portion of the powder layer with an energy beam to form at least a portion of the part from the powder layer during a first period of time; and (iv) a measurement device which measures at least portion of the object during a second period of time; wherein at least part of the first period in which the energy system device irradiates the powder with the energy beam and at least part of the second period in which the measurement device measures are overlapped.

71. The processing machine of claim 1 further comprising: (i) a mover which moves the build platform so as to move a specific position on the build platform along a moving direction; and (ii) a powder supply assembly which supplies a powder to the build platform which moves, and forms a powder layer; wherein the energy system changes an irradiation position where the energy beam is irradiated to the powder layer along a direction crossing the moving direction.

72. The processing machine of claim 1 further comprising: (i) a mover which moves the build platform so as to move a specific position on the build platform along a moving direction; (ii) a powder supply assembly which supplies a powder to the build platform which moves, and forms a powder layer; and wherein the energy system includes a plurality of irradiation systems which irradiate the layer with an energy beam to form a built part from the powder layer, wherein the irradiation systems arranged along a direction crossing the moving direction.

73. The processing machine of claim 1 further comprising a mover that rotates at least one of the build platform and the powder supply assembly about a rotation axis while the powder supply assembly deposits the powder onto the build platform.

74. The processing machine of claim 1 further comprising: a mover which moves the build platform so a specific position on the build platform is moved along a moving direction; wherein the powder supply assembly supplies the powder to the moving build platform to form a powder layer during a powder supply time; and wherein the energy system irradiates at least a portion of the powder layer with the energy beam to form at least a portion of the object from the powder layer during an irradiation time; and wherein at least part of the powder supply time and the irradiation time are overlapped.

75. (canceled)

76. A method for building a three-dimensional object from powder comprising:
providing a build platform;
distributing the powder onto the build platform to form a powder layer with a powder supply assembly; and
directing an energy beam at a portion of the powder on the build platform to form a portion of the object with an energy system.

77. The method of claim 76, wherein distributing the powder includes (i) retaining the powder with a powder container; (ii) positioning a supply outlet over the build platform; and (iii) selectively controlling the flow of the powder from the supply outlet with a flow control assembly.

78-134. (canceled)
